(19) United States
(12) Patent Application Publication
(10) Pub. No.: US 2022/0234775 A1
(43) Pub. Date: Jul. 28, 2022

(54) PROCEDURE, MODELS OF FLEXIBLE CONTAINERS AND MACHINE TO GENERATE AND SEAL FLEXIBLE CONTAINER FLAPS

(71) Applicant: Guillermo LOPEZ-AROSTEGUI SAENZ, Urduliz (Vizcaya) (MX)

(72) Inventor: Guillermo LOPEZ-AROSTEGUI SAENZ, Urduliz (Vizcaya) (MX)

(21) Appl. No.: 17/422,428

(22) PCT Filed: Jan. 11, 2019
(86) PCT No.: PCT/ES2019/000005

§ 371 Date: Jul. 12, 2021

(51) Int. Cl. B65B 51/30; B65B 9/20; B29C 65/00

(52) U.S. Cl. CPC B65B 51/303; B65B 9/2042; B65D 75/12; B29C 66/849; B29C 66/4312

(57) ABSTRACT

The procedure of the invention consists in manufacturing and/or transforming flexible containers in vertical filling and sealing machines that manufacture or process English fold, stable bottom or pad type containers, by generating and sealing flaps at the top and/or bottom of the lateral sides of the previous pre-container (6a) or subsequent pre-container (6b) arranged in the vertical machine.

Impact bodies (2; 3) installed in the vertical machine are used, which, when operated, hit, push and fold at least part of at least one side or lateral side on at least another part of another side or contiguous side, thus generating at least any one of the flaps such as: the plus flaps (11; 12; 13), triangular body flaps (14) manipulated triangular body flaps (15) the flap folded on itself (15a) or the strip flap (15b).

Subsequently, the flaps are sealed, by means of a sealing mode like that of a resistance, in order to keep the generated flap permanently stable.

Another object of the invention, devices that are installed in the vertical machine that facilitate the optimal generation of the flaps, such as:
the Rammer body (19) intended to widen and stretch the wrapper or sheet of the bottom part or/and of the lower support side of the pre-container (6a), or
Pressing platform or drawer unit (22) intended to push and crush the upper part of the pre-container (6b) against the underside of the clamp (1a), causing the pre-container (6b) to expand three-dimensionally in a cubic shape.

The new machines of the invention will have at least one impact body (2; 3) or/and at least one device (19; 20; 21; 22) of the invention.

The invention also protects different packaging models, such as mixed packaging: one half of the pad type and the other half of the English fold type.

### TECHNICAL FIELD OF THE INVENTION

It belongs to the industry that manufactures three-dimensional or heat-sealed stable bottom flexible containers, which stand upright on their own because a flatter, wider and firmer side is generated in the container.
The technology of this invention is applicable, complementing them, in other packaging machines that manufacture flexible containers, for example: the vertical (or, for example, the horizontal) machines for liquids and/or solids that, from a film roll, forms, fills and seals (one, two, three, four or more seams) of the container, for example, pad type, English type, stable bottom, stand up, stabilo Pack® or doy pack.
These machines use different types of wrappers or film, which can be laminated, in the form of a tube or semi-tube, and can also be as a monolayer (e.g. polyethylene) or multilayer/complex (of two, three, four, five or more layers of, e.g. polypropylene-polyethylene, polyethylene-polyester or cardboard-polyethylene-aluminum bonded sheets).
The products to be packaged are from well differentiated sectors:

A) Food:

a.1) Liquid or paste-like products (additionally may also contain solids) such as: drinks, yogurts, purees, soups, sauces or jams.

a.2) Solid products such as: corn flakes, vegetables, legumes, dried fruit, chips, olives or snacks.

B) Non-food:

b.1) Liquid or paste-like products (additionally may also contain solids) such as: mineral or synthetic oils, gels or shampoo, perfumes-colognes, creams, paints, chemical or cleaning products.

b.2) Solid products or objects such as: hardware parts (screws; washers; etc.), toys, consumables or kitchenware.

### State of the Relevant Technique

On the one hand, there is the process of transforming initial containers into three-dimensional containers, also of my invention and which I call 3D compack.

This system has been protected with five applications for Invention Patents [PCT/ES2012/000261—WO201303903; PCT/ES2014/000041—WO2014140464; PCT/ES2015/000131—WO2016042176A1; PCT/ES2015/000174—WO2016087690A1; PCT/ES2016/000085—WO2017021570A1].

It consists of a procedure and machine to transform initial containers (flexible containers that have previously been configured, filled and sealed by vertical or horizontal machines) into different three-dimensional containers, such as: the cube, rectangular prism, rhomboid pyramid, cylinder or irregular polyhedra.

In a first stage, pressure is applied in the direction of the inner seal of the container, using at least one impact body on or against at least one part of at least one perimeter lateral side or area of two perimeter lateral sides contiguous to one end or apex; so that part of the fluid is displaced towards the contour of the container, increasing the pressure inside the container, as well as producing a local inflation effect, obtaining: at least one support side or additional side in the area of the container with which the impact body impacts which allows the container to stand upright in a stable manner and in turn modify the geometric configuration of the container, as well as generating at least one flap or triangular body contiguous to the support side or additional side and, in a second stage, the generated flap is sealed, by means of a heat source such as a resistance or by ultrasound, at least part of at least one side of at least one sealing line.

On the other hand, the vertical or horizontal packaging machines with which flexible packaging is also manufactured, that are available on the current market and have been marketed for at least twenty years, are the following;
Stable bottom, English type, stand up or stabilo packaging systems, which use film rolls (laminated; semi-tube or tube), as well as a square or cylindrical forming tube where the film is fitted or adjusted to the above mentioned tube sliding along it thus momentarily configuring a cylindrical or cubic shape (in this case, a container from the middle down is mainly configured in a cubic form).

Then, when the wrapper used exceeds the tube (five or more centimeters) the container is sealed at the bottom and then (when the wrapper moves downwards) it is sealed from the top. In the case of wanting to configure a three-dimensional container in a cubic form from the middle down, and as the side that acts as the base is flat: the technique known as the English fold is used which is that, just as the container is transversely sealed from the bottom, a triangle-shaped impact body is introduced into the container from the bottom of the two parallel sides to the left and right of the container.

Also, optionally, up to five longitudinal sealing lines can be made outside the forming tube to give consistency to the container: one in the middle and at the longitudinal joint of the two ends of the fold that wraps the forming tube, thus sealing the sheet so that the wrapper remains in the intended tube shape, as well as four more longitudinal sealing lines on the four vertical edges of the cubic form generated by the forming tube.

Depending on the type of packaging (laminated; in tube or semi-tube) and the degree of stability to be obtained, the container may have two or three sealing lines such as those on the pad type, the English fold type or, for example, a combined half pad and half English type) or of four or five sealing lines (the stable bottom, stand up or stabilo type containers).
The Doy pack packaging system, which has a support base side but is less stable, less volumetric and less economical (since it requires a special complex three-layer plastic to provide rigidity and consistency to the container). Also, as this container is almost flat—except for just the bottom part- and with two sealing lines on the sides: it makes it more difficult to dose or to use, because it generates a narrow mouth and also because, if the container contains liquid, less pressure is exerted on it making it difficult to leave.

The technique consists of folding or bending the film twice. First, in two equal halves; second, the part where the (closed) curvature of the fold or bend is made is introduced inwards, generating another fold or bend towards the inside of the container in order to make the container acquire a stable base shape (like a gusset that expands) on the underside with which it will be held upright and finally sealed with five seam lines (two at the bottom, two at the sides and one at the top once the product is introduced inside) to maintain the configuration of the container.

### Technical Problem to be Solved

When applying, installing or incorporating the 3D plus system procedure, of generating and sealing at least one plus flap, directly in the vertical flexible packaging machines [e.g., the pad or pillow pack type of one, two, three, four or more sealing line containers that do not stand upright, or the containers that do stand upright such as those of the English type, gusseted, stand up, stabilo, doy pack or stable bottom/block bottom, which also have one, two, three, four or more sealing lines], the following technical aspects are solved:

1—the procedure and processes of the 3D compack transformation system are simplified, as it is now possible to carry out the entire transformation (generating and sealing or generating and folding one, two, three or four plus flaps or triangular body flaps, or one, two, three, four or more burr plus flaps or burr flap) of a pre-container before it has been made or filled inside with the product to be packaged, thus saving time and costs in the 3D plus transformation process.

2—the transformation of high production flexible packaging, such as initial packaging or pre-packaging produced by high performance vertical packaging machines for flexible packaging of 60, 70, 80 or more packaging units per minute, can be covered or undertaken effectively and immediately.

Therefore, since the 3D plus device can be installed in any of the vertical or horizontal packaging machines on the market, it solves the possibility of transforming any type of initial or pre-container size in a practical, functional, effective and economical way as well as expanding the marketing field.

3—it allows the sealing lines to be applied from the 3D plus system to be safer because they can be carried out when the container is empty without it still being filled with the product to be packaged, so that no particles, matter or substances can come between the packaging and the sealing. It also allows less alteration of the pre-selected sealing temperature so that safer sealing lines will be produced, and the operator will need to spend less time controlling and adjusting the sealing system.

4—make the burr plus flap or burr flap sealing lines easier, simpler and faster, which in addition to conferring greater stability and consistency to the container: they also enable an opening cap to be generated easily and quickly where to serve or take the product packaged inside, since these burr plus flaps or burr flaps can be detached by pulling on them.

Make these sealing lines on the edges. Later, when the container is tightly closed, it is more difficult because the container holds or necessarily contains a fluid inside (air/gas or/and liquid/paste) that makes the shape of the container more unstable, so if it contains a lot of fluid it will make it difficult to generate the burr plus flap or burr flap and, if it contains little fluid, the container will not be straight but curved, so at least part of the burr plus flap or burr flap may not be generated and sealed.

Exposure of the Invention

A first object of the invention, is the procedure or processes of generating at least one plus flap or triangular body flap: directly on the vertical (or, for example, on horizontal or diagonally inclined) packaging machines for flexible containers of the film type in rolls or laminated (or also in tubes or semi-tubes), in which these machines, in a first stage, form a pre-container open at least on one side, in a second stage fill the product to be packaged and, in a third stage the container is sealed (closed tightly all around the contour and sealed on all the perimeter sides) or pre-container, which can be closed (all around the contour and sealed on all the perimeter sides) or open, on at least one of its sides and then transferred to the production plants where they will be filled with the product to be packaged.

For this, at least one device of the 3D plus system will be installed in the vertical or horizontal flexible packaging machines to generate and seal at least one plus flap (on flexible containers, e.g. English type, stable bottom, stand up, stabilo or doy pack), at least one triangular body flap (in containers that are of the pad type or English type from the middle down and pad type from the middle up) or burr plus flap (these are made on the edges, preferably horizontally on the front and back side of the pre-container or container, so that it will be sealed over the English fold at the height of the ends of this edge).
In the vertical packaging machines, when the procedure or processes of the 3D plus system are most optimized (generating and sealing the plus flap, triangular body flap or burr plus flap), it is when the devices of the invention are activated at the moment right after the sealing and cutting jaws of the vertical packaging machines are closed (trapping or transversely holding the film or sheet of the wrapper, blocking its advance) and, preferably, before the pre-container of the product to be packaged is filled.

A preferential mode of the procedure of the invention is set out below.

Procedure to transform flexible English fold, stable bottom, pad or half English fold or stable bottom and half pad containers or pre-containers manufactured on vertical packaging machines, by generating and sealing at least one flap, triangular body flap, English fold plus flap, stable bottom plus flap or burr plus flap.

The Procedure has the following four Stages:

A first stage, in which the wrapper (e.g., a complex two-layer film type sheet on a roll, or also, in a tube or semi-tube) is driven by a displacement mode (e.g. mechanical, such as that of at least one roller driven by a motor or turning cylinder) to the forming tube's forming neck (e.g, cylindrical, quadrangular or rectangular) where the sheet (or tube or semi-tube wrapper) is folded down to wrap the forming tube on all its sides or perimeter contour, so that the sheet will take the form of the forming tube, for example, quadrangular or cylindrical.

Also, if the vertical (or horizontal) machine produces stable bottom flexible containers, in addition to the English fold, it will also generate:
at least one sealed fold with its longitudinal sealing line in at least one of the vertical edges or/and areas contiguous to it of at least one of the generated side faces of the pre-container, in which, preferably, four of these folds and edge sealing lines are generated, two on the left side and another two parallel on the right side: obtaining,
a more stable, consistent pre-container or container with a support side that makes the base wider and flatter.

A second stage, in which the wrapper advances down the forming tube and will stop just after passing the sealing and cutting jaws, preferably rectilinear and arranged horizontally and,

followed by the sealing and cutting jaws:
if the vertical packaging machine produces pad type containers, the sealing and cutting jaws will only be closed (without generating any folds or flaps), transversely trapping, clamping and blocking part of the wrapper, in such a way that it will be stretched or in tension in at least the area of the gap between the sealing and cutting jaws and the forming tube arranged vertically, where a previous pre-container is defined.
if the vertical machine is producing an English fold or stable bottom type container: while the sealing and cutting jaws are being closed, the English fold flaps, characteristic of these two types of containers are generated [preferably at each of the four corners of the container (left or/and right) or/and (top or/and bottom)], by means of a mechanical mode such as a triangular shaped impact body (arranged horizontally), that, when introduced inside every lateral side or lateral face of the pre-container (which is being formed in the vertical machine) it generates the English fold at the bottom of the pre-container, and, at the top of the container, the English fold is generated in the same way but with the impact body being of a geometric quadrangular shape (arranged vertically). In this way, both impact bodies displace part of the sheet on the side face of the container near the apex of the corner inwards, thus generating two parallel triangular flaps folded inwards and which, in the case of being generated by the triangular impact body, the two parallel triangular flaps will be positioned horizontally, forming in turn, between both flaps: a larger triangular flap, as well as forming in the external side area of the container: a narrow gap/cavity or slot arranged horizontally; and, with the quadrangular impact body, two triangular flaps are also generated, folded inwards but, in this case, arranged diagonally separated from each other, so that both in turn form in the outer lateral area of the container: an irregular triangular shape (in which its lateral sides are curved) with a cavity or hole; obtaining:
a flat or additional side on the bottom of the container or pre-container that is on top of the sealing and cutting jaws, which serves as a base for the container to stand upright.

In both cases, the wrapper on top of the sealing and cutting jaws cannot be blocked or loose because the 3D plus flaps of the invention will be generated later, in which the wrapper goes down (the proportional part depending on the size of the width and height of the plus flap to be generated) by folding part of the bottom of the lateral side of it onto at least another part of the wrapper of the flat support side.

A third stage, in which the sealing and cutting jaws must preferably remain closed throughout the transformation process of the 3D plus system and that, depending on the container model to be obtained, one can choose to generate one or more of the plus flaps and/or triangular bodies of the invention, as well as manipulate or transform, by means of a mode, the flaps, triangular body flaps, plus flaps or burr plus flaps that are generated.

The 3D plus procedure consists of or includes the following two steps:

First Step

Press in the direction of the inner seal of the pre-container or container, using at least one rigid or semi-rigid plus impact body [or, e.g., by means of a push mode such as directed air] on/against/with/between/in at least one part [or, also, e.g., against/with/between/in the intermediate area, partial area, complete area] of at least one lateral side or lateral face of the pre-container or/and container (preferably, of an area closer to the sealing and cutting jaws) or area of two or more sides or lateral sides (preferably, of an area closer to the sealing and cutting jaws) contiguous to one end or apex of the pre-container or/and container; so that part of the fluid is displaced towards the contour of the container, increasing the pressure inside the container, as well as producing a local inflation effect, thus obtaining:
at least one wider and flatter supporting or additional side in at least the area or side of the pre-container or container with which the impact body impacts, allowing it to remain stable and upright, as well as modifying the geometric shape of the container or pre-container and,
[at least one plus flap {English fold plus flap (mounted to an English fold), stable bottom plus flap (mounted to an English fold and to at least one lateral side edge flap)} and/or at least one burr plus flap {English fold burr plus flap (mounted to an English fold), stable bottom burr plus flap (mounted to an English fold and to one lateral side edge flap)] or/and [at least one triangular body flap or/and at least one flap or manipulated triangular flap, by means of a 3D compack transformation mode such as, for example, folded on itself {this circumstance means that, prior to folding the flap (15) on itself, the clamp (1a; 1b) has to be opened at least enough so that it can be released and thus the part of the flap (15; 11; 12) be able to move or rotate, or the part of the wrapper, film, sheet, tube or semi-tube, which is or is held, rammed or blocked by the clamp (1a; 1b) when it is in the closed position} or, if not, sealing and cutting the flap (15a) in the form of a strip flap (13)].] on the support side or additional side, or the area limited by a support contour or additional side.

Second Step

Seal, by means of a heat source mode such as a resistor or by ultrasound, at least part of at least one side with at least one sealing line of [at least one plus flap or/and at least one burr plus flap] or/and [at least one triangular body flap or/and at least one manipulated triangular body flap, e.g. folded on itself], defined in the previous step; obtaining:
at least one sealing line that will keep at least one of the support sides or additional side, or the area limited by a support contour or additional side, permanently stable as well as keeping the English fold plus flap, stable bottom plus flap, English fold burr plus flap, stable bottom burr plus flap, triangular body flap, triangular body flap folded over itself or manipulated triangular body flap permanently stable.

Also, without pretending to be limiting as to the scope of protection of the invention, the different types of plus flaps and, preferably, the triangular body flap or pre-cut triangular body flap and/or subsequently, can be manipulated by choosing randomly and in combination and/or repetitively, for example, from among at least one or more of any of the options (of the 3D compack flexible packaging transformation system) for manipulating a flap described below:
seal at least once at least part of at least one side of the triangular body flap or plus flap.
fold or bend the triangular body flap or plus flap over itself and seal at least once at least part of at least one side of it;
fold or bend the triangular body flap or plus flap over itself {this circumstance means that, prior to folding the flap (15) on itself, the clamp (1a; 1b) has to be opened at least enough so that it can be released and thus the part of the flap (15; 11; 12) be able to move or rotate, or the part of the wrapper, film, sheet, tube or semi-tube, which is or is held, rammed or blocked by the clamp (1a; 1b) when it is in the closed position} and seal it at least once, at least part of it, and also cut off at least once at least part of the remaining triangular body flap or resulting plus flap;
seal at least once at least part of one side of the triangular body flap or plus flap, fold it or bend it over itself and seal at least part of it once;
seal at least once at least part of one side of the triangular body flap or plus flap, fold it or bend it over itself and seal it at least once, at least part of at least a side of it, and also cut off at least once at least part of the remaining triangular body flap or resulting plus flap;
seal at least once at least part of one side of the triangular body flap or plus flap, and cut off at least once at least part of it;
seal at least once at least part of one side triangular body flap or plus flap, of the and cut off at least once at least part of it, fold it or bend it and seal it at least once, at least part of it, or also join the rest of the resulting flap or plus flap: to the rest of the container by means of a way to adhere it, as for example, with contact glue, a staple or a strip of tape;
fold the triangular body flap or plus flap;
fold the triangular body flap or plus flap and join it to the rest of the container by means of an adhesion mode such as, for example, contact glue, a staple or a strip of tape; and
seal at least once at least part of at least one side triangular body flap or plus flap; fold it and, optionally, join it with the rest of the container at least once at least part of it, by means of an adhesion mode such as, for example, contact glue, a staple or a strip of tape.

A fourth and last stage, in which, first, the product to be packaged falls from the weighing machine or weighing hopper—which is located on top of the vertical packaging machine—through the forming tube into the previous pre-container located in the space between the sealing and cutting jaws and the forming tube of the vertical packaging machine and, then the sealing and cutting jaws seal (it can also be sealed in earlier stages, once the sealing and cutting jaws are closed) and transversely cut, at the same time, the previous pre-container and the following pre-container (both of which are located on top and under the sealing and cutting jaws) and,

finally, the sealing and cutting jaws are open, returning to the start position or the stop position: obtaining,
on the one hand, a flexible container with a three-dimensional geometric shape or a geometric body that has been transformed in the vertical machine (or horizontal or, for example, diagonally), as well as it can be sealed and closed in its entirety or open on at least one side and,
on the other hand, a non-individual and unfinished three-dimensional flexible previous pre-container without sealing or cutting on at least one side or the top part.

Next, a new manufacturing or processing cycle begins for the containers or pre-containers, so the wrapper will move downwards, sliding down the forming tube, a distance that depends on the size in height that one wants to give to the pre-container or container which is to be processed or manufactured: the greater the height of the container, the greater the distance or time that the wrapper moves forward.

A second object of the invention, is to protect the invention as a device or devices for application and installation in any of the vertical (or horizontal or diagonally inclined) flexible packaging machines that are already operating in the market today or, on the contrary, are to be manufactured.

The devices are the following:

Device to generate and seal at least one plus flap, burr plus flap, triangular body flap of a flexible pre-container or container of a vertical (or horizontal) packaging machine with a forming tube for flexible film type containers in rolls, sheets, tubes or semi-tubes.

This device is installed in an area around and next to the following pre-container and previous pre-container ((preferably without still containing anything inside of the product to be packaged—especially if it is not a liquid product—as well as not being completely closed, by keeping at least one side unsealed)) which is held and delimited between the sealing and cutting jaws—which hold it and/or block it—and the forming tube of the vertical machine.

This device will preferably be fixed to the sealing and cutting jaws, but it can also be fixed to a support (fixed in turn to the vertical machine) or to another element or part of the vertical machine, or it can also be fixed to the floor.

Likewise, the device of the invention is applicable both in a container (an individual unit, this being closed in its entirety or open on at least one side, in which it can be inside the vertical or horizontal machine, or be outside it) like in a previous or following pre-container (the one that is unfinished as it has not been completely transformed and still remains in the vertical or horizontal machine, as well as it may contain the packaged product inside or, preferably, it is empty). Therefore, any one of the transformation devices of the 3D plus system will preferably be fixed on top or/and on the bottom of the sealing and cutting jaws, and to [(left or/and right) or/and (in front or/and behind)] of the previous pre-container and the following pre-container.

Therefore, the three-dimensional transformation of the 3D plus system can be done completely, both at the top and bottom half of the containers or pre-containers, generating at least one flap, triangular bodies or burr (on the edges and/or lateral sides, or areas that are contiguous to these), although the result is not exactly the same in terms of appearance, because the original pre-container or container—before the transformation—is not the same in appearance either, since the bottom side and the lateral sides from the middle down of the container or pre-container are flat and, from the middle up, they are not flat both on the top side and on the lateral sides where the wrapper is pushed inwards to form a non-homogeneous, irregular hole. For this reason, the plus flaps generated and sealed (by means of the 3D plus transformation) on the bottom of the pre-container or container will have a uniform, smooth and homogeneous appearance, without protruding peaks, and the plus flaps on the top of the pre-container or container will be more irregular as they contain some folds, as well as this one of a triangular configuration protruding outwards in the form of a peak.

The 3D plus device, is equipped with at least one impact body driven by a mode, for example, of mechanical displacement of at least one linear or swivel cylinder (the most optimal, because the rotation striking action is carried out from top to bottom and, also, because it is easier to locate), where the impact body is fixed to its rod, as well as at least one sealing (or cauterization) system unit by means of a heat source such as that of at least a resistance or by ultrasound, in which this can be arranged or fixed to the (most optimal) impact body or/and to the vertical machine's sealing and cutting jaws; aiming at,
first, to generate with the impact body on the edges or areas contiguous to the shaped or unfinished container: a flap, triangular body or burr and,
second, seal at least once on at least part of one side of the triangular body flap, English fold plus flap or burr flap generated.

On the other hand, the plus flap, burr plus flap or, above all, the triangular body flap that is generated from a pre-container or flexible pad type container or half English fold or stable bottom and half pad type containers: can also be manipulated or transformed by means of other devices, procedures or methods of the 3D compack system described above in 5 patent applications also of my invention:

[PCT/ES2012/000261—WO201303903; PCT/ES2014/000041—WO2014140464; PCT/ES2015/000131—WO2016042176A1; PCT/ES2015/000174—WO2016087690A1; PCT/ES2016/000085—WO2017021570A1].

A choice can be made, without claiming to be restrictive as to the extent of the protection, in a random, combined and/or repetitive manner from among at least one or more of any of the following options for handling a flap:
seal at least once at least part of at least one side of the triangular body flap or plus flap.
fold or bend the triangular body flap or plus flap over itself and seal at least once by at least one sealing line on at least one side {this circumstance means that, prior to folding the flap (15) on itself, the clamp (1a; 1b) has to be opened at least enough so that it can be released and thus the part of the flap (15; 11; 12) be able to move or rotate, or the part of the wrapper, film, sheet, tube or semi-tube, which is or is held, rammed or blocked by the clamp (1a; 1b) when it is in the closed position}
fold or bend the triangular body flap or plus flap over itself and seal it at least once at least part of it, and also cut at least once with at least part of the rest of the resulting triangular body flap or plus flap;
seal at least once at least part of one side of the triangular body flap or plus flap, fold it or bend it over itself and seal at least part of it once;
seal at least once at least part of one side of the triangular body flap or plus flap, fold it or bend it over itself and seal at least once at least part of at least one side of it and also cut at least once at least part of the rest of the triangular body flap or the resulting plus flap;
seal at least once at least part of one side of the triangular body flap or plus flap, and cut at least once at least part of it;
seal at least once at least part of one side of the triangular body flap or plus flap, and cut at least once at least part of it, fold it or bend it and seal at least part of it once, or also join the rest of the resulting flap or plus flap: to the rest of the container by means of a way of adhering it such as contact glue, a staple or a strip of tape;
fold the triangular body flap or plus flap;
fold the triangular body flap or plus flap and put it together with the rest of the container by means of a way of adhering it such as contact glue, a staple or a strip of tape; and
seal at least once at least part of at least one side of the triangular body flap or plus flap; fold it and, optionally, put it together with the rest of the container at least once at least part of it by means of a way of adhering it such as contact glue, a staple or a strip of tape.

Device to Stretch the Wrapper by Means of Arms or Blades Before the Flap, Triangular Body, English Fold or Burr Plus Flap is Generated

A device to widen and stretch the wrapper of the pre-container lengthways (forward and backward) or/and widthwise (towards the sides) of the area, nearby area or area further up from where the flaps are generated (flap, triangular body flap, English fold plus flap, stable bottom plus flap, burr flap or burr plus flap), by means of a support body mode such as arms or blades as tensioners ((they can also be extendable and/or telescopic) that are fixed to the forming tube and remain inside the wrapper; in such a way that it will produce an effect in the area of expansion or configuration of the shape of the container to be obtained, prior to being sealed and/or if the pre-container is an individual unit sealed or not tightly.

This device will be arranged or located at the height (or approximately) of the pre-container: intended to facilitate, on the one hand, the formation of the geometric shape of the container or pre-container in the optimum dimensions (especially in a pad type container) and, on the other hand, to prevent the formation of folds in the area where the flap, second flap over English fold, triangular body or, for example, the burr of the 3D plus system is to be generated.

Device to Insufflate at Least One Fluid into the Pre-Container Before the Flaps of the Invention are Generated

A device to widen and inflate the wrapper of the pre-container but, above all, by the area, nearby area or area further up from where the flaps of the invention are generated (triangular body flap, English fold plus flap, stable bottom plus flap, burr flap or burr plus flap), by means of a way to insufflate a fluid such as air and/or gas; in such a way that a general inflation effect will be produced (or/and inflation aimed at specific areas where the flap, triangular body, English fold or burr plus flap of the pre-container is generated) or configuration of the shape of the container to be obtained, before being sealed and/or if the pre-container is an individual unit sealed or not tightly.

This device will be arranged or located inside the wrapper and fixed to the forming tube, as well as optionally at least one air blowing tube can be directed (e.g. with at least one air blowing tube hinged so that it can be bent) by positioning it right inside the wrapper of the pre-container in the position and/or at the height (or approximate) where the flap, triangular body, English fold or burr plus flap is generated: intended to
on the one hand, enable the geometrical shape of the container or pre-container to be formed in the optimum dimensions (especially in a pad type container) and,
on the other hand, that no folds are formed in the area where the flap, second flap over English fold, triangular body is to be generated

Device to Stretch the Wrapper by Means of Suction Cups Before the Flap, Triangular Body, English Fold or Burr Plus Flap is Generated

A device to widen and stretch the wrapper of the pre-container lengthways (forward and backward) or/and widthwise (towards the sides) of the area, nearby area or area further up from where the flap, triangular body, second flap over English fold or burr plus flap is generated, by means of a mode of at least one suction cup, with or without air aspiration.

These will be fixed outside the wrapper to at least one element or part of the packaging machine, as well as, optionally, at least one suction cup can be fixed to the rod of a linear or rotating cylinder to approach the wrapper; in such a way that it will produce an effect in the area of expansion or configuration of the shape of the container to be obtained, prior to being sealed and/or if the pre-container is an individual unit sealed or not tightly.

Conical Flap Removal Device

This device will act, before at least one flap is generated (plus flap; burr plus flap, triangular body flap; manipulated triangular body flap (15) to the left and right of the top of the following pre-container, a cone-shaped flap without folds will be generated, by means of a conical flap removal device, in such a way that it will facilitate the following generation in/on this conical flap: at least one flap (plus flap; burr plus flap, triangular body flap; manipulated triangular body flap (15) without folds, wider or broader.

The device consists of the following elements or parts:
On the one hand, at least one support body such as a blade, arm, claw or even a chest of drawers. These are driven mechanically, e.g. by a rotary or swivel actuator or at least a linear cylinder, in which the support bodies are located on the left and/or right, preferably from the middle or middle down of the side face of the following pre-container or, in the case of the drawer unit, it will be fixed right below the following pre-container so that the same can be pushed in, from the middle down (or approximately).

These device elements will preferably be fixed to the axis of a rotary or swivel actuator or to the rod of a linear cylinder (if the following pre-container is to be pushed or moved from the sides and/or from the bottom); intended to:
in the case of being attached to a rotary actuator, flip over to the left or/and the right side the following pre-container which is secured transversely at the top by the sealing and cutting jaws (1), and
in the case of being fixed to a linear cylinder, move, preferably, laterally or laterally upwards, or diagonally upwards; and,
on the other hand, of at least one swivel (or rotary) actuator or of at least one pneumatic or electric linear cylinder, fixed to a support mode facing at least one lateral side or that of the front or back side of the pre-container or container, and on which its axis is arranged at a height right over the middle or middle down (or approximately) of the pre-container, and facing the front and back sides of the pre-container or container;

The device is preferably fixed under the sealing and cutting jaws (1) in front of the following pre-container, and at the middle or the middle down the front or back side of the following pre-container (located under the sealing and cutting jaws (1)), and secured transversely by the same at the top of the pre-container: intended to
move the pre-container or container with a pendular (or linear) movement to the left and/or right and in a rotation degree between 1° and 90° (or approximately), with 45° being the most optimal but that, in any case, depending on the dimensions, volumetry and the quantity of fluid packed inside (more fluid, less swivel or rotation degrees); in such a way that, when turning, pressure will be exerted by impacting into the pre-container {the bottom part of the sealing and cutting jaws} with {the part from the middle up, apex or area of a forth up from the top (or approximately) towards where the pre-container is directed with the pendulum movement; producing a local inflation area in the area of a forth up from the top (or approximately) of the pre-container that has not been impacted by the sealing and cutting jaws (1); obtaining:
at least one support side or additional transitional side in the area of the pre-container with which the sealing and cutting jaws impact (1) and,
a flap with an inflated conical configuration, without folds, in the {apex area or quarter area (or approximately) of the top part of the pre-container} opposite {to the other part of a quarter from the top of the pre-container that has been impacted by the sealing and cutting jaws (1).

Pressing Platform or Pressing Drawer Device

This device will be located right under the following pre-container that is found under the sealing and cutting jaws of the vertical packaging machine.
It consists of a support base (adjustable), preferably with a drawer, where the part from the middle down (or approximately) of the following pre-container will be inserted inside the pressing drawer or will rest on the pressing platform: intended to press the following pre-container that is located between the pressing platform and the surface under the sealing and cutting jaws, upwards: obtaining
   a following pre-container that has been crushed and widened from three fifths to the top (or approximately), to facilitate the generation of wider plus flaps in relation to the side or lateral side of the pre-container, and the pre-container will acquire a cubic shape from the middle up (or approximately).
The pressing platform or drawer will be moved upwards, by means of a mechanical mode such as a linear cylinder actuator arranged in a vertical position (from the bottom up) and fixed to a support, where the underside of the pressing platform or drawer is fixed to the actuator's rod: intended to push the following pre-container upwards, until it is crushed against the underside of the sealing and cutting jaws (1).

Ramming Device Immobilizer of the Support Side of the Previous Pre-Container

This device will be located under the forming tube and/or preferably inside and under the whole forming tube.

The device comprises the following elements:
an impact body by means of a rammer mode, preferably flat and of the same geometrical shape as that of the support side that acts as a base, preferably square or circular, but that in any case, this impact body will be defined by a perimeter structure (preferably quadrangular or circular), as a chassis, which is hollow in the area right under (or approximately) the forming tube, to allow the product to be packed to fall down the forming tube into the previous pre-container, without any part of the rammer intervening.

The rammer may be smaller or narrower on at least one of its sides (or the perimeter outline) so as to free up space in the area between the outer perimeter of the previous pre-container support side and the lateral sides or the outer perimeter of the rammer, so as to allow the plus impact bodies, when operated, to fold at least part of the bottom area of the wrapper of at least one side or lateral side: over at least part of at least one side or outermost area of the wrapper of the supporting side, thus generating at least one plus flap, and
a drive mode by mechanical means such as a linear actuator or pneumatic or electric linear cylinder, on whose rod is fixed to the rammer at at least one point.

This device is intended to ram and immobilize with the impact body rammer: the support side or face that acts as a base of the previous pre-container, blocking the wrapper which is between the rammer (located on top) and the surface (preferably flat) of the top part of the sealing and cutting jaws, located under the wrapper.

The procedure for the ramming device is the following:

A first step, in which the wrapper, that wraps the forming tube, advances until it surpasses the sealing and cutting jaws; then, it is closed by trapping and holding the wrapper and, at the same time, optionally, the English fold flaps and/or the flat English fold flaps can be generated or not.

A second step, where the rammer impact body is operated, which is fixed inside the forming tube and is therefore also located inside the following pre-container (the wrapper in an initial three-dimensional geometric body shape that is between the sealing and cutting jaws and the forming tube): thus blocking and immobilizing part of the base side so that the pre-container does not move, shift or lift, thus making it easier to optimally generate the plus flaps at a later date.

A third step, in which at least one plus impact body is operated from on top and/or under the sealing and cutting jaws, where there is also a pre-container secured and trapped by the sealing and cutting jaws: obtaining
at least one plus flap, because at least part of at least one side or face of the lower part of the previous pre-container wrapper has been folded: in at least part of the contour or perimeter area and/or the area contiguous to the perimeter (or outer or borderline area) of the inner side of the supporting side, thus generating at least one plus flap.

A third step, in which once one or more of the plus flaps have been generated, the rammer impact body returns to the initial standing position and,
the sealing and cutting jaws, seals and cuts or just cuts (since it has been previously sealed once the sealing and cutting jaws were closed):
the lower part of the previous pre-container and
the lower part of the following pre-container.

The sealing and cutting jaws are then opened and the processing cycle for the flexible 3D plus containers begins again.

Extendable and Retractable Forming Tube Device

This device has two forming tube sections (preferably square or cylindrical), one of which is underneath the other, this being the one that is mobile, driven by means of a mechanical mode such as: that of at least one linear cylinder, which is fixed to the inner side of the forming tube at the top, which is stationary and fixed to the vertical machine.

The mobile forming tube will extend or move downwards: a distance or length less than the gap between the lowest part of the mobile forming tube itself and the radius of action of the impact bodies ( ) of the invention that generate the plus flaps; in such a way that it will allow these impact bodies to rotate completely until they reach the sealing and cutting jaws (1) without the mobile forming tube blocking their passage. Likewise, when the plus impact body ( ) is completely rotated, the wrapper must be able to move downwards to form the fold of the plus flap generated, so that the wrapper that is on top of the sealing and cutting jaws (1), which is in the closed position: must be loose so as to allow the plus impact bodies of the invention to move completely without tearing the wrapper, and finally be able to generate from the plus flaps, as it can be inserted into the said gap by folding part of the side wrapper over another part of the wrapper on the flat support side (or side acting as a base) of the bottom part of the previous pre-container.

The mobile forming tube, is therefore intended to facilitate, on the one hand, that the wrapper of the previous pre-container is widened from the bottom and, on the other hand, that the wrapper is kept taut or stretched to prevent folds from forming, facilitating the optimal folding of the wrapper when the plus flap is generated.

The procedure is the following:

Once the wrapper of the previous pre-container is secured and blocked by the sealing and cutting jaws (1) and preferably before the previous pre-container is filled with the product to be packaged and the plus flaps are generated:
the mobile forming tube, will be moved downwards and parallel to the fixed tube, by means of a linear cylinder which is fixed to the inner side of the forming tube and to which the mobile forming tube is fixed on its rod,
then, at least one of the sealing and cutting jaws (1) is operated, driven by the rotary actuator, generating a plus flap. This plus flap is also sealed immediately afterwards,
next, immediately afterwards, the impact body plus flap and the mobile forming tube returns to the initial starting point and,
finally, the inside of the previous pre-container is filled with the contents to be packed, that fall from a multi-head dosing or weighing machine located on top of the two forming tubes ( ).

Next, the following processes of the transformation process of the 3D plus system of the invention will be given.

A third object of the invention, is that of a vertical packaging machine for pre-containers or flexible containers (in film on a roll or, for example, laminates, in tube or semi-tube) with more different applications that add to the characteristics of the vertical machine itself or, likewise, that of perfecting or improving a vertical packaging machine that produces (forming a three-dimensional shape, filling and sealing) pre-containers or flexible containers (in film on a roll or, for example, laminates or in tube or semi-tube). These machines make or produce flexible containers or pre-containers, for example, English fold, stable bottom, pad, English fold and pad, stable bottom or pad or stand up.

The pre-container, is the flexible container that still remains in the vertical packaging machine, being processed and/or transformed not yet being an individual container unit as it has not been completely closed or tightly sealed, as well as not having been sealed or cut at least one of its sides. There are two types of pre-containers:

A—The previous pre-container is part of the wrapper, film, sheet, tube or semi-tube that is of a three-dimensional tubular geometric shape, as well as remaining open in the vertical packaging machine on at least one side. It is located between the forming tube and between the sealing and/or cutting jaws in the closed position, which has not yet acquired the final intended geometrical shape, and the pre-container may or may not contain the product to be packaged inside.

B—The following pre-container or post-container is part of the wrapper, film, sheet, tube or semi-tube that is of an unfinished geometric body shape, or finished, that remains closed in the vertical (horizontal or, for example, inclined or diagonal) packaging machine, and is located right under the sealing and cutting jaws that hold it in place when operated in the closed position. It has not been cut yet, so it is not a single packaging unit. The post-container may or may not contain the product to be packaged inside.

The container, is the one that has been cut and is not part of the wrapper since this is an individual flexible packaging unit, which has acquired the intended geometric body shape.

There are two types of containers:

A—The container sealed on all sides and closed in its entirety.

B—The container open on at least one of its sides or closed in its entirety: intended to be an empty container that will be taken to the production plants to be filled with the product to be packaged and sealed tightly.

Next, different machines of the invention are exposed depending on the type of forming tube and of the model of the final container that is intended to be obtained: Vertical packaging machine for flexible containers of, for example, the English fold, stable bottom or Pad type, consisting mainly of a forming tube (e.g., of a square or cylindrical shape), of at least one set of sealing and cutting jaws, of a device of at least one impact body to generate (at least one plus flap of the invention and/or at least one triangular body flap) and/or burr plus flap, as well as of at least one heat source for sealing.

The invention involves a refinement and improvement of these vertical (or, for example, horizontal or diagonally inclined) packaging machines for flexible containers which contain at least one fluid and, optionally or additionally, may contain, for example, solids or/and (granules or/and powders), Therefore, the invention is applicable as a device or devices to install and couple to vertical (or, for example, in horizontal or diagonal) machines already existing in the market, which can be new (in-plant manufacturing) or also vertical machines that are already operating in production plants; in both cases these machines comprise:
means of generating container bodies, such as a square or cylindrical forming tube, and
a method of filling the contents to be packaged into the container, such as a dosing weighing machine, and
at least one jaw device or set of two parallel jaws with which flexible containers are transversely and horizontally (top and bottom) sealed and cut, and
optionally or additionally, a sealing mode intended to seal lengthwise, at least once, the wrapper or sheet that wraps the forming tube by adopting its shape, and
optionally or additionally, means of generating at least one English fold type flap of a triangular configuration;
   where the machine is characterized because it has:
at least one 3D plus device of the invention, intended to hit, by means of an impact body mode, at least part of at least one side or lateral side or edge, or area contiguous to the edge, or also area of a apex or area of two sides or contiguous sides of the container or pre-container: generating a flap ( ), triangular body flap ( ), plus flap, burr plus flap ( ) or cut triangular body flap. The plus impact body must be fixed, for example, to the sealing and cutting jaws, to a support fixed to the machine or to at least one component or part of the machine, and must be arranged so that the rod or the impact body reaches the side or lateral side of the pre-container, and
at least one sealing system {one for each plus flap ( ), burr plus flap, triangular body flap ( ) or triangular body flap in the form of a strip (23) longitudinal to the middle of the flap}, by means of a heat source such as a resistance, laser or ultrasound; arranged close to the top or bottom of the side or lateral side, as for example, more optimally, is attached to the same impact body, that generates the plus flap or triangular body flap, as well as may be attached to the sealing and cutting jaws. Likewise, it can also be fixed to the surface or side, preferably flat on the top and/or bottom of the sealing and cutting jaws: intended to
   seal at least once with at least one sealing line at least part of at least one side of at least one English fold plus flap, stable bottom plus flap, burr plus flap, triangular body flap or strip flap, defined in the previous step; obtaining:
   at least one sealing line that will permanently keep at least one of the support sides or additional side, or the area limited by a support contour or additional side, stable as well as permanently keeping the English fold plus flap, stable bottom plus flap, English fold burr plus flap, flap plus stable bottom burr plus flap or triangular body flap, stable.

Optionally, the vertical packaging machine for flexible containers can also have the following elements, devices, procedures or processes:

1.—a device designed to provide a sealed burr around the entire perimeter of at least one of the lateral sides of the so-called stable-bottomed containers, located on the sides of the forming tube, preferably square; in which, first, by a means such as a mechanical method, at least one edge fold will be generated on at least one lateral side of the pre-container or container and, second, at least one sealing system, by means of a heat source such as a resistor or by ultrasound, to seal at least part of the edge or area of the edge generated.

2.—A device intended to widen and stretch the wrapper of the pre-container lengthways (forward and backward) or/and widthwise (towards the sides) of the area, nearby area or area further up from where the English fold plus flap, stable bottom plus flap, burr plus flap, triangular body flap, triangular body flap folded or bent over itself, burr flap, triangular body flap cut and sealed in a strip are later generated.

The devices are the following, without claiming to be restrictive as to the scope of protection of the invention:
2.1 at least one system of rods or frame as a tensioner (may be extendable and/or telescopic), which are fixed to the inner side of the forming tube remaining inside the wrapper and of the previous pre-container, which is secured on the sealing and cutting jaws, and which has not yet been sealed or cut by the upper part of the pre-container, by means of a cutting mode.
2.2 At least one system of suction cups to stretch the wrapper from the outside, with or without air suction, or also by means of air directed into the previous pre-container (e.g. from the inside of the forming tube by means of at least one air tube (hinged or not) connected to an air pump; in such a way that it will produce an effect, in the area or in the pre-container, of three-dimensional inflation and pre-forming of the intended geometrical shape.

This device is to be arranged or located at the height (or approximately) of the pre-package: it is intended to facilitate, on the one hand, the formation of the geometrical shape of the container or pre-container in the optimum dimensions (especially in a pad type container) and, on the other hand, to prevent the formation of folds in the area where the plus flaps of the invention are to be generated.

3.—The vertical (or, for example, horizontal) packaging machines that produce flexible pad type containers or also hybrid flexible containers, English type from the middle down and pad type from the middle up, there will be a device to fold or bend at least once at least part of a triangular body flap (or strip) over at least part of another part of it. The procedure involves the following steps:
a first step, optional and before the flap, triangular body ( ) or strip ( ) [the strip is generated by sealing and cutting at least part of at least two segments of the flap or triangular body on the left and right side] is folded or bent over itself. The following will be done:
   at least part of at least one side of at least one sealing line ( ) through at least one side of the triangular body flap ( ) or strip ( ), in such a way that it will subsequently facilitate the folding or bending of the triangular body flap ( ) or strip ( ) by at least any one of the sealing lines ( ) which have been intended to be made and,
a second step, once the flap or triangular body ( ) or strip ( ) has been folded or bent at least once over itself:
   seal at least once on at least one side of at least part of the edge and/or contiguous area to the edge that has been generated by folding or bending the flap, triangular body flap or strip at least once over itself, in such a way that it will cause the flap, triangular body flap ( ) or strip ( ) to be permanently held in place folded or bent at least once over itself.

4.—Any other device, procedure, process or, likewise, different ways of manipulating the flap, triangular body or edge of the 3D plus system, reflected and protected in four patents of Invention prior to this Description of the Invention Report; they are the following: PCT/ES2012/000261—WO201303903; PCT/ES2014/000041—WO2014140464; PCT/ES2015/000131—WO2016042176A1; PCT/ES2015/000174—WO2016087690A1; PCT/ES2016/000085—WO2017021570A1.

A forth object of the invention, the different and unique types of flaps generated on the pre-containers or containers; these are the following:
English fold plus flap, it has a triangular trapezoid shape, and is generated in the area or contiguous area (on top or/and under) or/and (to the left or/and right) of the lateral face or side of the pre-container or container in which, previously, an English fold vertical flap has been generated, this is of a triangular configuration shape arranged in a sloping plane (or curvilinear sloping) position.

Subsequently, this English fold plus flap is preferably sealed at least once on at least one side of at least one sealing line, by means of a heat source such as a resistor.

Also, optionally, the flap may be adhered by means of a method such as contact glue or by means of grippers).
flat English fold plus flap, it has a rectangular trapezoid shape, and is generated in the area or contiguous area of (on top or/and under) or/and (to the left or/and right) of the lateral face or side of the pre-container or container, preferably on the lateral side of the bottom. This English fold plus flap is made on English fold type pre-containers or containers or also those that are English fold from the middle down and pad from the middle up. In any case, this flap is generated in an area on the lateral side or nearby area, preferably in the lowest part of the pre-container or container, where the English fold has been previously generated and also, at the same time, a folded flap with a triangular configuration has been generated in a horizontally oriented plane, in which the flap, starting from the outermost side, is inserted into the pre-container or container, right on top of the lower end of the side that acts as a support side. Subsequently, this flat English fold plus flap is sealed on at least part of at least one side of at least one sealing line.

Also, optionally, the flap may be adhered by means of a method such as contact glue or by means of grippers).
stable bottom plus flap, this flap and sealing line is generated in the same way and in the same area as the flap and sealing line generated in the English fold plus flap. The only thing that changes is that, previously, it has been generated longitudinally in at least part of the wrapper of at least one of the four edges and/or contiguous zones to the same, defined by the forming tube:
at least one fold of at least part of the adjoining wrapper of two contiguous sides forming an edge, by means of a mechanical folding method, and
at least part of at least one side of at least one sealing line in the fold, by means of a heat source such as a resistor.

The fold and the seal sealing line will be carried out at the same time, continuously and simultaneously, as the wrapper advances down the forming tube, in this case, quadrangular.

Therefore, when the stable bottom plus flap and its corresponding sealing line are generated, it is going to be done (both at the top and at the bottom of the container) on this fold and vertical edge sealing line that partially or perimetrically borders the lateral side, and this I will call lateral side vertical edge flap: obtaining

a side that makes a wider and more square base, as well as produces a greater consistency, rigidity and stability of the pre-container or container. This fold and sealing line of this lateral side vertical edge when the English fold flap is generated: will be arranged in a curved position, but then it turns into a vertical or vertical inclined inwards position.
flat stable bottom plus flap, this flap and the corresponding sealing line is generated in the same way and in the same area as the flap and sealing line generated in the flat English fold plus flap. The only thing that changes is, that at least one vertical edge flap has also been generated on the lateral side.

This lateral side vertical edge flap is preferably made on the entire two vertical edges of the lateral side that wraps the forming tube of the vertical machine so that when the container or pre-container is closed or sealed on top and underneath: a vertical edge flap is obtained on the entire perimeter of the lateral side; so that, when the flat English fold plus flap is generated, in the area of the pre-container or container where it is widened and the English fold is generated horizontally: the fold and sealing line of this lateral side vertical edge will also be in a horizontal position, but will then turn into a vertical or vertical inclined inwards position.

Therefore, when the flat stable bottom plus flap and its corresponding sealing line are generated: this will be made (in the upper part or/and in the lower part of the container) on this fold and vertical edge sealing line arranged in at least part or all of the lateral side perimeter, as well as on the triangular shaped flap arranged inside the container, which is optionally generated when making the English fold: obtaining a side that makes a wider and more square base.
English fold burr plus flap, it is of a rectangular trapezoid shape, and it is made on at least one edge or area contiguous to it generated (on the front side or/and the back side) or/and (on top or/and under) the pre-container or container but which, in turn, has also been generated on the sides or lateral sides of the container or pre-container and on top or/and under: at least one flat or inclined English fold plus flap.

The burr flaps of the lower and upper front and back side of the pre-container or container make the container or pre-container more stable and consistent. Also, the burrs on the top side can be in turn sealing lines, which can be removed by pulling on at least part of the wrapper from the side containing the English fold burr plus flaps.

This burr flap is generated in two steps, first, the area or contiguous area on the upper and lower side of the edge is crushed or joined: generating a fold and, second, at least one side of at least part of at least one sealing line is sealed by a heat source such as a resistor.

Also, this flap can be generated after or before the flaps on the side of the pre-container or container are generated.
stable bottom burr plus flap, this flap and sealing line is generated in the same way and in the same place and area as the one generated in the English fold burr plus flap.

The only thing that changes is that a vertical edge flap has also been generated on at least one of the lateral sides of the pre-container or stable bottom type container.
burr flap, this flap and sealing line is generated in the same way and in the same place and area as the one generated in the English fold burr plus flap. The only thing that changes is that it is generated in a pre-container or pad type container, or half pad type and half English fold or stable bottom, so it will be generated next to the lateral side where a triangular body flap, manipulated triangular body flap, or a flap folded over a triangular body is generated. Likewise, a triangular body can also be considered as a burr flap with its corresponding sealing line: if it is made, for example, in the middle of the edge or the front or back side of the top or/and bottom of the pre-container or container, since this is not made by mounting on top or on at least part of the flap or the fold of the: English fold flap, flat English fold plus flap and a flap on a English fold bottom.
flap, it is not of a triangular shape, and preferably it is of a trapezoid shape because it has been cut and sealed, for example, from a triangular flap.

The resulting flap will preferably be sealed. The flap can also be adhered by means of a method such as contact glue or by means of grippers.
triangular body flap, it is of a triangular shape and is generated, by means of an impact body, when this hits on the side or lateral side (left or/and right) or/and (on top or/and bottom) of a pre-container or container, for example, of a pad type or also mixed: half English fold or stable bottom type and the other half pad.

Optionally, at least part of at least one side can be sealed by at least one sealing line of the triangular body flap, preferably at the intersection of the flap and the rest of the body of the container or pre-container.
manipulated triangular body flap, it is the same as the triangular body flap, being sealed or not, but, in this case, it will be manipulated, by means of a 3D or 3D plus compack mode, being able to choose in a random and combined and/or repetitive way from at least one or more of any of the following options:

[Not Intended to be Limiting as to the Scope of Protection of the Invention] fold and adhere the flap by means of a way such as contact glue or by means of grippers; seal only; fold and seal; seal, fold and seal; seal and glue; seal, fold and glue; seal and cut; seal, cut and glue; cut, seal and glue; fold or fold on itself and glue; seal, fold or fold over itself and glue; fold or fold over itself and seal; seal, fold or fold over itself and seal; seal, fold or fold on itself, seal and cut; fold or fold on itself, seal and cut; fold or fold on itself, seal and glue; seal, fold or fold on itself, seal and glue; seal and cut, fold or fold on itself; seal and cut, fold or fold on itself and glue; seal and cut, fold or fold on itself and seal.
triangular body flap folded over itself, it is a manipulated triangular body flap that is generated, in a preferential way, by folding or bending at least once at least part of this triangular body flap (sealed or not previously) over at least part of another part of it.

A fifth object of the invention, are the different and unique sealing lines applied to the different types of flaps of the invention generated from a flexible container (sealed on all its sides, as well as closed in its entirety by all of the external contour) or flexible pre-container (it has not been sealed in its entirety and still remains in the vertical packaging machine as part of the wrapper that goes down the forming tube, as well as it has almost completely acquired the intended geometric body shape but still remains open at the top, so as to subsequently be filled inside with the product to be contained).

They are applied right after the impact body upon impact generates at least one flap on at least one side or lateral side of the top and bottom part of the container or pre-container, e.g.

English fold or stable bottom type.

Different sealing lines can be distinguished:

English Fold Plus Flap Sealing Line (25a)

This is done on top and/or under a plus flap generated on the English fold, which is positioned vertically (or, e.g., inclined, curved or diagonally) and not in a horizontal plane, since the pre-container or container does not rest or sit on the flat surface of the side on top of and under the sealing and/or cutting jaws: obtaining, a permanent English plus flap, which is either rectangular-triangular or rectangular in shape, depending on the verticality or inclination of how the English plus flap is located prior to generating the English plus flap, as well as the side or lateral side area of this plus sealing line, an oval-triangular cavity or hole is formed.

Flat English Fold Plus Flap Sealing Line (25b)

This is done on top and/or under a plus flap generated on the English fold, which is positioned horizontally, because the pre-container or container rests or sits on the flat surface of the upper and lower side of the sealing and/or cutting jaws: obtaining a permanent English fold plus flap, which is of a rectangular shape, as the area of the side or lateral side contiguous to this flat English plus fold sealing line, is of a flat shape arranged vertically.

Stable Bottom Plus Flap Sealing Line (25c)

It is made in the same way and produces the same effect as the one made in the English fold plus flap sealing line but, in this case, this sealing line can also be mounted on top (if it is made on the top side or on the inside one) and arranged below (if made on the bottom side or on the outside one) of the lateral side vertical edge flap previously generated on at least one lateral side of the pre-container or container.

Flat Stable Bottom Plus Flap Sealing Line (25d)

It is made in the same way and produces the same effect as the one made in the flat English fold plus flap sealing line, but, in this case, this sealing line can also be mounted on top (if it is made on the top side or on the inside one) and arranged below (if made on the bottom side or on the outside one) of the lateral side vertical edge flap previously generated on at least one lateral side of the pre-container or container.

English Fold Burr Plus Flap Sealing Line (26a)

It is made on the edge (or/and contiguous area to it) of the bottom (or support) side or/and top of the front or back side of the pre-container or container, in which this edge is more optimal when it is previously arranged with the sides or contiguous sides at right angles, because it has been generated when the lower part of the pre-container or container was sitting horizontally: on the sealing and/or cutting jaws.

Also, this plus sealing line will be made on at least part of the English fold flap, as well as sealed at least once by at least one plus sealing line: the entirety of this edge or English fold burr plus flap that has been previously generated.

Stable Bottom Burr Plus Flap Sealing Line (26b)

It is made in the same way and produces the same effect as the one made in the English fold burr plus flap sealing line but, in this case, this sealing line will in turn be mounted on top (if it is made on the top side or on the inside one) and arranged below (if made on the bottom side or on the outside one) of the lateral side vertical edge flap previously generated on at least one lateral side of the pre-container or container.

The sealing of the different types of sealing lines is done by means of a heat source mode such as resistance or ultrasound, as well as the sealing of: at least part of at least one side of at least one sealing line of any one of the plus flaps, burr flaps, triangular flaps or manipulated triangular flaps.

These sealing lines can be made in different ways, the most significant being those described below but which, in any case, are not intended to be restrictive as regards the scope of protection of the invention:
on at least part or all of the area of intersection of the plus flap and the remainder of the container or pre-container, or
on at least one part of the flap with at least one sealing line perpendicular to the plus flap or lateral side, apex or the area contiguous to this o, for example, making
at least one sealing line in the apex forming the top and lateral sides of the plus flap, so that at least part of two contiguous faces are sealed, or this sealing line carried out in the apex and in turn at least part of a sealing line in the area of intersection of the plus flap and the container; or, for example,
on at least part of at least one side of the plus (English fold and/or burr) flap of at least one sealing line in the form of a circle, a square or in diagonal.

In order for these sealing lines to be carried out, the following two steps must first be taken:
a first step, in which the English fold flap is generated [two folds of a triangular configuration parallel in the direction of the inside of the container and which can be arranged in a horizontal plane or in an inclined plane depending on the shape of the container or pre-container or if the latter, for example, is of the English fold or of a stable bottom type in the upper and/or lower part of the pre-container or container: obtaining an inflation effect in which the pre-container or container acquires a three-dimensional rectangular prism or a parallelepiped geometric body shape and,
a second step, of impacting by means of an impact body in/between/on at least part of at least one side face or lateral side, or, the contiguous area/area around/area of the contiguous side face/intersection area of the lateral side (optionally, at least part of at least one contiguous side can also be added): containing the English type flap or English fold.

It is optimized the most when the sealing is carried out, preferably, in the intersection area of the generated flap and the rest of the pre-container's (the one that has not yet been tightly sealed) or container's (a completely sealed individual unit) body.

This sealing line, of the invention of the English fold plus flap, flat English fold plus flap, stable bottom plus flap and flat stable bottom plus flap, English fold burr plus flap and stable bottom burr plus flap, gives the container or pre container a greater stability, consistency and rigidity, due to the following three reasons:
when the trapezoid—triangular or trapezoid—rectangular flap is generated, it makes the container or pre-container widen even more, and it also makes the lower side, that serves as a support base, more square.
by sealing, preferably, in the intersection area of the generated flap and the rest of the container body, it makes this area of the wrapper harden because of the thermoplastic reaction due to the effect of the heat.
by making the sealing line in the middle of the lower side, the one that acts as a base {generated by making the English fold, this being the sealing line that materializes when the pre-container is tightly sealed on the lower side, and which is now located in the middle of the lower side that acts as a base}: it remains permanently attached to the rest of the container without protruding outwards, so that a completely flat side is permanently obtained, as well as it being innocuous since, in some cases, contact glue is used to produce the same effect by gluing the top part of the wrapper which is folded into a sheet to one side.

A sixth object of the invention, is a container obtainable, in accordance with the methods proposed above, as well as the preferential realizations of such methods of container processing, comprising a first stage of pressing to define the flap and, subsequently, optionally, at least another manipulation stage of at least one flap of at least one container or at least one pre-container, in which one is to choose, for example, a random and combined and/or repetitive manipulation mode from among at least one or more of any of the following options:

fold and adhere the flap using a method such as contact glue or by using grippers; seal only; fold and seal; seal, fold and seal; seal and glue; seal, fold and glue; seal and cut; seal, cut and glue; cut, seal and glue; fold or fold over itself and glue; seal, fold or fold over itself and glue; seal, fold or fold over itself and seal; seal, fold or fold over itself, seal and cut; fold or fold over itself, seal and cut; fold or fold over itself, seal and glue; seal, fold or fold over itself, seal and glue; seal and cut, fold or fold over itself and glue; seal and cut, fold or fold over itself and seal.

All of the containers of the invention may contain at least one fluid and, optionally or additionally, may also contain, for example, at least one solid or solids, granules or powders. For example: [(air or/and gas) or/and (liquid or/and paste)] or/and [(solid/solids or/and granules) or/and powders)].

The invention is applicable to either containers or pre-containers, closed or sealed in their entirety along the entire contour, lateral side or perimeter area, as well as to containers or pre-containers open or not sealed in their entirety along the entire contour, lateral side or perimeter area.

Once the container of the invention has been manufactured and the product to be packed is inside it, optionally, it is also possible to extract gaseous fluid (air or/and gas) before being closed or/and sealed in its entirety, in order to obtain a container that will take up less space.

According to the preferential object of the invention, the containers of the invention have the common denominator of containing:
[at least one English fold plus flap or/and at least one flat English fold plus flap. These are made in the area or contiguous area of the lower or/and higher part and to the left or/and right: of the side/lateral side or edge of the pre-container or container on the left and right side of the container] or/and
[at least one stable bottom plus flap/and at least one flat stable bottom plus flap. These are made in the area or contiguous area of the lower or/and higher part and to the left or/and right of the side/lateral side or edge of the pre-container or container] or/and
[at least one English fold burr plus flap or English fold burr plus flap. These are made in the area or contiguous area of the lower or/and higher part and to the left or/and right: of the side/lateral side or edge of the pre-container or container].

The containers are of many different shapes, and of different uses or characteristics, depending on the following factors: [Not being restrictive as to the scope of the invention]

1) Type of pre-container, following pre-container or container from which we start to transform, by means of the 3D plus system or/and 3D compack, as for example: the pad type, pillow pack, stand up, English type or English fold, stable bottom type or, likewise, mixed containers in which half or part is English fold or stable bottom and the another half or part is pad. Or also, any of the above described to which, previously or subsequently, at least part of at least one lateral side or lateral face has been sealed and cut.

2) The number of flaps generated, that determine the three-dimensional geometric shape of the container, previous pre-container or following pre-container; the most representative are: the rhomboid pyramid (one flap is generated), the cylinder (four convex flaps are generated), the inverted trapezoid (two flaps are generated), the rectangular trapezoid (cube container, rectangular prism and parallelepiped with a dosing neck in which three flaps are generated), the cube, rectangular and parallelepiped prism (in all three, 4 flaps are generated), the irregular polyhedrons (any of the above containers whose shape is altered by means of at least one cut and/or sealing of at least one side of the container or pre-container), the modified geometric bodies (any of the abovementioned containers or pre-containers), which, once at least one of the flaps has been generated, are modified into irregular shapes by making at least one sealing line in different inclination planes, and not in a straight line or in a horizontal or vertical plane, such as curved or semi-circular lines or in an inclined or diagonal plane.

3) The number or/and/type of flap(s) generated (randomly and in combination) on a container or pre-container, such as the English fold flap, flat English fold flap, stable bottom flap, flat stable bottom flap, triangular body flap, manipulated triangular body flap, triangular body flap folded over itself, vertical edge flap, burr flap or, for example, any of the plus flaps described above.

It is another additional object of the invention, that any one of the containers of the invention of this Description report, as well as of the previous ones, at least one of its sides, especially those of a cubic form, rectangular prism or parallelepiped, may generate at least one opening and closing lid by from where the product packed inside can be accessed and served, preferably, the side from the top or the front or the back of the container. The lid can be generated:
either by folding {at least part of at least one edge or area contiguous to the edge of at least one side of the container or pre-container} and sealing {at least once at least one side of at least one sealing line by means of a heat source such as a resistor}: obtaining, a burr plus flap (English fold burr plus flap or stable bottom burr plus flap) that, when pulled, detaches, creating an opening or lid through which to serve or access the packaged contents inside the container;
or, by means of delimiting or tracing {in an area of at least one side, edge or area contiguous to the edge of at least one side or face of the container, or also at the level of the entire perimeter, for example, at the same height below the flaps generated on the top of the container}:
at least one laser pre-cut (easy-to-open) line of about 7 microns (or approximately) made (by the wear or roughing technique) on at least one layer of the wrapper or, for example, plastic sheet; and on which this can be delineated by a pre-cut, for example: of a square, rectangle or circle.

Next, also object of the invention, the most representative and relevant flexible packaging of the invention are described, which are not intended to be restrictive as to the scope of protection of the invention.

A) Any of the flexible 3D plus containers or of the invention, characterized because it has at least one English fold plus flap, as well as at least part of at least one side towards at least one direction of at least one sealing line on the English fold plus flap.

B) Any of the flexible 3D plus containers or of the invention, characterized because it has at least one flat English fold plus flap, as well as at least part of at least one side towards at least one direction of at least one sealing line on the flat English fold plus flap.

C) Any of the flexible 3D plus containers or of the invention, characterized because it has at least one stable bottom plus flap, as well as at least part of at least one side towards at least one direction and on a plane or on an inclined plane: of at least one sealing line on the stable bottom plus flap.

D) Any of the flexible 3D plus containers or of the invention, characterized because it has at least one flat stable bottom plus flap, as well as at least part of at least one side towards at least one direction and on a horizontal plane or on an inclined plane: of at least one sealing line on the stable bottom plus flap.

E) Any of the flexible 3D plus containers or of the invention, characterized because it has at least one English fold plus flap, and
at least part of at least one side in at least one direction and on a plane or on an inclined plane of at least one sealing line in the English fold plus flap; just as
at least part of at least one triangular body flap folded or bent over itself at least once over at least part of another part of it, and
at least part of at least one side towards at least one direction and on a plane or on an inclined plane: of at least one sealing line on at least part of at least one side of the triangular body's folded flap.

F) Any of the flexible 3D plus containers or of the invention, characterized because it has at least one flat English fold plus flap, and
at least part of at least one side in at least one direction and on a plane or on an inclined plane of at least one sealing line in the English fold plus flap; just as
at least part of at least one triangular body flap folded or bent over itself at least once over at least part of another part of it, and
at least part of at least one side towards at least one direction and on a plane or on an inclined plane: of at least one sealing line on at least part of at least one side of the triangular body's folded flap.

G) Any of the flexible 3D plus containers or of the invention, characterized because it has at least one stable bottom plus flap, and
at least part of at least one side in at least one direction and on a plane or on an inclined plane of at least one sealing line in the English fold plus flap; just as
at least part of at least one triangular body flap folded or bent over itself at least once over at least part of another part of it, and
at least part of at least one side towards at least one direction and on a plane or on an inclined plane: of at least one sealing line on at least part of at least one side of the triangular body's folded flap.

H) Any of the flexible 3D plus containers or of the invention, characterized because it has at least one flat stable bottom plus flap, y
at least part of at least one side in at least one direction and on a plane or on an inclined plane of at least one sealing line in the English fold plus flap; just as
at least part of at least one triangular body flap folded or bent over itself at least once over at least part of another part of it, and
at least part of at least one side towards at least one direction and on a plane or on an inclined plane: of at least one sealing line on at least part of at least one side of the triangular body's folded flap.

I) Any of the flexible 3D plus containers or of the invention, characterized because it has at least one English fold plus flap, as well as at least part of at least one side in at least one direction of at least one sealing line in the English fold plus flap; and
at least one English fold burr plus flap or/and at least part of at least one burr flap made in the middle of the side or edge; and at least part of at least one side of at least one sealing line, by means of a heat source such as a resistor.

J) Any of the flexible 3D plus containers or of the invention, characterized because it has at least one flat English fold plus flap, as well as at least part of at least one side in at least one direction of at least one sealing line in the flat English fold plus flap; and
at least one English fold burr plus flap or at least part of at least one burr flap made in the middle of the side or edge; just as at least part of at least one side of at least one sealing line of the English fold burr plus flap, by means of a heat source such as a resistor.

K) Any of the flexible 3D plus containers or of the invention, characterized because it has at least one stable bottom plus flap, as well as at least part of at least one side in at least one direction of at least one sealing line in the stable bottom plus flap; and
at least one stable bottom burr plus flap or at least part of at least one burr flap made in the middle of the side or edge; and at least part of at least one side of at least one sealing line, by means of a heat source such as a resistor.

L) Any of the flexible 3D plus containers or of the invention, according to the flexible container of the letter E characterized because it additionally comprises at least one burr flap, as well as at least part of at least one side of at least one sealing line, by means of a heat source such as a resistor.

M) Any of the flexible 3D plus containers or of the invention, according to the flexible container of the letter F characterized because it additionally comprises at least one burr flap, as well as at least part of at least one side of at least one sealing line, by means of a heat source such as a resistor.

N) Any of the flexible 3D plus containers or of the invention, according to the flexible container of the letter G characterized because it additionally comprises at least one burr flap, as well as at least part of at least one side of at least one sealing line, by means of a heat source such as a resistor.

O) Any of the flexible 3D plus containers or of the invention, characterized by having at least one pre-cut line in at least part of a layer of the wrapper (approximately 7 microns) or in at least one side of the container, made by means of a laser sealing device or system mode.

P) Flexible container of the invention, that has a cubic, rectangular or parallelepiped prism shape (or also cubic, rectangular or parallelepiped prism but with at least one of its faces, edges or sides not parallel, perpendicular or in a horizontal plane, but rather the opposite: not parallel, oblique, diagonal and in inclined planes, characterized by having at least one pre-cut line in at least part of a layer of the wrapper (approximately 7 microns) or in at least one side of the container, made by means of a laser sealing device or system mode.

Q) Flexible container of the invention that has a cylindrical shape, characterized by having at least one pre-cut line in at least part of a layer of the wrapper (approximately 7 microns) or in at least one side of the container, made by means of a laser sealing device or system mode.

Next, also object of the invention are the following flexible containers, which are the most unique and representative of this Description report, without claiming to be restrictive in terms of the scope of protection of the invention.

1a) English fold type flexible container, with no defined flat English fold flap both on the left and right and on the bottom and top, also, the container can be closed or open on at least one of the sides so that the product to be packaged can subsequently be filled on the production lines, characterized because it has two plus flaps [(one English fold plus flap on the left and one on the right) from the bottom or top of the lateral side of the pre-container or container], as well as at least part of at least one side towards at least one direction of at least one sealing line on each English fold plus flap.

The container or pre-container of a rectangular prism or parallelepiped geometric body shape, where in addition the top or/and bottom or/and left or/and right can be broader, wider or square: depending on the width and length of the flaps generated on the lateral sides of the container.

Optionally, it can also contain at least one English fold burr plus flap or/and burr flap: on top and/or under the front or/and back part of the closed or open container.

1b) English fold type flexible container, with no defined horizontal flat English fold flap both on the left and right and on the bottom and top of the closed or open container on at least one side (not tightly sealed), characterized because it has two plus flaps [(one English fold plus flap on the left and one on the right) from the bottom or top of the lateral side of the pre-container or container], as well as at least part of at least one side towards at least one direction of at least one sealing line on each English fold plus flap; and
one English fold plus flap to the left or right of the top (or bottom) of the lateral side of the pre-container or container, as well as at least part of at least one side in at least one direction of at least one sealing line in the English fold plus flap.

The container or pre-container has a rectangular trapezoid geometric shape with a cone-shaped dispensing neck at the top, where in addition the top or/and bottom or/and left or/and right can be broader, wider or square: depending on the width and length of the flaps generated on the lateral sides of the container.

Optionally, it can also contain at least one English fold burr plus flap or/and burr flap: on top and/or under the front or/and back part of the closed or open container.

1c) English fold type flexible container, in which there is no defined flat English fold flap both on the left and right and on the bottom and top of the closed or open container on at least one side (not tightly sealed), characterized because it has two plus flaps [(one English fold plus flap on the left and one on the right) from the bottom or top of the lateral side of the pre-container or container], as well as at least part of at least one side towards at least one direction of at least one sealing line on each English fold plus flap; and
two plus flaps [(one English fold plus flap on the left and one on the right) from the bottom or top of the lateral side of the pre-container or container], as well as at least part of at least one side towards at least one direction of at least one sealing line on each English fold plus flap.

The container or pre-container has a cubic, rectangular or parallelepiped prism geometric body shape where, in addition, the top or/and bottom or/and left or/and right can be broader, wider or square: depending on the width and length of the flaps generated on the lateral sides of the container.

Optionally, it can also contain at least one English fold burr plus flap or/and burr flap: on top and/or under the front or/and back part of the closed or open container.

1d) English fold type flexible container, in which there is no defined flat English fold flap both on the left and right and on the bottom and top of the closed or open container on at least one side (not tightly sealed), characterized because it has one English fold plus flap both on the left or right from the top or bottom of the lateral side of the pre-container or container, as well as at least part of at least one side in at least one direction of at least one sealing line in the English fold plus flap.

The container or pre-container has a rectangular or parallelepiped prism geometric body shape but is wider and more volumetric in 3D in the area or area contiguous to the generated flap, where in addition the top or/and bottom or/and left or/and right part can be broader, wider or square: depending on the width and length of the flap generated on the lateral side of the container.

Optionally, it can also contain at least one English fold burr plus flap or/and burr flap: on top and/or under the front or/and back part of the closed or open container.

1e) English fold type flexible container, in which there is no defined flat English fold flap both on the left and right, on the bottom and top of the closed or open container on at least one side (not tightly sealed), characterized because it has one English fold plus flap to the left or/and right of the bottom (or/and top) part of the pre-container or container, as well as at least part of at least one side in at least one direction of at least one sealing line in the English fold plus flap; and
one English fold plus flap on the opposite lateral side (left or right) of the top lateral side part from where the English fold plus flap of the bottom (or top) part of the pre-container or container is generated, as well as at least part of at least one side in at least one direction of at least one sealing line in the English fold plus flap.

The container or pre-container has a parallelepiped geometric body shape where the two top sides are parallel and the two lateral sides are parallel but in diagonal and, also, the volumetry of the container is reversed from the middle up compared to the middle down: in one it widens to the left and down and the other widens to the right and up, in which the wider or longer the flaps generated the more it widens.

Optionally, it can also contain at least one English fold burr plus flap or/and burr flap: on top and/or under the front or/and back part of the closed or open container.

2a) English fold type flexible container, in which at least one flat English fold flap is defined on both the left and the right from the top or bottom of the lateral side of the container or pre-container, closed or open on at least one side, characterized because it has two plus flaps [two flat English fold plus flaps], or one English fold plus flap and one flat English fold plus flap to the left and right of the bottom (or top) part of the pre-container or container, as well as at least part of at least one side of at least one sealing line on each flat English fold plus flap or English fold plus flap.

The container or pre-container has a rectangular or parallelepiped prism geometric body shape where, in addition, the top or/and bottom or/and left or/and right part can be broader, wider or square: depending on the width and length of the flaps generated on the lateral sides of the container.

Optionally, it can also contain [(at least one English fold burr plus flap or/and at least one English fold burr plus flap) or/and at least one burr flap]: on top and/or underneath the front or/and behind the closed or open container.

2b) English fold type flexible container, in which at least one flat English fold flap is defined on both the left and the right from the top or bottom of the lateral side of the container or pre-container, closed or open on at least one side, characterized because it has two plus flaps [two flat English fold plus flaps], or, one English fold plus flap and one flat English fold plus flap to the left and right of the bottom (or top) part of the pre-container or container, as well as at least part of at least one side of at least one sealing line on each flat English fold plus flap or English fold plus flap; and
one English fold plus flap on the left or right from the top (or bottom) of the lateral side of the container or pre-container, as well as at least part of at least one side in at least one direction of at least one sealing line in the English fold plus flap.

The container or pre-container has a rectangular trapezoid geometric figure shape with a cone-shaped dispensing neck at the top, where in addition the top or/and bottom or/and left or/and right part can be broader, wider or square: depending on the width and length of the flaps generated on the lateral sides of the container.

Optionally, it can also contain [(at least one English fold burr plus flap or/and at least one English fold burr plus flap) or/and at least one burr flap]: on top and/or underneath the front or/and behind the closed or open container.

2c) English fold type flexible container, in which at least one flat English fold flap is defined on both the left and the right from the top or bottom of the lateral side of the container or pre-container, closed or open on at least one side, characterized because it has two plus flaps [two flat English fold plus flaps], or one English fold plus flap and one flat English fold plus flap] to the left and right of the lateral side of the bottom (or top) part of the pre-container or container, as well as at least part of at least one side in at least one direction of at least one sealing line on each flat English fold plus flap or English fold plus flap; and
two plus flaps [(two flat English fold plus flaps), or (one English fold plus flap and one flat English fold plus flap)] to the left and right of the top (or bottom) of the sides of the pre-container or container, as well as at least part of at least one side of at least one sealing line on each English fold plus flap.

The container or pre-container has a cubic, rectangular or parallelepiped prism geometric body shape where, in addition, the top or/and bottom or/and left or/and right part can be broader, wider or square: depending on the width and length of the flaps generated on the lateral sides of the container.

Optionally, it can also contain [(at least one English fold burr plus flap or/and at least one English fold burr plus flap) or/and at least one burr flap]: on top and/or underneath the front or/and behind the closed or open container.

2d) English fold type flexible container, in which at least one flat English fold flap is defined on both the left and the right from the top or bottom of the lateral side of the container or pre-container, closed or open on at least one side, characterized because it has one plus flap [one flat English fold plus flap or an English fold plus flap] to the left or right of the upper or lower side of the pre-container or container, as well as at least part of at least one side in at least one direction of at least one sealing line in the flat English fold flap or in the English fold plus flap.

The container or pre-container has a narrow volumetric rectangular prism or parallelepiped geometric body shape, but being wider and volumetric in 3D in the area or area contiguous to the generated flap where, in addition, the top or/and bottom or/and left or/and right can be broader, wider or square: depending on the width and length of the flaps generated on the side of the container.

Optionally, it can also contain [(at least one English fold burr plus flap or/and at least one English fold burr plus flap) or/and at least one burr flap]: on top and/or underneath the front or/and behind the closed or open container.

2e) English fold type flexible container, in which at least one flat English fold flap is defined on both the left and the right from the top or bottom of the lateral side of the container or pre-container, closed or open on at least one side, characterized because it has one flat English fold plus flap or one English fold plus flap, to the left or right of the bottom (or top) part of the lateral side of the pre-container or container, as well as at least part of at least one side in at least one direction of at least one sealing line in the flat English fold plus flap or English fold plus flap; and
one English fold plus flap on the opposite lateral side (left or right) of the bottom (or top) lateral side from where the flat English fold plus flap of the pre-container or container is generated, as well as at least part of at least one side in at least one direction of at least one sealing line in the English fold plus flap.

The container or pre-container has a parallelepiped geometric shape, where the two top sides are parallel and the two lateral sides are parallel but in diagonal, and the volumetry of the container is reversed from the middle up to the middle down: in one it widens to the left and down and in the other it widens to the right and up, in which the wider or the longer the flaps generated are on the lateral sides, the more it widens.

Optionally, it can also contain [(at least one English fold burr plus flap or/and at least one English fold burr plus flap) or/and at least one burr flap]: on top and/or underneath the front or/and behind the closed or open container.

3a) English fold type flexible container, in which at least one flat English fold flap is defined on both the left and the right from the top or bottom of the lateral side of the container or pre-container, closed or open on at least one side, and there is a definition in at least one vertical/inclined and not horizontal edge, at least part of at least one lateral side vertical edge flap (24), characterized because it has two plus flaps [two flat stable bottom plus flaps, or one flat stable bottom plus flap and one stable bottom plus flap] to the left or right of the bottom (or top) part of the pre-container or container, as well as at least part of at least one side in at least one direction of at least one sealing line in each flat stable bottom plus flap or stable bottom plus flap.

The container or pre-container has a rectangular or parallelepiped prism geometric body shape, where in addition the top or/and bottom or/and left or/and right part can be broader, wider or square: depending on the width and length of the flaps generated on the sides of the container.

Optionally, it can also contain [(at least one stable bottom burr plus flap or/and at least one stable bottom burr plus flap) or at least one burr flap on top and/or underneath the front or/and behind the closed or open container.

3b) English fold type flexible container, in which at least one flat English fold flap is defined on both the left and the right from the top or bottom of the lateral side of the container closed or open on at least one side, and there is a definition in at least vertical/inclined and not horizontal edge, at least part of at least one lateral side vertical edge flap (24), characterized because it has two plus flaps [two flat stable bottom plus flaps, or one flat stable bottom plus flap and one stable bottom plus flap] to the left or right of the bottom (or top) part of the pre-container or container, as well as at least part of at least one side in at least one direction of at least one sealing line in each flat stable bottom plus flap or stable bottom plus flap; and
one English fold plus flap to the left or right of the top (or bottom) part of the lateral side of the pre-container or container, as well as at least part of at least one side in at least one direction of at least one sealing line in the English fold plus flap.

The container or pre-container has a rectangular trapezoid geometric body shape with a cone-shaped dispensing neck at the top, where in addition the top or/and bottom or/and left or/and right part can be broader, wider or square: depending on the width and length of the flaps generated on the lateral sides of the container.

Optionally, it can contain [(at least one stable bottom burr plus flap or/and at least one English fold burr plus flap) or English fold burr plus flap or/and at least one burr flap on top and/or underneath the front or/and behind the closed or open container.

3c) English fold type flexible container, in which at least one flat English fold flap is defined on both the left and the right from the top or bottom of the lateral side of the container, closed or open on at least one side, and there is a definition in at least one vertical/inclined and not horizontal edge, at least part of at least one lateral side vertical edge flap (24), characterized because it has two plus flaps [two flat stable bottom plus flaps, or one flat stable bottom plus flap and one stable bottom plus flap] to the left and right of the bottom (or top) part of the pre-container or container, as well as at least part of at least one side in at least one direction of at least one sealing line in each flat stable bottom plus flap or stable bottom plus flap; and
two plus flaps [two flat stable bottom plus flaps, or one flat stable bottom plus flap or one stable bottom plus flap] to the left and right of the top (or bottom) of the lateral side of the pre-container or container, as well as at least part of at least one side in at least one direction of at least one sealing line in the flat stable bottom plus flap or stable bottom plus flap.

The container or pre-container has a cubic, rectangular or parallelepiped prism geometric body shape, where in addition the top or/and bottom or/and left or/and right part can be broader, wider or square: depending on the width and length of the flaps generated on the sides of the container.

Optionally, it can contain [(at least one stable bottom burr plus flap or/and at least one English fold burr plus flap) or English fold burr plus flap or/and at least one burr flap on top and/or underneath the front or/and behind the closed or open container.

3d) English fold type flexible container, {in which at least one flat English fold flap is defined on both the left and the right from the top or bottom of the lateral side of the pre-container or container, and there is a definition in at least one vertical/inclined and not horizontal edge, at least part of at least one lateral side vertical edge flap (24), characterized because it has one flat stable bottom plus flap or one flat stable bottom plus flap to the left or right of the bottom (or top) part of the pre-container or container, as well as at least part of at least one side in at least one direction of at least one sealing line in each flat stable bottom plus flap or stable bottom plus flap.

The container or pre-container has a rectangular or parallelepiped prism geometric body shape but being wider and more volumetric in 3D in the area or area contiguous to the generated flap, where in addition the top or/and bottom or/and left or/and right can be broader, wider or square: depending on the width and length of the flaps generated on the side of the container.

Optionally, it can also contain (at least one stable bottom burr plus flap or/and at least one English fold burr plus flap) or/and at least one burr flap on top and/or underneath the front or/and behind the closed or open container.

3e) English fold type flexible container, {in which at least one flat English fold flap is defined on both the left and the right from the top or bottom of the lateral side of the container, closed or open on at least one side, and there is a definition in at least one lateral side vertical edge flap (24) on each side or lateral side, characterized because it has one flat stable bottom plus flap, or one flat stable bottom plus flap to the left and right of the bottom (or top) part of the pre-container or container, as well as at least part of at least one side in at least one direction of at least one sealing line in each flat stable bottom plus flap or stable bottom plus flap; and
one stable bottom plus flap on the opposite lateral side, to the left or right, of the lateral side of the bottom (or top) part from which the stable bottom plus flap or flat stable bottom plus flap of the container is generated, as well as at least part of at least one side in at least one direction of at least one sealing line in the stable bottom plus flap.

The container or pre-container has a parallelepiped geometric body shape where the two top sides are parallel and the two lateral sides are parallel but in diagonal and, also, the volumetry of the container is reversed from the middle up compared to the middle down: in one it widens to the left and down and the other widens to the right and up, in which the wider or longer the flaps generated the more it widens.

Optionally, it can also contain (at least one stable bottom burr plus flap or/and at least one English fold burr plus flap) or/and at least one burr flap on top and/or underneath the front or/and behind the closed or open container.

4a) Flexible container, half English fold type (in which there is no defined flat English fold flap) and the other half, pad type. The closed or open container or pre-container (at least one of the sides to be filled with the product to be packaged later), characterized because it has two plus flaps, one English fold plus flap on the left and the other on the right from the bottom or top of the lateral side of the pre-container or container, as well as at least part of one side towards at least one direction of at least one sealing line on each English fold plus flap.

The container has a rectangular or parallelepiped prism geometric body shape, where also the top or/and bottom or/and left or/and right part can be broader, wider or square: depending on the width and length of the flaps generated in the container.

Optionally, it can also contain at least one English fold burr plus flap or/and burr flap: on top and/or underneath the front or/and behind the closed or open container.

4b) Flexible container, half English fold type (in which there is no defined flat English fold flap) and the other half, pad type. The closed or open container or pre-container (at least one of the sides to be filled with the product to be packaged later), characterized because it has two plus flaps, one English fold plus flap on the left and the other on the right from the bottom or top of the lateral side of the pre-container or container, as well as at least part of one side towards at least one direction of at least one sealing line on each English fold plus flap; and
a triangular body flap folded back on itself at least once over at least part of another part of it, on the left or right side of the top part of the container, and
at least part of at least one side in at least one direction and on a plane or on an inclined plane of at least one sealing line: on at least part of at least one side of the triangular body flap folded back on itself.

[At least one triangular body flap of this flexible container, as another option other than folding or bending at least once over itself, can also be manipulated to choose, for example, in a random and combined and/or repetitive manner from among at least one or more of any of the following options:

fold and adhere the flap using a method such as contact glue or grippers; seal only; fold and seal; seal, fold and seal; seal and glue; seal, fold and glue; seal and cut; seal, cut and glue; cut, seal and glue; fold or fold over itself and glue; seal, fold or fold over itself and glue; fold or fold over itself and seal; seal, fold or fold over itself and seal; seal, fold or fold over itself, seal and cut; fold or fold over itself, seal and cut; fold or fold over itself, seal and glue; seal, fold or fold over itself, seal and glue; seal and cut, fold or fold over itself and glue; seal and cut, fold or fold over itself and seal]

The container has a rectangular trapezoid geometrical shape with a cone-shaped dispensing neck at the top where, in addition, the top or/and bottom or/and left or/and right part can be broader, wider or square: depending on the width and length of the flaps generated on the sides of the container.

Optionally, it can also contain at least one English fold burr plus flap or/and burr flap: on top and/or underneath the front or/and behind the closed or open container.

4c) Flexible container, half English fold type (in which there is no defined flat English fold flag) and the other half, pad type. The closed or open container or pre-container (at least one of the sides to be filled with the product to be packaged later), characterized because it has two plus flaps, one English fold plus flap on the left and on the right from the bottom or top of the pre-container or container, as well as at least part of one side in at least one direction of at least one sealing line on each English fold plus flap; and
on the left and right side at the top (or bottom): a triangular body flap folded over itself at least once over at least part of another part of it, and
at least part of at least one side in at least one direction and on a plane or on an inclined plane of at least one sealing line: on at least part of at least one side of each of the triangular body flaps folded or bent over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a rectangular or parallelepiped prism geometric body shape, where also the top or/and bottom or/and left or/and right part can be broader, wider or square: depending on the width and length of the flaps generated in the container.

Optionally, it can also contain at least one English fold burr plus flap or/and burr flap: on top and/or underneath the front or/and behind the closed or open container.

4d) Flexible container, half English fold type (in which there is no defined flat English fold flap) and the other half, pad type. The closed or open container or pre-container (at least one of the sides to be filled with the product to be packaged later), characterized because it has one English fold plus flap on the left and on the right from the top or bottom of the lateral side of the pre-container or container, as well as at least part of at least one side in at least one direction of at least one sealing line in the English fold plus flap.

The container has a cubic, rectangular or parallelepiped prism geometric body shape, but is wider and more volumetric in 3D in the area or area contiguous to the generated flap, where in addition the top or/and bottom or/and left or/and right part can be broader, wider or square: depending on the width and length of the flap generated on the lateral side of the container.

Optionally, it can also contain at least one English fold burr plus flap or/and burr flap: on top and/or underneath the front or/and behind the closed or open container.

4e) Flexible container, half English fold type (in which there is no defined flat English fold flap) and the other half, pad type. The closed or open container or pre-container (at least one of the sides to be filled with the product to be packaged later), characterized because it has one English fold plus flap on the left and on the right from the top or bottom of the lateral side of the pre-container or container, as well as at least part of at least one side in at least one direction of at least one sealing line in the English fold plus flap; and
one triangular body flap folded over itself at least once on at least another part of it, on the opposite lateral side [to the left or right side of the bottom (or top) part of the pre-container or container]: on the lateral side from where the English fold plus flap of the pre-container or container is generated, and
at least part of at least one side in at least one direction and on a plane or on an inclined plane of at least one sealing line: on at least part of at least one side of the triangular body flaps folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a parallelepiped geometric shape where the two top sides are parallel and the two lateral sides are parallel but in diagonal, and the volumetry of the container is reversed from the middle up in comparison to the middle down: in one it widens to the left and down and in the other it widens to the right and up, in which the wider or the longer the flaps generated are on the lateral sides, the more it widens.

Optionally, it can also contain at least one English fold burr plus flap or/and burr flap: on top and/or underneath the front or/and behind the closed or open container.

5a) Flexible container, half English fold type (in which at least one flat English fold flap is defined) and the other half, pad type. The closed or open container or pre-container (at least one of the sides to be filled with the product to be packaged later), characterized because it has two flaps [one or two flat stable bottom plus flap/s, or one flat stable bottom plus flap and one stable bottom plus flap] on the left and on the right of the bottom (or top) part of the container, as well as at least part of at least one side in at least one direction of at least one sealing line in every flat stable bottom plus flap or stable bottom plus flap.

The container has a rectangular or parallelepiped prism geometric body shape where also the top or/and bottom or/and left or/and right part can be broader, wider or square: depending on the width and length of the flaps generated in the container.

Optionally, it can also contain [(at least one stable bottom burr plus flap or/and at least one stable bottom burr plus flap) or at least one burr flap]: on top and/or underneath the front or/and behind the closed or open container.

5b) Flexible container, half English fold type (in which at least one flat English fold flap is defined) and the other half, pad type. The closed or open container or pre-container (at least one of the sides to be filled with the product to be packaged later), characterized because it has two flaps [one or two flat stable bottom plus flap/s, or one flat stable bottom plus flap and one stable bottom plus flap] on the left and on the right of the bottom (or top) part of the container, as well as at least part of at least one side in at least one direction of at least one sealing line in every flat stable bottom plus flap or stable bottom plus flap; and
a triangular body flap folded back on itself at least once over at least part of another part of it, to the left or right of the top (or bottom) part of the container, and
at least part of at least one side in at least one direction and on a plane or on an inclined plane of at least one sealing line: on at least part of at least one side of the triangular body flaps folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a rectangular trapezoid geometric shape with a cone-shaped dispensing neck at the top where, also the top or/and bottom or/and left or/and right part can be broader, wider or square: depending on the width and length of the flaps generated on the lateral sides of the container.

Optionally, it can contain (at least one stable bottom burr plus flap or/and at least one English fold burr plus flap) or English fold burr plus flap) or/and at least one burr flap: on top and/or underneath the front or/and behind the closed or open container.

5c) Flexible container, half English fold type (in which at least one flat English fold flap is defined) and the other half, pad type. The closed or open container or pre-container (at least one of the sides to be filled with the product to be packaged later), characterized because it has two flaps [one or two flat stable bottom plus flap/s, or one flat stable bottom plus flap and one stable bottom plus flap] on the left and on the right of the bottom (or top) part of the container, as well as at least part of at least one side in at least one direction of at least one sealing line in every flat stable bottom plus flap or stable bottom plus flap; and
on the left and right side at the top (or bottom) of the container: a triangular shaped flap folded over itself at least once on another part of the container, and
at least part of at least one side in at least one direction and on a plane or on an inclined plane of at least one sealing line: on at least part of at least one side of the triangular body flaps folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a cubic, rectangular or parallelepiped prism geometric body shape where also the top or/and bottom or/and left or/and right part can be broader, wider or square: depending on the width and length of the flaps generated in the container.

Optionally, it can contain (at least one stable bottom burr plus flap or/and at least one English fold burr plus flap) or English fold burr plus flap) or/and at least one burr flap: on top and/or underneath the front or/and behind the closed or open container.

5d) Flexible container, half English fold type (in which at least one flat English fold flap is defined) and the other half, pad type. The closed or open container or pre-container (at least one of the sides to be filled with the product to be packaged later), characterized because it has [one flat English fold plus flap or one English fold plus flap] on the left and on the right of the bottom (or top) part of the lateral side of the container, as well as at least part of at least one side in at least one direction of at least one sealing line in the flat English fold plus flap or English fold plus flap.

The container has a narrow volumetric rectangular prism or parallelepiped geometric body shape, but being wider and volumetric in 3D in the area or area contiguous to the generated flap where, in addition, the top or/and bottom or/and left or/and right can be broader, wider or square: depending on the width and length of the flaps generated on the side of the container.

Optionally, it can also contain (at least one stable bottom burr plus flap or/and at least one English fold burr plus flap) or/and at least one burr flap: on top and/or underneath the front or/and behind the closed or open container.

5e) Flexible container, half English fold type (in which at least one flat English fold flap is defined) and the other half, pad type. The container or pre-container can be closed or open (at least one of the sides to be filled with the product to be packaged later), characterized because it has [one flat English fold plus flap or one English fold plus flap] on the left and on the right of the bottom (or top) part of the lateral side of the container, as well as at least part of at least one side in at least one direction of at least one sealing line in the flat English fold plus flap or English fold plus flap; and
a triangular body flap folded back on itself at least once over at least part of another part of it, on the opposite side [to the left or right of the top (or bottom) part of the container]: on the lateral side where the flat English fold plus flap or English fold plus flap is generated from the bottom (or top) of the container, and
at least part of at least one side in at least one direction and on a plane or on an inclined plane of at least one sealing line: on at least part of at least one side of the triangular body flaps folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a parallelepiped geometric shape where the two top sides are parallel and the two lateral sides are parallel but in diagonal, and the volumetry of the container is reversed from the middle up in comparison to the middle down: in one it widens to the left and down and in the other it widens to the right and up, in which the wider or the longer the flaps generated are on the lateral sides, the more it widens.

Optionally, it can also contain (at least one stable bottom burr plus flap or/and at least one English fold burr plus flap) or/and at least one burr flap: on top and/or underneath the front or/and behind the closed or open container.

6a) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) [minus one fold and at least one edge sealing line in the perimeter area of the lateral side of the container] on both sides or lateral sides of the container, characterized because it has two flaps [two flat stable bottom plus flaps, or one flat stable bottom plus flap and one stable bottom plus flap] to the left or right of the bottom (or top) part of the container, as well as at least part of at least one side in at least one direction of at least one sealing line in each flat stable bottom plus flap or stable bottom plus flap.

The container has a rectangular or parallelepiped prism geometric body shape, where also the top or/and bottom or/and left or/and right part can be broader, wider or square: depending on the width and length of the flaps generated.

Optionally, it can also contain [(at least one stable bottom burr plus flap or/and at least one flat stable bottom burr plus flap) or/and at least one burr flap]: on top and/or underneath the front or/and behind the closed or open container.

6b) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on both sides or lateral sides of the container, characterized because it has two flaps [two flat stable bottom plus flaps, or one flat stable bottom plus flap and one stable bottom plus flap] to the left or right of the bottom (or top) part of the container, as well as at least part of at least one side in at least one direction of at least one sealing line in each flat stable bottom plus flap or stable bottom plus flap; and
a triangular body flap folded over itself at least once in at least one direction over at least another part of it, to the left or right of the top (or bottom) of the pre-container or container, and
at least part of at least one side in at least one direction and on a plane or on an inclined plane of at least one sealing line: on at least part of at least one side of the triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a rectangular trapezoid geometric shape with a cone-shaped dosing neck at the top where, in addition, the top or/and bottom or/and left or/and right part can be broader, wider or square: depending on the width and length of the flaps generated on the lateral sides of the container.

Optionally, it can also contain [(at least one stable bottom burr plus flap or/and at least one flat stable bottom burr plus flap) or/and at least one burr flap: on top and/or underneath the front or/and behind the closed or open container.

6c) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on both sides or lateral sides of the container, characterized because it has two flaps [two flat stable bottom plus flaps, or one flat stable bottom plus flap and one stable bottom plus flap] to the left or right of the bottom (or top) part of the container, as well as at least part of at least one side in at least one direction of at least one sealing line in each flat stable bottom plus flap or stable bottom plus flap; and

to the left and also to the right of the top (or bottom) part of the container:
a triangular body flap folded over itself at least once over at least part of another part of it, and
at least part of at least one side in at least one direction and on a plane or on an inclined plane of at least one sealing line: on at least part of at least one side of each triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a cubic, rectangular or parallelepiped prism geometric body shape where, in addition, the top or/and bottom or/and left or/and right part can be broader, wider or square: depending on the width and length of the flaps generated on the lateral sides of the container.

Optionally, it can also contain [(at least one stable bottom burr plus flap or/and at least one flat stable bottom burr plus flap) or/and at least one burr flap]: on top and/or underneath the front or/and behind the closed or open container.

6d) Flexible container, half of which is of the stable bottom type or English fold type (in which at least one flat English fold triangular configuration flap is defined) and the other half is of the pad type. The container or pre-container can be closed or open (at least one of the sides so that, later, once the container is manufactured, it can be filled with the product to be packaged), and there is also a definition in at least one lateral side vertical edge flap (24) on both lateral sides of the container, characterized because it has [one flat stable bottom plus flap or one stable bottom plus flap] to the left or right of the bottom (or top) part of the container, and also
at least part of at least one side in at least one direction and on a plane or in an inclined plane of at least one sealing line on each flat stable bottom plus flap or stable bottom plus flap.

The container has a rectangular or parallelepiped prism geometric body shape but being wider and volumetric in 3D in the area or area contiguous to the generated flap, where in addition the top or/and bottom or/and left or/and right can be broader, wider or square: depending on the width and length of the flaps generated.

Optionally, it can also contain [(at least one flat stable bottom burr plus flap or/and at least one stable bottom burr plus flap) or/and at least one burr flap]: on top and/or underneath the front or/and behind the closed or open container.

6e) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on both lateral sides of the container, characterized because it has [one flat stable bottom plus flap or one stable bottom plus flap] to the left or right of the bottom (or top) part of the container, and
at least part of at least one side in at least one direction and on a plane or in an inclined plane of at least one sealing line on each flat stable bottom plus flap or stable bottom plus flap; and
one triangular body flap folded over itself at least once on at least part of another part of it: on the opposite side {(left or right) of the top (or bottom) part of the container} from where (left or right) the flat stable bottom plus flap or stable bottom plus flap on the bottom (or top) part of the container is generated, and
at least part of at least one side in at least one direction and on a plane or in an inclined plane of at least one sealing line: on at least part of at least one side of the triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a parallelepiped geometric shape where the two top sides are parallel and the two lateral sides are parallel but in diagonal, and the volumetry of the container is reversed from the middle up in comparison to the middle down: in one it widens to the left and down and in the other it widens to the right and up, in which the wider or the longer the flaps generated are on the lateral sides, the more it widens.

Optionally, it can also contain [(at least one stable bottom burr plus flap or/and at least one flat stable bottom burr plus flap) or/and at least one burr flap]: on top and/or underneath the front or/and behind the closed or open container.

7a) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on at least one of the sides or lateral sides of the container, characterized because it has two flaps to the left and right of the bottom part of the container, and:
in the case of having defined only one flat English fold flap, [(one flat stable bottom plus flap and one English fold plus flap), or (one stable bottom plus flap and one flat English fold plus flap)] will be made to the left and right of the bottom (or top) part of the container or pre-container and,
at least part of at least one side in at least one direction and on a plane or in an inclined plane of at least one sealing line on each flat stable bottom plus flap, stable bottom plus flap, English fold plus flap, flat English fold plus flap; and
in the case of having defined two English fold triangular configuration folded flaps, [one flat English fold plus flap and one flat stable bottom plus flap] will be made to the left and right of the bottom (or top) part of the container or pre-container and,
at least part of at least one side in at least one direction and on a plane or in an inclined plane of at least one sealing line on each flat stable bottom plus flap and flat English fold plus flap.

The container has a rectangular or parallelepiped prism geometric body shape where, in addition the top or/and bottom or/and left or/and right part can be broader, wider or square: depending on the width and length of the flaps generated on the sides of the container.

Optionally, it can also contain the following burrs:
in the case of having defined only one English fold triangular configuration folded flap, it may contain none or randomly, combined and/or repetitively contain at least one or more of: the stable bottom burr plus flap, flat stable bottom burr plus flap, English fold burr plus flap, English fold burr plus flap, and at least one burr flap; and,
in the case of having defined two English fold triangular configuration folded flaps, it may contain [(at least one flat stable bottom burr plus flap) or/and (at least one English fold burr plus flap) or/and at least one burr flap]: on top and/or under the front or/and back part of the closed or open container.

7b) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on at least one of the sides or lateral sides of the container, characterized because it has two flaps to the left and right of the bottom part of the container or pre-container, and:
in the case of having defined only one flat English fold flap, [(one flat stable bottom plus flap and one English fold plus flap), or (one stable bottom plus flap and one flat English fold plus flap)] will be made to the left and right of the bottom (or top) part of the container or pre-container and,
at least part of at least one side in at least one direction and on a plane or in an inclined plane of at least one sealing line on each flat stable bottom plus flap, stable bottom plus flap, English fold plus flap, flat English fold plus flap; and
   in the case of having defined two English fold flaps in a horizontal plane, [one flat English fold plus flap and one flat stable bottom plus flap] will be made to the left and right of the bottom (or top) part of the container or pre-container and,
at least part of at least one side in at least one direction and on a plane or in an inclined plane of at least one sealing line on each flat stable bottom plus flap and flat English fold plus flap; y,
one triangular body flap folded over itself at least once on at least one other part of it, to the left or right of the top (or bottom) part of the container, and
at least part of at least one side in at least one direction and on a plane or in an inclined plane of at least one sealing line: on at least part of at least one side of the triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a rectangular trapezoid geometrical shape with a cone-shaped dispensing neck at the top, where in addition the top or/and bottom or/and left or/and right can be broader, wider or square: depending on the width and length of the flaps generated on the sides of the container.

Optionally, it can also contain the following burrs:
in the case of having defined only one English fold triangular configuration folded flap, it may contain none or randomly, combined and/or repetitively contain at least one or more of: the stable bottom burr plus flap, flat stable bottom burr plus flap, English fold burr plus flap, English fold burr plus flap, and burr flap; and,
in the case of having defined two English fold triangular configuration folded flaps, it may contain [(at least one flat stable bottom burr plus flap) or/and (at least one English fold burr plus flap) or/and at least one burr flap]: on top and/or under the front or/and back part of the closed or open container.

7c) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on at least one of the sides or lateral sides of the container, characterized because it has two flaps to the left and right of the bottom part of the container, and:
in the case of having defined only one flat English fold flap, [(one flat stable bottom plus flap and one English fold plus flap), or (one stable bottom plus flap and one flat English fold plus flap)] will be made to the left and right of the bottom (or top) part of the container or pre-container and,
at least part of at least one side in at least one direction and on a plane or in an inclined plane of at least one sealing line on each flat stable bottom plus flap, stable bottom plus flap, English fold plus flap, flat English fold plus flap; and
   in the case of having defined two English fold flaps in a horizontal plane, [one flat English fold plus flap and one flat stable bottom plus flap] will be made to the left and right of the bottom (or top) part of the container or pre-container and,
at least part of at least one side in at least one direction and on a plane or in an inclined plane of at least one sealing line on each flat stable bottom plus flap and flat English fold plus flap; and
on the left and also on the right of the top (or bottom) part of the container: a triangular shaped body flap folded or bent over itself at least once over at least part of another part of the container, and
at least part of at least one side in at least one direction and on a plane or in an inclined plane of at least one sealing line: on at least part of at least one side of each triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a cubic, rectangular or parallelepiped prism geometric body shape where, in addition the top or/and bottom or/and left or/and right part can be broader, wider or square: depending on the width and length of the flaps generated on the sides of the container.

Optionally, it can also contain the following burrs:
in the case of having defined only one English fold triangular configuration folded flap, it may contain none or randomly, combined and/or repetitively contain at least one or more of: the stable bottom burr plus flap, flat stable bottom burr plus flap, English fold burr plus flap, English fold burr plus flap, and burr flap; and,
in the case of having defined two English fold triangular configuration folded flaps, it may contain [(at least one flat stable bottom burr plus flap) or/and (at least one English fold burr plus flap) or/and at least one burr flap]: on top and/or under the front or/and back part of the closed or open container.

7d) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on at least one of the sides or lateral sides of the container, characterized because it has one flap to the left and right of the bottom part of the container, and:
in the case of having defined only one flat English fold flap, [(one flat stable bottom plus flap and one English fold plus flap), or (one stable bottom plus flap and one flat English fold plus flap)] will be made to the left and right of the bottom (or top) part of the container or pre-container and,
at least part of at least one side in at least one direction and on a plane or in an inclined plane of at least one sealing line on each flat stable bottom plus flap, stable bottom plus flap, English fold plus flap, flat English fold plus flap; and
   in the case of having defined two English fold flaps in a horizontal plane, [one flat English fold plus flap or one flat stable bottom plus flap] will be made to the left and right of the bottom (or top) part of the container or pre-container and,
at least part of at least one side in at least one direction and on a plane or in an inclined plane of at least one sealing line on each flat stable bottom plus flap and flat English fold plus flap.

The container has a rectangular or parallelepiped prism geometric body shape but is wider and more volumetric in 3D in the area or area contiguous to the generated flap, where in addition the top or/and bottom or/and left or/and right part can be broader, wider or square: depending on the width and length of the flap generated.

Optionally, it can also contain the following burrs:
in the case of having defined only one English fold triangular configuration folded flap, it may contain none or randomly, combined and/or repetitively contain at least one or more of: the stable bottom burr plus flap, flat stable bottom burr plus flap, English fold burr plus flap, English fold burr plus flap, and burr flap; and,
in the case of having defined two English fold triangular configuration folded flaps it may contain [(at least one flat stable bottom burr plus flap) or/and (at least one English fold burr plus flap) or/and at least one burr flap]: on top and/or under the front or/and back part of the closed or open container.

7e) Flexible container, half of which is of the stable bottom type or English fold type {in which at least one flat English fold flap is defined} and the other half is of the pad type. The container or pre-container can be closed or open (at least one of the sides so that, later, once the container is manufactured, it can be filled with the product to be packaged), and there is also a definition in at least one lateral side vertical edge flap (24) on at least one of the sides or lateral sides of the container, characterized because it has one flap to the left and right of the bottom part of the container, and:
in the case of having defined only one flat English fold flap, [(one flat stable bottom plus flap and one English fold plus flap), or (one stable bottom plus flap and one flat English fold plus flap)] will be made to the left and right of the bottom (or top) part of the container or pre-container and,
at least part of at least one side in at least one direction and on a plane or in an inclined plane of at least one sealing line on each flat stable bottom plus flap, stable bottom plus flap, English fold plus flap, flat English fold plus flap; and
   in the case of having defined two English fold flaps in a horizontal plane, [one flat English fold plus flap or one flat stable bottom plus flap] will be made to the left and right of the bottom (or top) part of the container or pre-container and,
at least part of at least one side in at least one direction and on a plane or in an inclined plane of at least one sealing line on each flat stable bottom plus flap and flat English fold plus flap; and
one triangular body flap folded over itself at least once on at least another part of it, on the opposite lateral side {(to the left or right) of the top (or bottom) part of the container} from where the flat stable bottom plus flap or stable bottom plus flap is generated (left or right) at the bottom (or top) of the container, and
at least part of at least one side in at least one direction and on a plane or in an inclined plane of at least one sealing line: on at least part of at least one side of a triangular body flap folded over itself.

[At least one triangular body flap of this flexible container, as another option other than folding or bending at least once over itself, can also be manipulated to choose, for example, in a random and combined and/or repetitive manner from among at least one or more of any of the options described above at the end of paragraph 4b)]

The container has a parallelepiped geometrical shape where the two top sides are parallel and the two lateral sides are parallel but in diagonal, and the volumetry of the container is reversed from the middle up in comparison to the middle down: in one it widens to the left and down and in the other it widens to the right and up, in which the wider or the longer the flaps generated are on the lateral sides, the more it widens.

Optionally, it can also contain the following burrs:
in the case of having defined only one English fold triangular configuration folded flap, it may contain none or randomly, combined and/or repetitively contain at least one or more of: the stable bottom burr plus flap, flat stable bottom burr plus flap, English fold burr plus flap, English fold burr plus flap, and burr flap; and,
in the case of having defined two English fold triangular configuration folded flaps it may contain [(at least one flat stable bottom burr plus flap) or/and (at least one English fold burr plus flap) or/and at least one burr flap]: on top and/or under the front or/and back part of the closed or open container.

### Advantages of the Invention

The integration and adaptability of the 3D plus system device to the vertical (or, for example, also horizontal) packaging machines is easy and straightforward.
The application of the 3D plus transformation system directly on the vertical packaging machines for flexible containers means an enormous saving in costs and production time since it will be possible to manufacture by means of devices installed on the vertical packaging machine. All of the most significant 3D compack type containers can be obtained, e.g.: containers that are transformed by generating one, two, three or four flaps and, optionally, at least one burr flap or English fold burr flap on (the front and/or the back) and/or (the top and/or the bottom).
It implements features to improve vertical (or, for example, horizontal) packaging machines, by enabling them to manufacture containers with greater stability, consistency, rigidity and with a more square configuration, as well as making it possible to manufacture other different models of containers as, for example, the cube or parallelepiped, or the English type or stable bottom containers which have been transformed into a cube, rectangular prism, cylinder or parallelepiped shape; or those transformed from a pad type container or pre-container: into a cube, rectangular prism, cylinder or parallelepiped, or, in the same way the same transformation effect, into the containers which are English type from the middle down and pad type from the middle up.
To give the English fold type containers or those with a stable bottom, greater stability, consistency and rigidity, making them more practical and functional, for example, by widening and making the support side square or squarer or by dosing them better as they are more volumetric. It is very optimal for containers containing liquid.
Because the 3D compack conversion process already produces the flattening effect on the top and bottom sides and because it also causes the containers to take on a cubic shape, further handling steps (e.g. on a linear or circular carousel) of the English fold or stable-bottom containers are avoided, once they have been manufactured and moved out of the vertical (or, for example, horizontal) packaging machines as is the case, for example, when the plastic legume containers or packages have the top and bottom side ironed to flatten and smooth them or they are folded and glued with contact glue, or as in the case of containers with a stable bottom with four seals (two on each lateral side) in which one third of the top part of the container: is folded once downwards and adhered with contact glue to the rest of the container, or because the bottom seal line (generated by the vertical or horizontal packaging machine) located halfway (or approximately) and across (facing the container from the front): it hinders the stability of the container as it is pulled out and this part is hardened by the heat of the container's sealing seam.
It allows a saving in the film on a roll type wrapper, by being able to use films of a lower thickness or fewer layers, especially, in the English type or stable bottom containers because these are more stable, consistent and rigid due to the effect of the 3D plus transformation.
The English fold flap and sealing line is currently the system that gives the greatest stability, consistency and rigidity to the English fold or stable bottom container transformed into a 3D compack, especially in the area of the base of the container. Likewise, the flap generated is very compact, resistant and does not protrude outwards, being therefore less deformable in comparison with the triangular shaped flap, also generated by the 3D compack system procedure; however, this flap does not allow the opening by it, not as it does happen with the triangular shaped flap that can be torn off and the container opened.
The containers of the invention are very attractive visually and have beautiful and refined flaps and sealing lines in the finish, apart from being practical and functional, which make the containers a very competitive and ideal marketing product.

### EXPOSITION OF A WAY TO CARRY OUT THE INVENTION

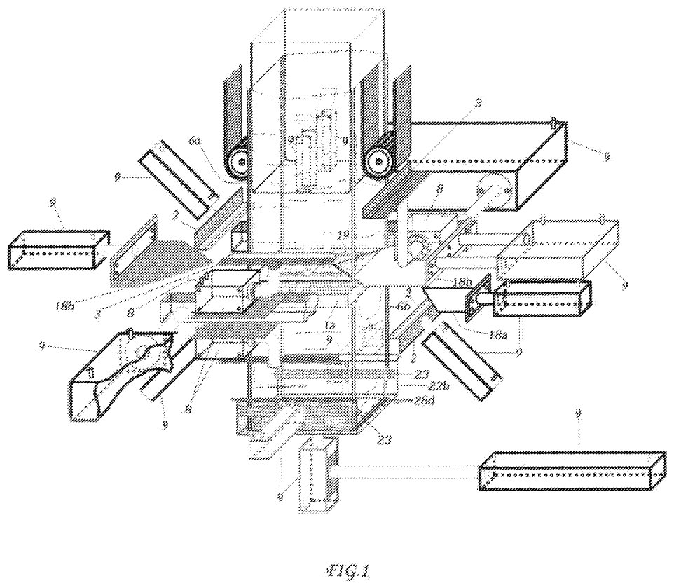

FIG. 1: shows a detailed view of the elevation of part of the elements or components of a vertical packaging machine of stable bottom (23) flexible containers, where the moment when the English fold flap (10) is generated can be seen as a triangular shaped impact body (17) is inserted into the side of the previous pre-container (6a), in this case with a stable four times sealed bottom (23). The sealing and cutting jaws (1) are arranged under the previous pre-container (6a), [in this case, the two jaws of this sealing and/or cutting jaw set (1) are moved by a linear drive] of the packaging machine, which is clamping and blocking the pre-container (6a), so that this jaw (1) also intervenes and participates to generate the flat stable bottom flap (or English fold) (12) and a flat support side (or base side) at the very bottom.

A fixed rotary actuator (8) can also be seen just on top the triangular configuration body (17), which in turn is fixed to its axis:
a rectangular shaped plus impact body (2) and, at the end of the same are two fixed resistors (4) as a heat source (4) to seal with two straight sealing lines in the intersection area of the flap that is generated and the rest of the pre-container's body; and,

in front of the pre-container and fixed on top of the sealing and cutting jaws (1), is another burr plus impact body (3) the same as the previous one but longer, thus arranged to generate and seal a stable bottom burr plus flap (16b) in the lower part of the front side of the previous pre-container (6a).
In this case, as it is a pre-container in which an English fold flap is generated (10a), the plus impact (2) and sealing bodies (4) and also the burr plus impact body (3) will be activated once the English fold flap has been generated (10).

Underneath the sealing and cutting jaws (1), there are two linear plus impact bodies (2) on the left and right and two (one is not visible) burr plus impact bodies (3) attached to a turning cylinder.

The English fold (10) generated in the upper part (on the left and right) of the previous pre-container (6b), by means of two rectangular bodies (18) that are inserted into the sides or lateral sides of the upper part of the container (7) or previous pre-container (6b), right at the same time as the sealing and cutting jaws are closed (1) can also be seen.

At the bottom of this container or pre-container (6b), it can be seen that two English fold flaps (10a) have been previously generated at the bottom.

If we wanted to obtain a stable bottom container with four seals, this would then be finished and only the sealing and cutting step would remain over the top of the container would remain, which would be carried out by the sealing and cutting jaws (1) that can be seen from the vertical packaging machine. But, as in this case, the container will be transformed into a cube:
an English fold plus flap (13) will also be generated to the left and right of the top part of the pre-container (6b) or container (7), which is now arranged or positioned under the sealing and cutting jaws (1). The English fold plus flap (13) is generated by means of an impact body (2) attached to a linear cylinder (9) which will be fixed, in this case, to a support; so that when it is activated: it will hit the sheet or film in an inward and upward direction until it hits or it can go no further with the sealing and cutting jaws (1) from below: obtaining a widening of the wrapper, film or sheet in the upper part of the container (7) or pre-container (6b), making the container inflate at this part and acquire a cubic geometric body shape and, at the same time,
the English fold plus flap (13) will be sealed, in this case, on the underside, by means of a rectilinear resistor fixed to the end of the impact body (2).

In addition, in the upper central part of the machine there is a quadrangular forming tube (5) and two ramming impact bodies fixed to the inside of the forming tube (5), in which the rammer (19) is fixed to the rod of a linear actuator and is operated and moved to the most open position, so the impact body rammer (19) so the impact body rammer (19) is ramming and blocking the support side of the pre-container (6a) which is gripped and held at the bottom by the sealing and cutting jaws (1).

On the other hand, just underneath the pre-container (6) or container (7), there is a tray or platform where the pre-container is supported, arranged in this way so that it does not hang down and facilitates the generation of, on the one hand, the English fold flap (10) and, on the other hand, the English fold plus flap (13).

This tray can also be moved upwards as it is fixed to a linear cylinder, to make it even easier to generate the English fold plus flap (13).

In turn, on two of the parallel lateral sides of the tray there is a linear cylinder which will have the double function of, on the one hand, holding the container at a concentric point and, on the other hand, exerting pressure towards the inside of the container to facilitate the formation, without any folds, of the plus flaps which will be generated in the top part of the container (6b).

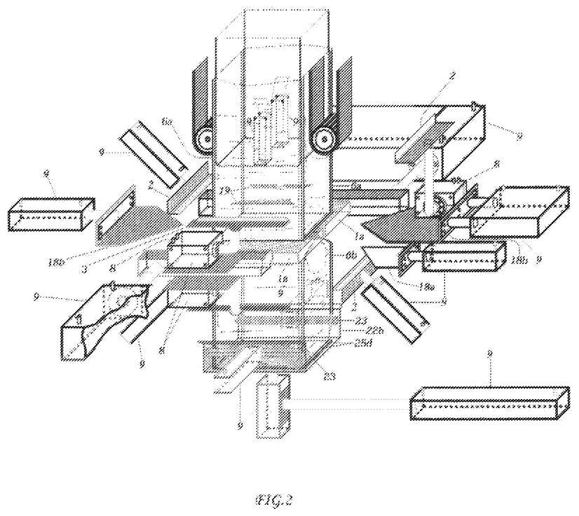

FIG. 2: shows the same drawing as in FIG. 1 at the precise moment when a container (6a) with a stable bottom has been formed once the triangular shaped body (17) has emerged from the inside of the lowest part of the container (6a) that is located in the top part of the sealing and cutting jaws (1).

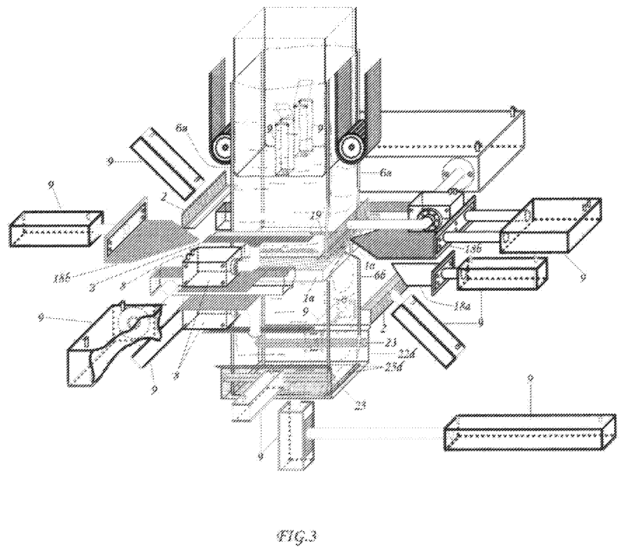

FIG. 3: shows the same drawing as in FIG. 1 at the precise moment when the plus impact body (2) has been activated and has generated a plus flap, which is sealed by two sealing lines at the moment of being generated.

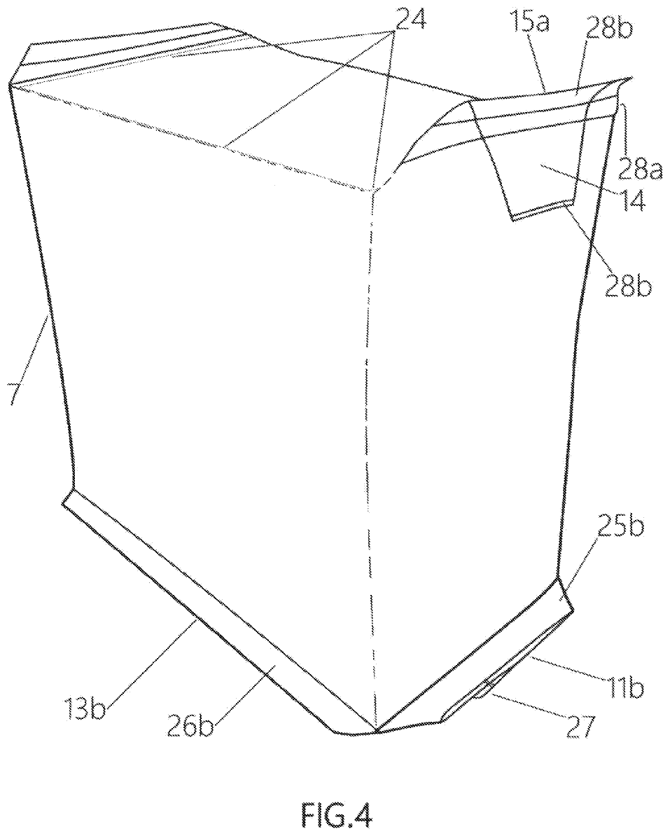

FIG. 4: shows a detailed view of the elevation of a cubic container (pad type from the middle up and English fold type from the middle down), which
at the bottom on all sides or faces, has been generated and sealed:
   two flat English fold plus flaps (11b) on the sides (one on the left and one on the right) and two flat English fold burr plus flaps (13b) (or flaps or burr flaps) on the front and back edge of the pre-container (6) or container (7) and,
on the uppermost side (or on the uppermost lateral sides) on the left and right, are seen or are generated and sealed:
   two triangular body flaps which have subsequently been sealed with a transverse flap sealing line (18a) in the intersection area of the triangular body flap and the rest of the body of the pad type container, as well as folded over itself (15b) in at least one direction {or at least part of the triangular body flap has been folded or bent over at least another part of it}; so that a fold (or flap) is generated which has also been sealed with at least one straight transverse sealing line (28b) in the entire transverse area of the intersection of the fold and the rest of the triangular body flap (14), which has also been folded inwards and sealed with a transverse flap sealing line (28b), and
on the upper side, the following has been carried out perimeterally on three of its sides:
   a continuous pre-cut sealing line (24) of 7 microns on the outer layer of the wrapper (or sheet or film on a roll), by means of a laser system or device, so that when it is pulled from the side, a lid or opening will be generated through which the packaged product inside the container can be served or accessed (7).

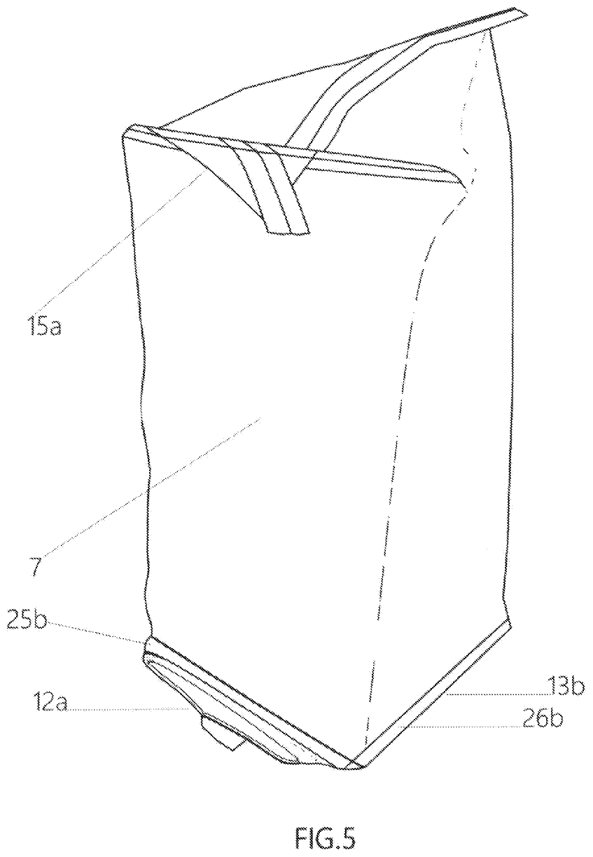

FIG. 5: shows a detailed view of the elevation of a stable bottom container, which has been transformed, by means of a 3D plus device, into a parallelepiped container with a dosing neck on one side of the uppermost half of the rectangular trapezoid container and the lower part of the container (7) has been generated and sealed:
two flat stable bottom plus flaps (12) [one on the left side or lateral side, and one on the right side or lateral side], and
two burr plus flaps (16a) [or edge flaps or burr flaps] on the front and back edge of the container and,
on the uppermost side (or in the upper part of the sides or lateral sides) and on the edge of one of the sides, by means of a 3D or/and 3D plus compack device located under the sealing and cutting jaws (1) of the vertical 3D plus machine, the following has been generated and sealed:
   a triangular body flap (or a triangular body) which has subsequently been sealed with a sealing line in the intersection area of the triangular body and the rest of the container's body (7) and then folded on itself in at least one direction at least part of the triangular body (15) over at least another it; so that a fold (or flap) is generated, which has been sealed with at least one straight sealing line across the width of the intersection area of the fold and the rest of the flap: obtaining
   a dosing neck in the form of an inclined cone, located on the upper side on the opposite side and in the opposite direction from the triangular body flap folded over itself, this neck has an inclination of 30° to 45° (approximately), rising from the edge or the upper part of the lateral side where the triangular body flap has been generated: to the apex or peak of the conical dosing neck on the opposite side of the top side of the container (7).

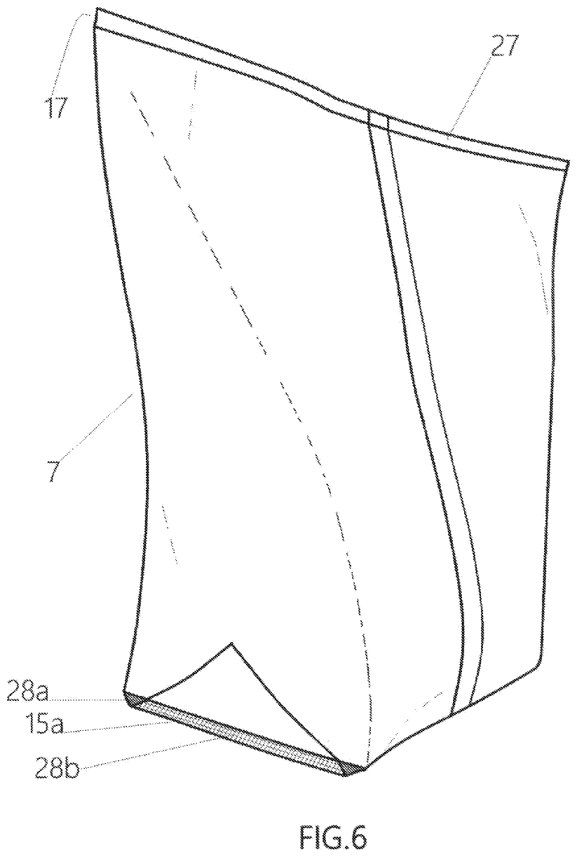

FIG. 6: shows a detailed view of the elevation of a 3D flexible container in the form of an inverted trapezoid but with a flat, square base or supporting side, as well as the container gradually narrowing as it is lifted up and until, at the sealing line seam (27) at the top of the container is transversely flat.

Also, the 3D plus vertical packaging machine, on the lowest lateral side or lateral face of a pad type pre-container (6) or container (7) has generated and folded:
a triangular body flap folded over itself (15a), and in the area of the fold generated in the flap, it has been subsequently sealed with a transverse flap sealing line (28b).

Also, before the triangular body flap is folded, it has been transversely sealed on the upper side with a flap transverse sealing line (28a) in the intersection area of the fold of the triangular body flap (14) with the body of the container.

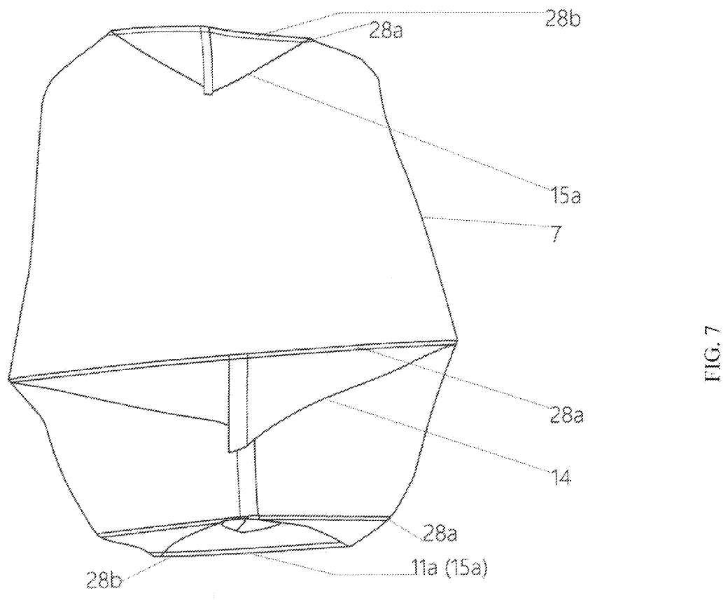

FIG. 7: shows a detailed view of the elevation of a flexible 3D parallelepiped container arranged in a lying and upright position, in which four flaps have also been generated:
on the lower left and right side, an English type flap (11a) which, first, has been sealed on the upper side by a transverse sealing line (28a) in the intersection area of the English type flap and the rest of the folded container; second, it has been folded over itself (15a) and, third, the generated fold has been sealed on the top side by a transverse sealing line (28b) in the intersection area of the fold and the rest of the folded English fold flap.
at the top, on the extreme left, a triangular body flap (14) which has been folded—in this case—once onto itself (15a), as well as sealed on the top side by a transverse flap sealing line (28a) at the edge and contiguous area to this which has been generated in the folding of the triangular body flap (14).
at the top, on the extreme right, the triangular body flap (14) has not been folded onto itself but has only been sealed on the top side by a transverse flap sealing line (28a) in the intersection area of the triangular body flap (14) and the rest of the container (7) or pre-container (6a; 6b).

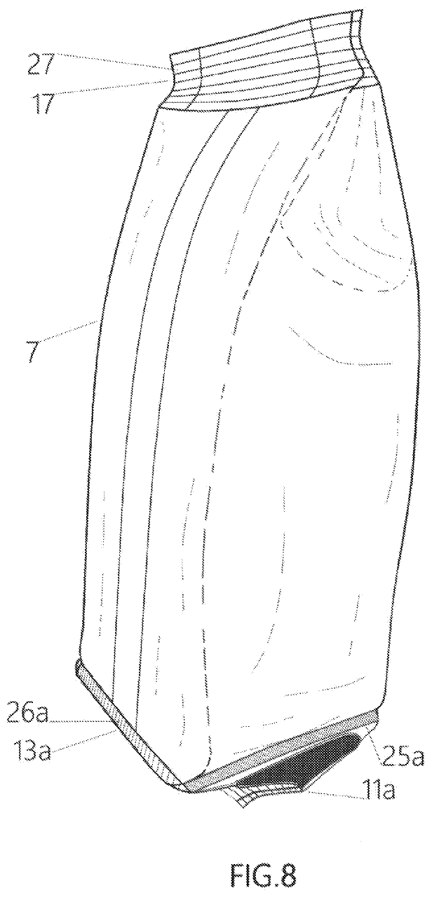

FIG. 8: shows a detailed view of the elevation of a flexible English fold type container (vertical) for which two English fold plus flaps (13) have been generated on the left and right side of the lowest part of the container.

The container (7), from the middle up, is triangular in shape when viewed from the side, and from the extreme left and right from the top of the sides or lateral sides close to the apex, one can see how the two parallel folded triangular flaps, characteristic of the English fold, and which in this case is curvilinear/inclined/vertical/diagonal: form an irregular hole or cavity (of a triangular or quasi-oval and curvilinear shape) in the lateral area of the top part of the container close to the apex, or the English fold transverse sealing line (27), as part of the side film from the top is folded and pushed inwards, and also part of this fold is permanently sealed by the English fold transverse sealing line (27).

On the other hand, the container is a rectangular prism from the middle down and the support side of the lower part that acts as a base is flat. This is because the following has been generated on the English fold flap on the lower left and right side or face:
an English fold plus flap (11a), which shows the corresponding sealing of, in this case, an English fold plus sealing line (25a).

Likewise, in the lower part of only the left side or face, an English fold burr plus flap (13a) has been generated transversely.

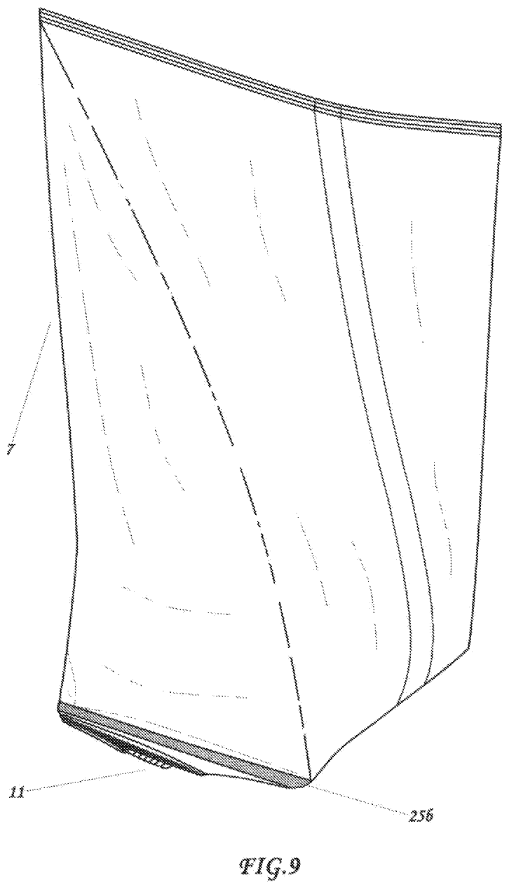

FIG. 9: shows a detailed view of the elevation of a flexible mixed type container, pad from the middle up, therefore, as can be seen in the image, there are no folds or bends in the film inwards, this makes this transverse sealing line at the top which closes the container, easy to open; and,

from the middle down, the container has a parallelepiped shape with a flat support side. This is due to two reasons:
that, previously, when the flat English fold (7) type of container was produced, it was placed at the bottom of the lateral sides of the container: it has already acquired a parallelepiped shape with a flat support side, and
that, subsequently, a flat English fold plus flap (11b) has been generated on the lower left and right lateral sides: with its corresponding, in this case, flat English fold sealing line (25b), in this case, on the top side of the flat English fold flap. This makes the container more stable, firm and consistent in its cubic or rectangular prismatic shape, and the support side sits better as it remains flatter.

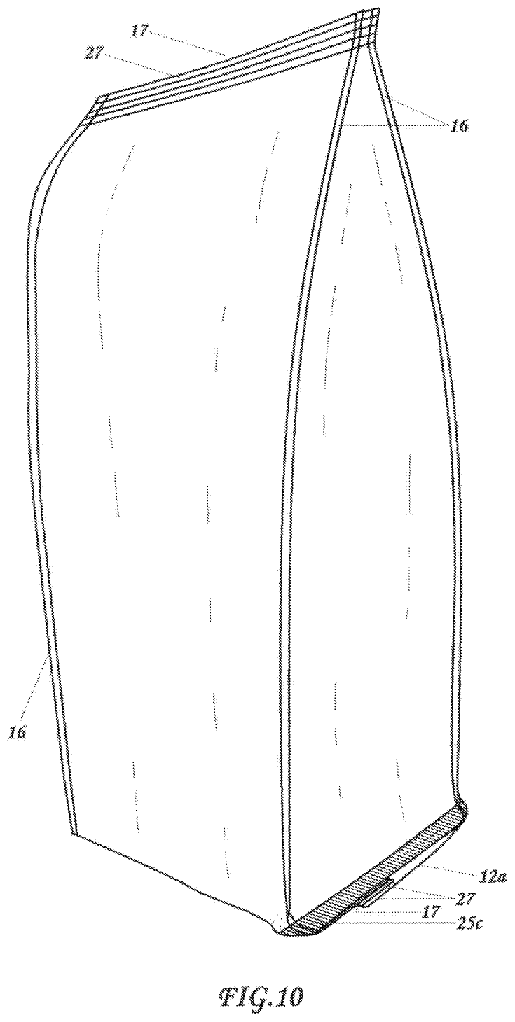

FIG. 10: shows a detailed view of the elevation of a flexible, stable bottom-type container with four seams, as can be seen in the picture, which are generated and arranged longitudinally and continuously on the four vertical edges of the four corners of the container.

On the lateral sides of the upper part of the container, one can see the characteristic inward gap previously created by making the English fold or English fold flap [also known as the vertical/diagonal/oblique/tilting English fold flap], as well as transversely on the top part of the container, the parallel transverse sealing lines (27) of the English fold transverse sealing flap (17) can be seen.

Also, on the lateral sides (left and right) of the underside of the container, there is a flat English fold flap—previously generated—:
a flat stable bottom plus flap (12a) that makes the container widen more than halfway down and that, in this case, has been sealed with a single flat stable bottom plus sealing line (25c), and, in this case, this sealing line is straight and not, for example, curved or diagonal/oblique.

Thus, the container is optimized by being more stable and consistent.

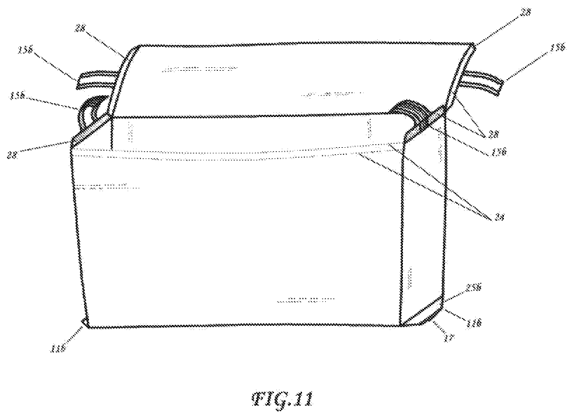

FIG. 11: shows a detailed view of the elevation of a a flexible mixed type container, which from the transverse middle upwards is pad type and from the transverse middle downwards is flat English fold type.

The container (7) has a horizontal rectangular prism shape and the following flaps or sealing lines have been generated:
on the left and right of the bottom part of the lateral sides, there are two flat English fold plus flaps (11b) by means of a transverse sealing line (25b) on the underside, as well as part of the folded or bent transverse sealing flap (17) underneath the base or support side.
at the top left and right of the lateral sides, there are two strip flaps (23), and one can see, in the intersection area between the strip flap (15b) and the rest of the container, as part of the sealing line of this flap, the transverse sealing line of the flap (28) which, in this case, has been made across the entire length.

On the other hand, in the upper transverse part of the front side, two pre-cutting lines (24) have been made by laser to generate—together with the sealing lines of the strip flap (15b)—an opening lid through which the packaged content inside the container (7) can be served.

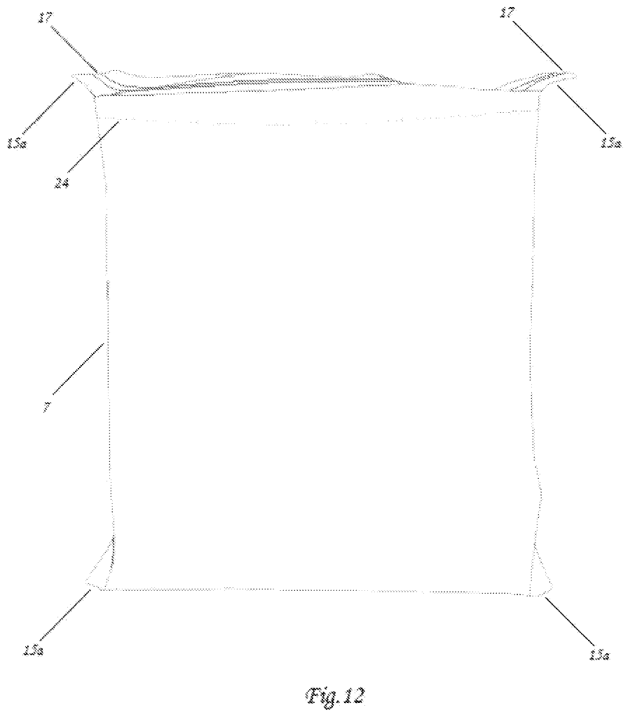

FIG. 12: shows a detailed view of the elevation of a flexible vertical pad type container which, in this case, is of a rectangular or parallelepiped prism shape, and the side that serves as a base (or support) is flat. The following flaps have been generated on the container:
at the bottom part of the lateral sides (left and right of the container) there is a triangular flap (14) folded over itself (15a) that, in this case, has been folded towards the flat side acting as a base or support. Also, the flap prior to being folded has not been sealed but, once folded over itself, has been sealed only by a transverse flap sealing line (28b) on the top side.
at the top part of the lateral sides (left and right of the container) there is a triangular flap (14) folded over itself (15a) that, in this case, has been folded towards the lateral side. Also, the flap prior to being folded has not been sealed but, once folded over itself, has been sealed only by a transverse flap sealing line (28b) on the edge and contiguous area to it, and on the top side.

It can also be seen that when the flap is folded back on itself, the transversal closing flap (17) of the container has also been folded back in the same way.

On the other hand, just underneath the upper part of the front side there is a pre-cut line (24), which also continues the transverse totality of the two lateral sides contiguous to the front side.

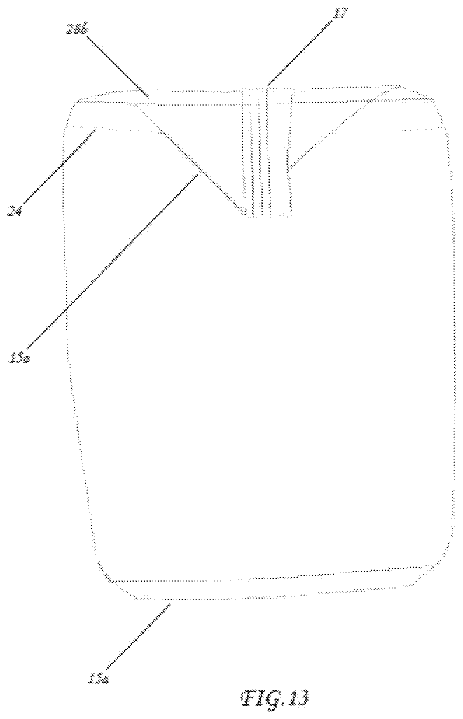

FIG. 13: shows a detailed view of the elevation of the same flexible container as in FIG. 12 but, in this case, it is a view of one of the two lateral sides of the container. It can be seen how in the upper part there is a triangular body flap folded over itself (15a) towards the lateral face, and the detail of the sealing of only one transverse flap sealing line (28b) in the edge and contiguous area to it, as well as on the upper side of the flap.

Also, one can see the pre-cut line (24) made just below the top part of this lateral side and which, in this case, coincides with the flap (15a) arranged above it.

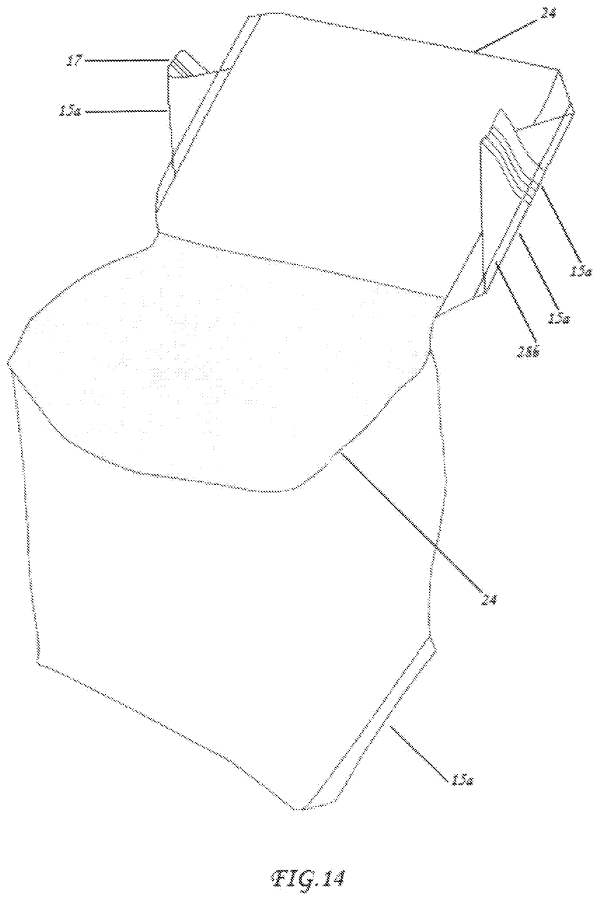

FIG. 14: shows an oblique zenithal view of the same flexible container as in FIGS. 12 and 13 but in this case an opening lid can be seen on top of the container because the only pre-cut line (24), which is continuously included in both the front side and the two contiguous sides:
has been torn along the entire pre-cut line (24) by pulling just over this line (24), and by starting to pull (up and back) on one of the two top corners of the container that make up the contiguous front, top and lateral sides.

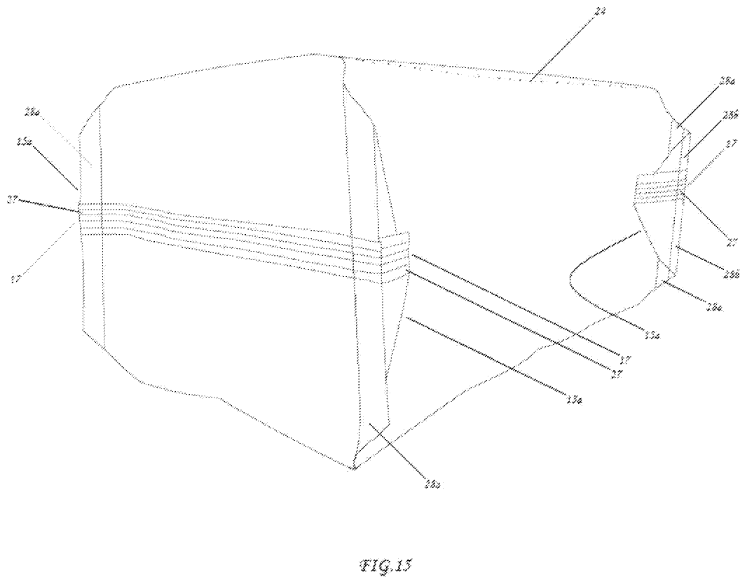

FIG. 15: shows a detailed view of the elevation of a lying horizontal flexible pad type container, of a rectangular or parallelepiped prism shape, where all its sides are flat and the lowest side acts as a base or a support side.

On the upper flat side there is a pre-cut line (24) arranged on the perimeter contour of three sides, the front side and two of the contiguous sides; this will generate an opening lid on the uppermost side.

Four identical triangular body flaps (14) have been generated in the container folded over themselves (15a) towards the contiguous lateral sides. These flaps have been sealed, first and before being folded: on the inner side and by a transverse sealing line (28a) in the intersection area between the flap and the rest of the container and, second and after being folded, it has been sealed on the inner side by a transverse flap sealing line (28b) on the edge and contiguous area to it.

It can also be seen that the transverse closing flap (17) is folded in the same way as the flap (14) folded over itself (15a).

Also, in the upper part of the transverse area of the front side, there is part of a pre-cut line (24), that continually proceeds in the in the perimeter contour of the entire two lateral sides of the flat face on top.

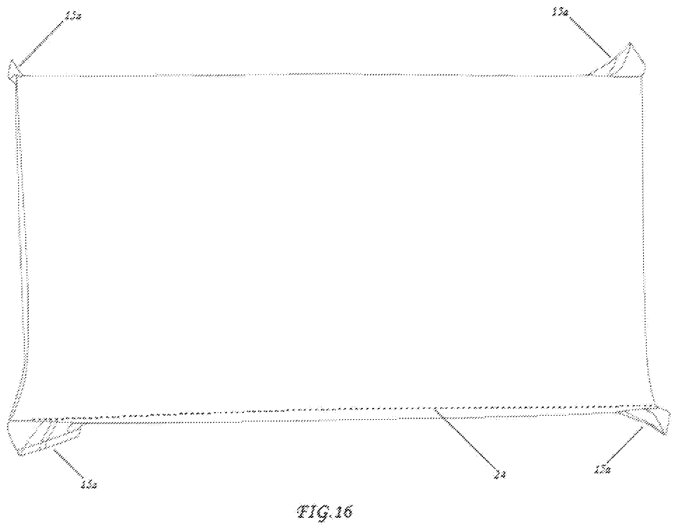

FIG. 16: shows a detailed view of the elevation of the same container as in FIG. 15 but, in this case, is a zenithal view of the upper side, where one can see in the upper part or in the upper side that there are three pre-cut lines (24) joined as one in the outer perimeter of three of the contiguous sides. This pre-cut line (24) will generate a container opening lid.

Also, we can see part of the two triangular body flaps folded onto themselves (15a) towards the lateral side on the left and right sides, and, also, we can see, on the upper side, the transverse flap sealing line (28b) on the edge and the area contiguous to it.

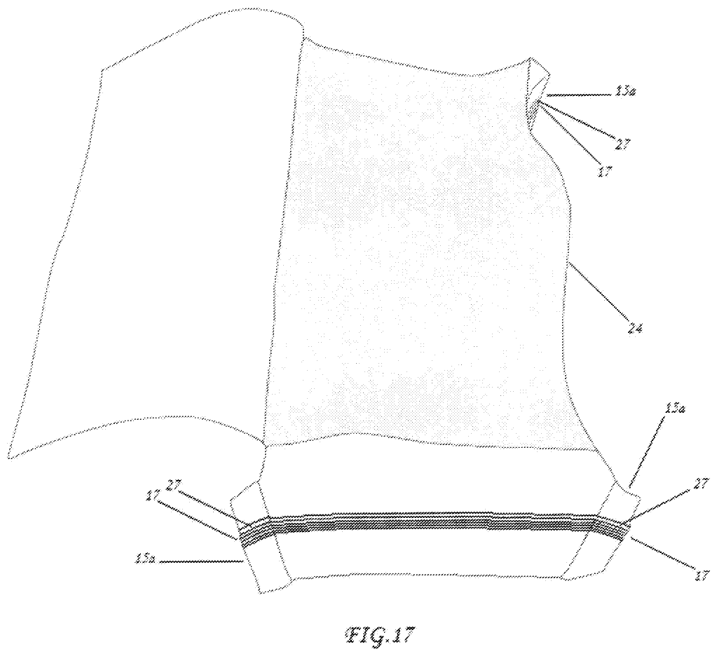

FIG. 17: shows a detailed view of the elevation of the same container than that of FIGS. and 16 but, in this case, it is an oblique zenithal view where it can be seen that an opening lid has been created on the top or on the upper side of the container to make use of the content packed inside it, because the only pre-cut line (24) runs continuously both on the front side and on the two sides contiguous to it:
this has been torn along the entire pre-cut line (24) by pulling just over this line (24), and by starting to pull (up and back) on one of the two top corners of the container that make up the contiguous front, top and lateral sides.

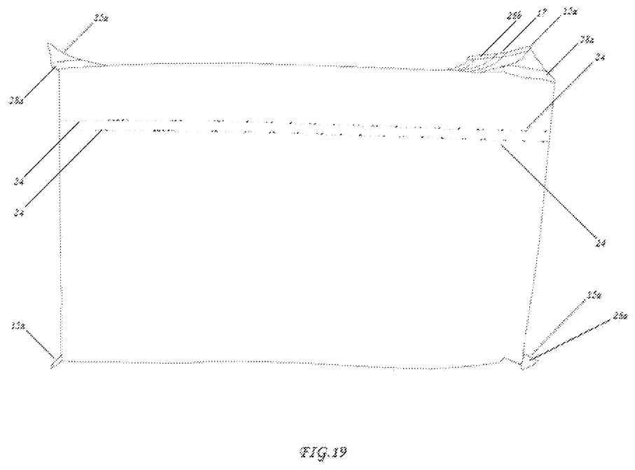

FIG. 18: shows a detailed view of the elevation of a lying horizontal flexible pad type container of a rectangular or parallelepiped prism shape, where all its sides are flat and the lowest side acts as a base or a support side.

At the top of the flat front side, there are two pre-cut lines (24), which continue at the same height distance along the entire outer perimeter of the container, so it will continue along the lateral sides and the back side, so that when pulling and tearing a corner just over this pre-cut line (24) made by laser, preferably 7 microns: an opening lid is generated through which the content packed inside can be served and that, in this case, the lid is detached or torn from the rest of the container.

Having one more pre-cut line (24) parallel right underneath the other makes it easier and more effective to tear the pre-cut line (24) located on top, because this area delimited by the two pre-cut lines is more consistent allowing better finger grip when pulling the wrapper to tear the pre-cut line, as well as preventing the wrapper, film or sheet from tearing in more places other than the pre-cut line (24).

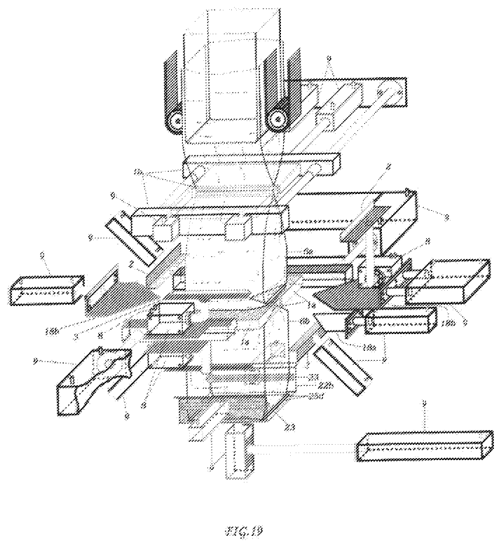

FIG. 19: shows a detailed view of the elevation of the same machine as the one in FIGS. 1, 2 and 3 but, in this case, the machine also has or has installed a second sealing and/or cutting jaw (1b) over the sealing and/or cutting jaw (1a), also, the previous pre-container (6a) that is being developed or manufactured is of the mixed type, pad type from the middle up and English fold type from the middle down (without vertical edge flaps) and, the following pre-container (6b) is an entirely English fold type of container where it can be seen that a flat English fold plus flap has been generated at the bottom (11b) and in the upper left and right side no plus flap has been generated, but a vertical (or, for example, diagonal or oblique) English fold flap has been generated by means of the impact body (18a). In this case, the machine will produce or manufacture two different containers in each production cycle.

The sealing and/or cutting jaw (1b) is operated in the closed position, where the support segments of the two jaws are in contact when closed.

According to a first object of the invention, a process for transforming an English fold type pre-container with a stable bottom is presented, in which an English fold flap arranged in a vertical (or curved, inclined or diagonal) plane is generated to the left and right of the top part of the pre-container (6b) and an English fold flap arranged in a horizontal plane is generated to the left and right of the bottom part of the pre-container (6a):

These pre-containers (6a; 6b), by means of the plus impact bodies (2; 3), will be transformed or widened into a cubic shape, generating a flat side in the upper part and a more stable and consistent side in the lower part or side, which will also have the function of a lid due to the fact that a 7 micron pre-cut line has been made in the outer layer of the sheet or film. Therefore, two flat English fold plus flaps (11a) [in horizontal plane] and two English fold plus flaps (11b) [indistinctly, I call it: in an inclined plane/vertical/diagonal] will generated and sealed. The Procedure comprises the following four Stages:

First Stage

It is predisposed to the vertical packaging machine of the film type roll and that, in this case, is a two-layer polyethylene and polypropylene rolled sheet in the outer layer. The roll is introduced into the drum at the back of the machine and is unfolded on mechanical and non-mechanical rollers that redirect the sheet to the forming neck, where it is folded into a square shape, which as the sheet or film moves downwards will completely wrap the forming tube (5), in this case, rectangular. This sheet, at the same time that it advances moving downwards, will undergo the following two processes:
a device arranged vertically and parallel to the side behind the forming tube (5), intended to seal with at least one continuous longitudinal sealing line, by means of a mechanical method such as that of a rotating wheel or disc, which in turn has a heat source mode on the outer perimeter contour: the two ends of the folded sheet overlap to form a rectangular tube, thus keeping the sheet permanently in the form of a tube, and
a device arranged vertically located in at least part of the four corners of the rectangular tube, intended to continuously fold the four edges and/or at least part of the areas contiguous to these edges generated in the wrapper when wrapping the forming tube (5), by means of a method such as a clamp or a method of strangling the wrapper at two points distant from each edge, as well as intended to seal with at least one continuous longitudinal sealing line, by means of a mechanical mode such as a roller sealer which is in itself a heat source, or in its external contour has a heat source mode, so as to continuously seal the four stable bottom burr edged flaps generated on the four edges; obtaining four defined lateral sides that give the pre-container or container greater consistency and stability, and it will facilitate or be part of the process by which the horizontal English fold flap is generated.

Then, the sheet or film already in the form of a tube, will pass through the sealing and cutting jaws (1a), located right underneath the forming tube (5), which will be at a distance from the sealing and cutting jaws (1a) which is less than, equal to or greater than the length of the container (7) or pre-container (6a) to be produced but which, in any case, it will allow the wrapper to later flex so that the English fold flaps, plus flaps, burr plus flaps or triangular body flaps folded or bent over themselves are generated.

Next, the following step is taken simultaneously:
the sealing and cutting jaws (1a) are operated to close (mechanically driven by linear cylinders (9) to flatten and block the wrapper, and
at the same time, on the lowest part of the lateral sides of the wrapper, is to be pressed with a triangular shaped impact body (18b), which is to be inserted into the container horizontally, thus generating the English fold (10) but with the horizontal triangular shaped flap centered in the middle of the width of the flat side which is also generated, thus giving the previous pre-container (6a) {the one between the sealing and cutting jaws (1a) and the forming tube (5)} a support base, and the pre-container (6a) is widened at the bottom adopting a parallelepiped or cubic geometric figure shape.

Second Stage

From here, the sealing and/or cutting jaws (1a) will be able to seal and cut the bottom part of the pre-container (6a). On the other hand, when the sealing and cutting jaws (1a) are operated and closed, they will more optimally form a flat and wide surface on both sides (top and bottom) so that the pre-container rests horizontally, which will subsequently make it easier to generate the plus flaps [or triangular body flaps] (14; 15a; 15b; 15c)] by knocking, folding and sealing at least part of the underside of the side or lateral side of the pre-container (6a) onto at least part of the supporting side or the one at the top. The procedure comprises the following steps:
A first step, in which two flat stable bottom plus flaps (12b) {one on the left side and one on the right side} will be generated at the same time from the bottom or lowest part of the pre-container (6a), by means of an impact body (2) and a heat source (4) from a device located near the bottom of each lateral side (one on the left and one on the right) of the pre-container (6a; 6b).

This device, in this case, is fixed to the upper side or face of at least one of the two jaws (the two movable ones, or a movable one and a fixed one) which make up the sealing and/or cutting jaws (or jaw set) (1a). The device consists of:
a plus impact body (2) which is preferably of a rectangular shape and which is additionally attached to (or forms part of) an extension support arm such as a tube, rod or bar which is attached to the shaft or key of the actuator shaft (8), preferably a rotary or swivel type: intended to extend the radius of action by acting as an extension and positioning the actuator (8) at an operating distance from the lateral side of the pre-container (6a); the actuator may in turn be rectilinear or curvilinear or, for example, adjustable in rotation angle: thus improving striking efficiency by horizontally matching the impact body and the surface formed when the sealing and cutting jaws are in the closed position. When this surface is flat and there is the minimum gap or space between the two jaws that make up this jaw set (1a), it is optimized the most; and,
a heat source, preferably of a resistance (4) which is fixed to the plus impact body (2): intended to seal at least part of at least one side of at least one sealing line of, in this case, the flat stable bottom plus flap generated at the bottom part of the lateral side of the pre-container (6a); and
a pneumatic or electric rotary or swivel actuator (8) with a rotation, preferably, of 90°, which is fixed, preferably, on the upper part or side of the fixed jaw (1a) and in a position where its axis is horizontal and parallel to the jaw's axis (1a); in such a way that, when rotated by 90°, the plus impact body (2) will horizontally coincide with the flat surface of a side or upper side of at least part of one of the two jaws (1a, 1b) of the sealing and/or cutting jaws (1a).

The flap is generated when the impact body (2) strikes, crushes and folds the intended portion of at least part of at least one side or lateral side of the pre-container (6a): into at least part of at least another side or lateral side of the pre-container (6a). Also, the higher the impact body (2) hits (impacts) on the lateral side: the greater will be the flap generated, causing the inflation and widening of the impacted area of the pre-container (6a): obtaining
a pre-container (6a) transformed into a more three-dimensional geometric figure shape in which the pressure inside has been increased producing a local inflation effect, causing one quarter (or approximately) of the pre-container (6a), from which the flat stable bottom plus flap (12b) has been generated, to take on a cubic or rectangular prismatic shape.
A second step, once these two flat stable bottom plus flaps (12b) have been generated, two flat stable bottom burr plus flaps (13d) will be generated instantly, one on the lowest part or on the edge of the front side and one on the back side, by means of the same procedure and the same device as that used to generate and seal the flat stable bottom plus flaps (12b), described above in the first step.

This device (3) is to be fixed, preferably, on the upper surface of the sealing and cutting jaws (1a; 1b): one in front of the front side and the other in front of the back side of the pre-container (6a) and at a distance equal to or less than the distance of the lateral devices (2).

Also, at least two, three or four or more devices (2, 3) can be operated at the same time to save time in the 3D plus transformation procedure.

For this purpose, the plus impact bodies (2, 3) involved must be narrower to allow the plus impact bodies (2, 3) to be mounted; so that:
either at least part of the left and/or right end of the burr plus impact body (3) in the middle is narrowed; or one or both plus impact bodies (2) or three of these lateral side plus impact bodies (2, 3) are narrowed.

Third Stage

Once the plus flaps have been generated and sealed and the impact bodies (2, 3) have returned to the initial stop position, the next three steps will be taken:
First, the pre-container (6a) is to be filled with the product to be packaged falling from the top of the machine where there is a multi-head weigher with flaps that, when opened, once the product to be packaged has been weighed, it falls down the inside of the forming tube (5) until it reaches the inside of the pre-container (6a) located above the sealing and cutting jaws (1).
Second, the jaw (1a), seals and cuts, or only cuts, by means of a blade, because it has been sealed during the second stage once the jaw (1a) has been closed.
Third, the sealing and/or cutting jaw (1a) opens and returns to the initial stop position.

Next, the pre-container (6a) together with the rest of the wrapper, will move downwards and stop right at the height required to give the pre-container (6a) once the sealing and/or cutting jaws (1a) have been passed; then, immediately, the sealing and/or cutting jaws (1a) will be completely closed, separating and holding: underneath the pre-container (6b) already completely formed and, on top, another pre-container (6a) belonging to a new packaging production cycle.

At the same time the sealing and/or cutting jaws (1a) close, as is the case with the lower part of the pre-container (6a) located at the top of the sealing and/or cutting jaws (1a), where the English fold flaps are generated (10):
the same process will be developed or carried out by which the English fold flaps are generated (10) but, in this case, on the top of the pre-container (6b) located under the sealing and cutting jaws (1a). Therefore, at the same time as the sealing and cutting jaws (1a) are closed, they will be inserted horizontally inwards both in the lower part of the upper pre-container (6a) and in the upper part of the pre-container (6b) of the jaw (1a):
an impact body (18a; 18b) on each lateral side of both pre-containers (6a, 6b), to thus generate two horizontal English fold flaps {at the bottom of the pre-container at the top of the jaw (1)} and two vertical English fold flaps (10b) (at the top of the pre-container at the bottom (6b) of the jaw (1a), as well as making the two pre-containers (6a, 6b) expand or acquire a cubic volumetry from the middle down (or approximately) of the top pre-container (6a) and from the middle down (or approximately) of the bottom pre-container (6b).

The two impact bodies (18) located under the jaw (1a) are preferably of a rectangular geometric shape, as well as the apexes that friction or contact with the wrapper are rounded to avoid damaging the pre-container (6b) or container (7).

These four impact bodies (18) are driven by means of a mechanical device such as a linear cylinder (9) and are fixed to its rod, as the actuator or linear cylinder is fixed to a support, which in turn is fixed to the vertical or horizontal machine.

Next, once the four English fold flaps have been generated and because in this case a cubic container is to be produced, the plus flaps will be generated simultaneously both in the upper part of the pre-container (6b) located under the sealing and/or cutting jaws (1a) and in the lower part of the pre-container (6a) located above the jaws (1a):
In the top pre-container, we will proceed in the same way and manner and with the same devices and procedure as the one described above in Stage two.
In the lower pre-container, we will proceed in the same way/manner, same devices and procedure as the one described above in Stage two, but the devices are fixed in an inverted position underneath the sealing and/or cutting jaws (1a).

In addition, optionally, before each of the two stable bottom plus flaps (12a) are generated on the left and right side of the top of the pre-container (6b), a cone-shaped flap with no folds will be generated by means of a conical flap removal device with no folds to enable the stable bottom plus flap (12a), also with no folds and of greater width or broader, to be generated in an optimum manner at a later date; so, in the vertical packaging machine, a conical flap removal device is installed underneath the sealing and/or cutting jaws (1a), arranged right in front of the pre-container (6b) at a height, preferably, from the middle or middle down the front or back side of the pre-container (6b), located underneath the sealing and/or cutting jaws (1a), which holds it transversely by the front or back side.

This device has:
a pneumatic or electric rotary actuator (8) fixed in a support mode and located in front of the pre-container (6b) or container (7), where the axis of the same will be at a height right in the middle of the lower (or approximate) half of the container (7) or pre-container (6b), as well as facing the front and back sides of the pre-container (6b) or container (7), and
two support bodies, preferably in the form of a flat rectangular blade or platen, placed one on the left and one on the right of the middle or middle down of the lateral side of the pre-container (6b), and at an adjustable distance close to or in contact but it is not necessary for the two blades to exert pressure towards the inside of the pre-container (6b) in opposite directions. These two blades are attached to the key of the rotary actuator shaft (8) that drives them: intended to
turn the pre-container (6b) like a pendulum, from the sides or lateral sides from the middle to the bottom of the pre-container (6b) or container (7), which is held transversely from the top by the sealing and/or cutting jaws (1a), moving the pre-container (6b) or container (7) with a pendulum movement to the left and/or right and in a few rotation degrees between 1° and 90° (approximately), 45° being the most optimal but, in any case, this will depend on variables such as that of the dimensions, volumetry and the amount of fluid packaged inside the pre-container (the more fluid the less the rotation or turning degrees); so that, when turning, pressure will be exerted on impact towards the inside of the pre-container (6b) {the underside of the sealing and/or cutting jaws (1)} with {the part of one half of the top side, apex or area of one quarter of the top (approximately) towards which the pre-container (6b) is directed with the pendulum movement; producing a local inflation area in the area of a quarter of the top (approximately) of the pre-container (6b) that has not been impacted by the sealing and/or cutting jaws (1a); obtaining:
at least one support side or additional transitional side in the area of the pre-container with which the sealing and cutting jaws impact (1a) and,
a conical configuration flap, inflated and without folds, in the {apex area or quarter area (approximately) of the top part of the pre-container (6b)} opposite {the other quarter area of the top of the pre-container (6b) that has been impacted with the jaw (1a).

The procedure of the device is the following:
once the sealing and/or cutting jaws (1a) are closed and the top part of the pre-container (6b) or container (7), which is now under the jaws (1a), is held transversally, as well as the two horizontal (10a) and the two vertical (10b) English fold flaps, the following steps are taken:
a first step, optional, in which the conical flap removal device is operated by first making the turn to the right so that the blade located on the left side of the pre-container (6a): will push the pre-container (6b) making it turn to the right and upwards, as well as generating a conical flap in the area of the apex or of a quarter of the upper half of the left side of the pre-container (6b); then,
   the plus impact body flap (2), located on the surface underneath the sealing and/or cutting jaws (1a) and close to the lateral side of the upper left side of the pre-container (6b), is operated, so the plus impact body flap (3), which is rectangular and wider than the width of the lateral side: will hit or impact, first, on the lateral side and, second, with the surface underneath the sealing and/or cutting jaws (1a), thus generating the stable bottom plus flap (12a) on the upper left side of the pre-container (6), and
   of the same, it is instantly sealed, in this case, in the stable bottom plus flap (12a), preferably, in the intersection area of this flap and the rest of the pre-container's body: obtaining a more consistent and stable cubic container on the support side, by having:

a broad, square flat side on the top side of the pre-container (6b), an inflated area with a cubic volumetry from the middle up of this pre-container, two stable bottom plus flaps and one stable bottom plus flap sealing line; and
a second step, once the two stable bottom plus flaps (12a) are generated at the top of the pre-container's lateral faces (6b), the sealing and/or cutting jaws (1a):
   seals and cuts or just cuts (because it has been sealed in a previous stage or step) at the same time the bottom part of the pre-container (6a) at the top and the top part of the pre-container (6b) located under the sealing and/or cutting jaws (1a). It is also possible to cut, previously, from the moment that the sealing and cutting jaws (1a) were closed the previous time, because the jaws (1a) hold and fasten the pre-container (6b)] and,
   finally, the sealing and cutting jaws (1) open and the container (7), already processed and transformed into a cubic geometric body shape, falls.

From here, the same stages and steps will be repeated to produce this same closed plus cubic container, in this case, in its entirety.

According to a second object of the invention, a machine is presented, or a refinement and improvement of vertical (or, for example, horizontal, inclined plane or diagonal) packaging machines for flexible containers such as the English fold, stable bottom, pad or, also, half or one part pad and half or one part English fold or stable bottom, which contains at least one fluid inside and, optionally or additionally, may contain at least one solid, e.g. (solids and/or granules) and/or (powders), which comprises:
optionally, means of conducting or guiding and folding the sheet, film on a roll or wrapper, such as a forming neck and/or a forming tube, preferably square or cylindrical, and
at least one jaw device or set of two parallel jaws with which the flexible pre-containers or containers are, preferably, transversely and horizontally sealed and cut (from both the top and the bottom), and
optionally, means of conducting or guiding and folding the sheet, film (on a roll) or wrapper (tube or semi-tube), such as a forming neck and a forming tube, preferably square or cylindrical, and
optionally or additionally, a means of sealing intended to seal longitudinally or at least part of at least one side by at least one sealing line: of at least part of two ends that meet and overlap of, for example, a sheet or film preferably wrapped around a forming tube, and
optionally or additionally, a means of generating at least one fold and at least one means of sealing (preferably longitudinal and continuous) the fold (or at least part of at least one side by at least one sealing line of the fold): on at least one vertical edge of at least one side of the sheet or film (or of a wrapper in the shape of a tube or semi-tube) which, most optimally, is folded wrapping the forming tube and, preferably, four of these folds are generated with at least one continuous sealing line: two on each vertical edge perimeter (to the left and right) of both the left side and the parallel right side.
optionally or additionally, a means of generating at least one fold such as the English fold or stable bottom type, and
optionally or additionally, a means of manual, mechanical or automated filling of the content to be packaged inside the pre-container or container, such as that of a hopper, dosing machine or multi-head weigher;
   where the machine is characterized because it has:
at least a 3D plus device of the invention, intended to hit or push, by means of an impact body mode or of a directed fluid (preferably air), to at least part of at least one face or side of the pre-container or container [for example: (to the left or/and right) or/and (in front or/and behind) from on top or/and underneath], preferably the area of the edge or contiguous area to it, but also the area of an apex or the area of two sides or contiguous sides):
   generating at least any one of the flaps as for example: plus flap (11a; 11b; 12a; 12b; 13a; 13b; 13c; 13d; 13e), the triangular body flap (14) or the manipulated triangular body flap (15a; 15b; 15c) by means of a mode such as the 3D compack system.

The plus impact body may be fixed to a support (itself fixed to the machine) or to at least one element or part of the machine, preferably, the sealing and cutting jaws (1), and
at least one sealing system, by means of a heat source such as a resistance, laser or ultrasound; arranged close to at least one face or side of the pre-container or container [e.g. to the (left or/and right) or/and (front or/and back) from on top or/and underneath] and which, preferably, most optimally, will be attached to the same plus impact body (2, 3), which generates the plus flap, burr plus flap, triangular body flap or manipulated triangular body flap by means of a mode such as the 3D compack system. It can also be fixed to the sealing and cutting jaws (1), preferably to the flat surface on top and/or underneath the sealing and cutting jaws: intended to
   seal at least once with at least one sealing line at least part of at least one side of at least one English fold plus flap, stable bottom plus flap, burr plus flap, triangular body flap or manipulated flap, defined in the previous step; obtaining:
      at least one sealing line that will permanently keep at least one of the support sides or additional side, or the area limited by a support contour or additional side, and will also permanently keep the English fold plus flap, stable bottom plus flap, English fold burr plus flap, stable bottom burr plus flap, triangular body flap or manipulated triangular body flap stable.

According to a third object of the invention, a system is presented which comprises the ability to produce at least two containers (7) in each machine manufacturing cycle, by means of at least a second sealing and/or cutting jaw (1b), as well as to generate any one of the containers, preferably a mixed container, one half of which (preferably a transverse horizontal from the middle up) is of the pad type and the other half of which is of the English fold or stable bottom type.

The following describes the procedure from the production or processing of the second cycle onwards, which contains the following steps:
A first stage, in which the wrapper, film, sheet, tube or semi-tube, by means of a mode as described in the first stage of Claim 1, is positioned or has passed {the last sealing and/or cutting jaws or also, the sealing and/or cutting jaws (1a) and/or jaws (1b)}: at least a distance equal to or greater than the length of the container (7) or pre-container (6a) or/and pre-container (6b) which is or are intended or wanted to be obtained.

A second stage, in which the procedure is the same as the one given in the second stage of Claim 1, and as in Claims 5 and 10. The following steps are taken:
A first step, in which the sealing and/or cutting jaw (1a) is closed, defining a pre-container (6a) open at the top and a pre-container (6b) closed at the top and at the bottom, and, depending on the intended container (7), a choice will be made from the following options:
   in the case of a mixed container, simultaneously, the sealing and/or cutting jaws (1a) will close at the same time as the impact bodies (18a; 18b) are operated, generating simultaneously two English fold type flaps both at the bottom of the pre-container (6a) and at the top of the pre-container (6b) and,
   in the case of a complete pad container, the jaw (1a) will close in the manner of the pad type container (where the impact bodies are not operated (18a; 18b)), thus generating a transverse pad sealing flap (17a), in which the two sides of the film, sheet, tube or semi-tube that are brought together when the jaw is closed (1a): do not form overlapping layers or folds as in the case of an English fold or a stable bottom container and,
   in the case of a complete (or partial) English fold or stable bottom container, the impact bodies (18a; 18b) arranged on the left and on the right and on top and underneath the jaw (1a) are operated simultaneously [as another option, at least one (18a; 18b) is operated], thus generating on the left and/or on the right of the lower part of the pre-container (6a) and on the left and on the right of the upper part of the pre-container (6b): a flap (or at least a flap) of the English fold and/or of the stable bottom type.
A second step, in which, preferably, the pre-container (6a) is filled with the product to be packaged and then the sealing and/or cutting jaw (1b) is closed defining a pre-container (6a) also closed from the top and from the bottom and that, depending on the finished container (7) to be obtained, a choice will be made from the following options:
   in the case of a mixed container, the jaw (1b) will close in the manner of the pad type container, where the impact bodies (18a; 18b) are not operated, thus generating a transverse pad sealing flap (17a), in which the two sides of the film, sheet, tube or semi-tube that are brought together when the jaw is closed (1b): will not form overlapping layers or folds as in the case of an English fold or a stable bottom containers and,
   in the case of a complete pad container, the jaw (1b) will close in the manner of the pad type container described above and,
   in the case of a complete (or partial) English fold or stable bottom container, the sealing and/or cutting jaw (1b) closes in the manner of the English fold or stable bottom type container, so that simultaneously with the closing of the jaw (1b), at least one impact body (18a; 18b) arranged on the left and on the right and underneath the jaw (1b) will preferably be operated [as another option, at least one (18a; 18b) is operated] thus generating on the left and/or on the right of the top part of the pre-container (6b):

one or two English fold and/or stable bottom type flaps.

Also, once the jaws (1a; 1b) are in the closed position, and depending on the container (7) to be obtained, it will be chosen, from any of the options or processes described in Claim 5, the option being the one that is most optimized when sealing and cutting in between the transverse sealing line carried out on the entire upper transverse part the pre-container (6a) or, also,
is cut or sealed and cut in front or behind, preferably, at least one transverse sealing line carried out on the entire upper transverse part the pre-container (6a), when it is desired to obtain a container that is open on at least one side, which will subsequently be used as a container to be filled and sealed, later, in a production plant.

Another option may also be given in which this jaw (1b) does not cut or seal, or only seals.

A third stage, in which the procedure is the same as in stage three of Claim 1 and stage four of Claim 2.

A forth stage, where the procedure is the same as in Claim 3.

A fifth stage, in which the sealing and/or cutting jaws (1a; 1b) are opened, thus obtaining:
in the case where the two jaws (1a; 1b) cut the entire upper and lower transverse part the pre-container (6a; 6b), two finished containers (7) in each manufacturing cycle:
an individual pre-container (6a) which has already been processed or converted into a container (7), where it will be picked up, for example, by a mechanical means such as a robot arm or gripper, or dropped onto a conveyor belt located underneath the machine, and
an individual pre-container (6b) which has already been processed or converted into a container (7), where it will be picked up by a mechanical means such as a robot arm or gripper, or dropped onto a conveyor belt located underneath the machine.

Also, both the pre-container (6a) or/and the pre-container (6b), can be opened from the upper or/and lower transverse part (unsealed or completely unsealed and cut) or closed (fully sealed and cut), just as the cut can be made in between by at least one closing transverse sealing line of the pre-container (6a) or on the contrary, on top of or underneath the sealing line(s) made; and,
if one of the sealing and/or cutting jaws (1b) does not cut, or does not cut completely across, only one finished container (7) is obtained:
   an individual pre-container (6b) which has already been processed or converted into a container (7), where it will be picked up by a mechanical means such as a robot arm or gripper, or dropped onto a conveyor belt located underneath the machine, and
   an individual pre-container (6a) which has not yet been processed or converted into a container (7), by remaining attached at the top to the wrapper, sheet, film, tube or semi-tube, which in the upper transverse area, before the jaw is opened (1b), can be either open (if it is not sealed or cut) or closed (if it is sealed at least in part, and not cut at least completely), just as, later, once the two jaws are opened, as the wrapper, film, sheet, tube or semi-tube advances again, the pre-container (6a) will become the pre-container (6b) as it is placed in its place, and
in the case that at least the two sealing and/or cutting jaws (1a; 1b) do not cut, or do not cut the entire transverse area, no finished container (7) would be obtained, so it would be the same as the previous case described above but with the difference that, in addition, as the wrapper, film, sheet, tube or semi-tube advances, the pre-container (6b) will be left hanging and will now become a pre-container (6c): after the pre-container it was previously (6a) it has now become a pre-container (6b).

A sixth stage, in which, the wrapper, film, sheet, tube or semi-tube, once all the sealing and/or cutting jaws (1a; 1b) are activated or are in the open position:
preferably, the one between the jaws (1b) and the rest of the wrapper, advances, since pre-container (6a) and pre-container (6b) have previously been cut by the sealing and/or cutting jaws (1b), in the entire upper transverse section, and
stops, preferably, when it passes or travels a distance {to be counted from the jaw (1a)} which is at least equal to or greater than the length of the height of the sum of the pre-container (6a) plus the pre-container (6b), which are desired or intended to be obtained; so that, on top (or on one side) or underneath (or on the other side) of the sealing and/or cutting jaw (1a) and that the jaw is closed: a pre-container (6b) and a pre-container (6a) are defined.

1.-99. (canceled)

100. Procedure for transforming flexible plastic or plastic-plus-paper pre-container or container: to a form of greater or lesser three-dimensionality or/and of different geometric body shape or of mixed geometric body shape.
The containers or pre-containers (6a; 6b; 7) are made of a flexible plastic material of film type in coil, sheet, tube or semi-tube, which may not hold anything inside or, on the contrary, hold at least one fluid, as well as additionally may additionally hold solid.
The pre-containers or containers are elaborated in manual or automatic vertical, horizontal or oblique machines for forming, filling and/or sealing of flexible heat-sealable containers, being the containers elaborated by these machines as the Pillow type, Pillow type, Suchet type, Pouch type, English fold type, Stable bottom type, Stabilo type, Stable bottom type, Pouch type or Gusset type, where the machines comprise:
at least one support to hold the film, foil, sheet, tube or half-tube type wrapper.
means of mobility, driving or/and dragging to move forward or backward the wrapping with which the containers are formed, using alternatively and combined in an indistinct order between one or more of the following options: manually, by means of the gripper of a robot, using at least one motorized roller where the wrapping is placed or/and the at least one rotating roller with belt transmission.
optionally or in addition, a forming tube (5) or/and forming neck with which the film, sheet, tube or half-tube is folded or/and formed into a film, sheet, tube or half-tube.
optionally or additionally, a sealing means, by means of a heat source such as that of a resistor or by ultrasound, to realize the longitudinal sealing line of the left and/or right longitudinal end of the pre-containers (6a; 6b) or containers (7) such as those of suchet, pouch, pillow or Pillow type with three or four seals or welds.
optionally or in addition, a sealing means, by means of a heat source such as that of a heating element or by ultrasound, for longitudinal sealing in the middle area or on the sides of the wrapper, these longitudinal seals being those in the middle of the rear face and on the left and right of the pre-containers (6a; 6b) or container (7) such as those of pad type, English fold or stable bottom of three, four or five seals or welds.
optionally or additionally, a means for generating and sealing at least one continuous or discontinuous vertical edge flap (16): on at least one side or on the left or/and right side of the pre-container or container, as well as the most optimal way to generate the vertical edge flaps (16) is when, by means of the forming neck or/and forming tube, the wrapper acquires or takes the shape of a quadrangular tube when being coupled around the forming tube (5), generating in the wrapper four vertical edges (16) in the area just of the four longitudinal edges that the forming tube (5) has; so that at least part of the wrapper on one of the sides or areas adjacent to an edge (16): is to be folded and sealed on at least part of the other side or zone contiguous to the same edge (16), so that the pre-container or container is to contain at least one vertical edge flap (16), which endows the pre-container or container with greater firmness and consistency.
at least one sealing and/or cutting jaw (1a) with which the top and/or bottom cross-section of the pre-containers (6a, 6b) or containers (7) is sealed and/or cut.
optionally or in addition, at least one way of generating an English fold, Stable bottom fold, Stable bottom fold or Stabilo fold, which are generated when the sealing and/or cutting jaw (1a, 1b) is simultaneously actuated at the same time as the sealing and/or cutting jaw (1a, 1b) is closed, by means of a mechanical means such as pneumatic cylinders or servos, an impact body (18a) such as that of a triangular-shaped plate arranged in a horizontal plane or/and at least one impact body (18b) such as that of a quadrangular or trapezoidal-shaped plate arranged in a vertical plane.
a way or means of forming a three-dimensional shape or geometric body, such as:
the upstream pre-container (6a), located just above the sealing and/or cutting jaw (1a), wherein the lower part of the pre-container (6a) is held by the sealing and/or cutting jaw (1a) which is actuated in the closed position, as well as the wrapper forming the pre-container (6a) is open at least at the top in order to thus introduce inside it the contents to be packaged, or it can also be closed since nothing is to be packaged inside it.
Likewise, the pre-container (6a) houses at least one fluid inside, as well as optionally it can house solid, and/or
the rear pre-container (6b), located just below the sealing and/or cutting jaw (1a), wherein the top of the pre-container (6b) is held by the sealing and/or cutting jaw (1a) which is actuated in the closed position, as well as the top of the wrapper forming the pre-container (6b) is closed,
Likewise, the pre-container (6b) houses at least one fluid inside, as well as optionally it can house solid, and/or
the unitary pre-container (7), is an independent container unit such as English Fold, Stable Bottom, Stabilo, Stable Bottom, Pillow, Pillow, Suchet, Pouch or gusset type packaging, which is to be supported or located just above or below the sealing and/or cutting jaw (1), therefore it is not attached to the wrapper or the pre-container (6a; 6b) and neither is it being held or trapped by the jaw (1a; 1b).
The unitary pre-container (7) is either the pre-container (6a; 6b) which at the top and bottom has been cut, or sealed and cut, or cut and sealed by the jaw (1a), or jaw (1a) and jaw (1b), or is a pre-made container and is subsequently placed, by means of a mechanical mode, above or below the jaw (1a) or jaw (1b).
The containers or unitary pre-containers (7) are closed, or are also open on part or all of one or more of their sides or areas, or may be or be totally closed, as well as may also not house anything inside, or house at least one fluid, or house a fluid and additionally solid.
optionally or in addition, means of introduction and dosing of the product to be packaged inside the pre-container or container, such as a linear or multi-head weigher and/or a hopper.
optionally or in addition, means of generating at least any one of the type flaps such as English fold, stable bottom, flat bottom, Stabilo or gusette; or
wherein the procedure is characterized in that it comprises the following steps:
A first stage, wherein the wrapper with which the pre-container (6a; 6b) is made is to be positioned or is positioned between the sealing and/or cutting jaw (1a), such that,
in a first option, it will be between the sealing and/or cutting jaw (1a) or also passing through the sealing and/or cutting jaw (1a), or
in a second option, it will be exceeding through the sealing and/or cutting jaw (1a) a distance in which at least one pre-container (6b) is formed.
A second stage, in which the sealing and/or cutting jaw (1a) is to be actuated in the closed position, so that:
in the first option of the first stage, the pre-container (6a), closed at the bottom and placed on the sealing and/or cutting jaw (1a), is to be obtained; and
in the second option of the first stage or second processing cycle of the pre-container, the pre-container (6a), closed at the bottom and located above the sealing and/or cutting jaw (1a), and the subsequent pre-container (6b), closed at the top and located below the sealing and/or cutting jaw (1a), are going to be obtained.
Optionally or in addition, one or more English fold, stable bottom fold, stable bottom fold, stable bottom fold or stable fold flaps are also generated simultaneously when the sealing and/or cutting jaw (1a) closes and are actuated by means of a mechanical means such as pneumatic cylinders or servos, an impact body (18a) such as that of a triangular-shaped plate arranged in a horizontal plane or/and at least one impact body (18b) such as that of a quadrangular-shaped plate arranged in a vertical plane, in such a way as to impact and move towards the inside of the side face of the pre-container profile (6a), wherein both impact bodies (18a; 18b) are aligned in the longitudinal half with respect to the side face of the left or/and right profile of the pre-container, wherein the impact body (18a) is to impact at the height of the bottom area of the pre-container (6a) and in an area close to and above the sealing and/or cutting jaw (1a), and the impact body (18b) is to impact at the height of the top zone of the pre-container (6b) and in an area near and below the sealing and/or cutting jaw (1a): causing at least part of the film or foil on the side face of the profile of the pre-container (6a) and also of the pre-container (6b) to be folded and pushed inward.
A third stage, comprising pressing one or more side faces of the pre-container (6a) or/and pre-container (6b), being most optimally pressing the area or the zone of the side faces of the pre-container that is close and/or contiguous to the top or/and bottom surface of the sealing and cutting jaw (1a; 1b), as optimally pressed
towards the inner enclosure and/or towards the surface above or/and below the sealing and/or cutting jaw (1a; 1b), employing a pushing mode such as blowing pressurized air or by means of one or more impact plus bodies or/and sealing and/or cutting impact plus body (2, 3), driven by means of a mechanical mode such as one or more pneumatic or electric cylinders such as the linear cylinder (9) and/or turning cylinder (8), as well as the cylinders are to be fixed to an element or part of the machine, being most optimal when they are fixed to the sealing and/or cutting jaw (1a; 1b) or/and to the English fold impact body or stable bottom (18a; 18b), in such a way that
at least part of the foil or film of at least one side face of the pre-container (6a) or/and pre-container (6b) which is close to or/and contiguous to the top or/and bottom face of the sealing and/or cutting jaw (1a) is to be gathered or folded: on at least part of the contiguous area of the top or bottom face of the pre-container (6a; 6b) which is situated just above or below the sealing and/or cutting jaw (1a); obtaining,
when pressed above and/or below the left or/and right side of the pre-container:
at least one flap, such as at least one plus flap (11a; 11b; 12a; 12b) or/and at least one triangular body flap (14), and
a greater three-dimensionality of the pre-container, wherein at least part of at least one side face of at least one side face of the pre-container profile and at least part of the bottom or/and top face of the pre-container is wider, flatter and more consistent. This is due to the fact that
a widening of the depth in the zone or area at the top or/and bottom of the side face of the left or/and right profile that has been pressed into the pre-container by at least one impact plus body (2), as well as widening in the contiguous zone or area of the top and/or bottom face of the pre-container with which it has been folded, and
a decrease in the height of the zone or area above or/and below the lateral face of the left or/and right side of the pre-container profile that has been pressed inward, as well as in the contiguous zone or area above or/and below the front and rear face; and/or
when pressing up or/and down on the front or/and back side of the pre-container:
at least one flap (13a; 13b; 13c; 13d; 13e), and
a reduced three-dimensionality of the pre-container, wherein at least part of at least one side face of the profile of the pre-container is less wide. This is due to the fact that
a narrowing of the depth of the zone or area above or/and below the side face of the left or/and right profile of the pre-container: which is contiguous of the zone or area above or/and below the front or/and rear face of the pre-container which has been pressed inward with at least one impact plus body (3), and
a decrease in the height of the zone or area above or/and below the front and rear face of the pre-container that has been pressed inward, as well as of the contiguous zone or area above or/and below the side face of the left or/and right profile of the pre-container.

101. Procedure for transforming a flexible pre-container, according to claim 100, characterized in that it comprises the widening of the pre-container (6a) or/and pre-container (6b), or/and, a flattened face is to be generated which acts as a base at the bottom of the pre-container (6a) or/and pre-container (6b), in order to facilitate the subsequent or simultaneous generation of one or more of any of the flaps, such as triangular body type (14), strip type (15), flap plus type (11; 12), burr flap type (13), English fold type or stable bottom or base type.
The procedure is most optimized when performed prior to the third step of pressing the pre-container to generate the flaps.
The flaring procedure is performed by means of different modes, which are chosen randomly and in combination and in an indistinct order from one or more of the following options:
2.1) Procedure comprising one or more of an immobilizing-tightening ram (19), arranged or located under the forming tube (5) or/and inside or outside and at the bottom of the forming tube (5), which when actuated is going to
tamp, block or immobilize the inside face of the support face or base face of the pre-container former (6a), comprised between the tamper (19) (located above) and the surface of the face or the top of the sealing and/or cutting jaw (1a; 1b), as well as it will also widen the pre-container (6a) at least on the underside.
The procedure comprises the following steps:
A first step, in which the wrapper, which envelops the forming tube (5), advances until it passes over the sealing and/or cutting jaw (1a; 1b);
then, the latter is closed generating a pre-container (6a) and/or pre-container (6b); as well as, simultaneously and optionally, when the jaw (1a; 1b) is closed, the English fold (10a), flat English fold (10b), stable bottom flap (10c) or flat stable bottom flap (10d) will be generated.
A second step, in which the rammer impact body (19) is actuated, preferably, until it travels a distance such as to tamp or block the face inside the support face or base face or, if not also, without making contact with the support face or base face, in such a way that it will
widen the pre-container (6a) from the bottom side or/and from the middle downwards (or approximately), so that it can also widen the sides or lateral faces of the bottom side of the pre-container (6a): intended to
to enable any of the flaps to be optimally generated a posteriori, e.g.: the triangular body flap (14), manipulated flap (15a, 15b, 15c) or plus flap (11a; 11b; 12a; 12b; 13a; 13b; 13c; 13d; 13e).
Optionally, the tamper body (19) can be further articulated, by means of a mechanical mode, in such a way that it can rotate upwards or to one side, preferably, until it is positioned in a vertical plane, subsequently facilitating the filling of the contents to be packaged inside the pre-container (6a) due to the fact that it occupies less space in width.
A third step, in which at least one impact plus body (2, 3) is actuated to generate the flaps on the top or/and bottom of the pre-container (6a; 6b) of the sealing and/or cutting jaw (1a; 1b): obtaining
at least any one of the single ones such as: the plus flap (11, 12, 13), the triangular body flap (14) or manipulated triangular body flap (15a; 15b; 15c).
A fourth step, in which once at least one flap has been generated, the impact body tamper (19) returns to the initial stationary position or, also if not, to an intermediate position.
2.2) Procedure comprising a second extendable and retractable forming tube (5b), arranged or located underneath the forming tube (5) or/and inside or outside and at the bottom of the forming tube (5), which when actuated and moved by means of a mechanical mode such as by at least one linear actuator or linear cylinder, is to
tamp, block or immobilize the inside face of the support face or base face of the pre-container former (6a), comprised between the tamper (19) (located above) and the surface of the face or the top of the sealing and/or cutting jaw (1a; 1b), as well as it will also widen the pre-container (6a) at least on the underside.
The procedure is the same as for the immobilizer-tightening rammer (19) described in four steps in point 2.1 above procedure of point 2.1.
2.3) Procedure comprising the immobilizer-stretcher ram (19) and the extendable and retractable forming tube (5b) of a sealing system in, by means of a heat source such as that of a heating element, fixed on the lowermost part of the immobilizing ram or the extensible-shrinkable forming tube to come into contact (when actuated) with the flat face or base of the inside of the pre-container (6a), such that alternatively and combinatorially and in an indistinct order one or more than one and in an indistinct order of any of the following options is to be chosen from any of the following:
1) seal at least part of the base or support face.
2) seal at least part of at least one English type flap or stable bottom, in case it has been formed and is located inside the pre-container (6a).
3) sealing at least part of the base face or support face where at least part of the transverse sealing flap (17) of the lowermost part of the pre-container (6a) is located, which has previously been rotated from a vertical position [by being held by the jaw (1a)] to a horizontal position by being placed below the base or support face as well as above the sealing and/or cutting jaw (1a) once the latter has been opened and then reclosed.
2.4) Procedure comprising a pressing platform (22a) or pressing drawer (22b), arranged in vertical plane below the rear pre-container (6b), as well as these are fixed to the rod of at least one actuator or linear cylinder (9) arranged in vertical plane and this, preferably, will be fixed in turn to the rod of another actuator or linear cylinder (or rotary actuator) arranged in horizontal plane, so that: the pre-container (6b) being gripped or blocked by the jaw (1a), the pressing platform or drawer (which is located just below since previously the linear cylinder (9) in horizontal plane has been actuated) is raised upwards, by means of the linear cylinder in vertical plane, and presses and displaces upwards the pre-container (6b) causing it to be crushed against the face below the sealing and/or cutting jaw (1a). Followed,
once the pre-container (6b) from the top (or from half or ¾ upwards) has been three-dimensionally widened into a cubic or rectangular prismatic shape and a flat face has been generated on the uppermost part of the pre-container, as well as the side faces are arranged at right angles to the flat face on top: it is actuated
at least one impact body (2, 3) to generate at least any one of the triangular body flaps (14), plus flaps (11; 12; 13) or manipulated triangular body flap (15a; 15b; 15c). Then, once the flap or flaps have been generated, the cylinder in the vertical plane returns to the starting point, and then the linear cylinder (9) also returns to the starting point, thus freeing the area underneath the pre-container (6b).
Optionally, the platform (22a) or press box (22b) can be provided with a clamping, gripping or locking system such as, for example, a clamping jaw (22c) to stabilize and clamp the container, preferably at a certain place or concentric point, and also, preferably, by means of a pressing device such as two parallel cylinders facing each other in the opposite direction, by means of a means of exerting pressure such as, for example, two parallel cylinders facing each other in the opposite direction, they will press at least one fluid contained inside the unitary pre-container (7) or pre-container (6a, 6b), so as to facilitate the optimal generation of the flaps both in shape and also by the fact that no overlapping folds are formed which will hinder the sealing.
2.5) Procedure comprising one or more of a conical flap remover (21), located close to and to the left and right of the top of the pre-container (6b; 6a), by which a flap is to be generated in a quasi-cone shape in which there are no over-folds, thereby facilitating the subsequent generation of any one of the plus flaps (11; 12) or triangular body flap (14) in an optimal manner (without folds and linear). The procedure is to be carried out once the sealing and/or cutting jaw (1a; 1b) has closed and is clamping, gripping or blocking the top transverse part of the pre-container (6b; 6a) or, likewise, the generated sealing transverse flap (17), which is located just between the two support segments of the sealing and/or cutting jaw set (1a; 1b).
The unitary pre-container (7) or pre-container (6b; 6b), in turn, may have previously generated (optional) an English fold type flap (10). The procedure comprises the following two steps:
A first step, wherein at least once the tapered flapper (21) which is attached to a pneumatic or electric rotary actuator, located in front of the rear pre-container (6b) or container, is actuated, performing a rotation of between 45 and 90 degrees (or approximately) towards at least one of the sides (to the left and/or right), whereby at least one impact body, preferably in the form of a blade (21a) or, for example, of a rectangular plate, fixed to the axis of the turning actuator and located on the lateral side of the rear pre-container (6b) or container opposite to the direction of movement of the conical flap remover (21):
is going to push the rear pre-container (6b; 6a) or unitary pre-container (7) causing it to flip or shift to the right and upward, causing one half (approximately) of the top of the rear pre-container (6b; 6a) or unitary pre-container (7), to crush against the bottom surface of the sealing jaw and/or cutter (1a; 1b): generating,
a conical flap in the area of the apex or one-fourth of the top half of the side opposite the flattened area of the rear pre-container (6b; 6a) or unitary pre-container (7).
A second step, in which the same procedure as that described in the third and fourth stages of claim 1 is to be carried out, whereby at least the impact body (2) located close to the conical flap is to be actuated in such a way that it is to be generated on at least part of the conical flap:
any one of the plus flaps (11, 12), triangular body flap (14) or triangular body flap manipulated.
Likewise, as another option, it will also be possible to generate these conical flaps by means of the sealing and/or cutting jaw (1a) [or successive jaws that may be installed in the machine one after the other] which, by means of a mechanical mode such as that of at least one linear actuator located in front of at least the left and/or right side face of the jaw (1a), in such a way that the head of the rod of this actuator or linear cylinder will be fixed parallel to the side or side face of the jaw (1a): to the side or lateral face of the sealing and/or cutting jaw (1a), in which this linear cylinder (9), preferably, is going to move or stop in two different ways depending on the model of the intended unitary pre-container (7) to be manufactured:
in the case of generating a single conical flap at the top of the pre-container (6b), the piston rod of the linear cylinder (9) will travel two distances in two stops or positions:
a first initial position in which the cylinder (9) is in stationary or starting position, as well as the jaw (1a) is located just below the forming tube (5) and, a second position, in which the rod advances forward so that the jaw (1a) will also advance forward at least a distance until it generates the conical flap on the side face opposite to that of the top of the pre-container (6b) on the side opposite to the direction of travel of the rod of the linear cylinder (9) and,
If two conical flaps are to be generated on the top of the pre-container (6b), the piston rod of the linear cylinder (9) travels three distances in three stops: a first intermediate position, in which the cylinder (9) is in stop or start position, as well as the jaw (1a) is located just below the forming tube (5) and, a second position, being the same as described in the previous case and, a third position, in which the rod will travel a distance backwards so that the jaw (1a) will also advance backwards a distance at least until generating the other conical flap on the opposite side to the other one, wherein the rod has stopped in a position before the intermediate position, traveling a distance at least until a conical flap is generated on the opposite side face of the top of the pre-container (6b) on the side opposite to the direction of travel of the rod of the linear cylinder (9), whereby the sealing and/or cutting jaw (1a) has stopped at a point or position backwards from the intermediate position.
Moreover, in the same machine there can be in cascade more than one sealing and/or cutting jaw (1) one after the other, so that once the wrapper, film, sheet, tube or semi-tube passes through any number of jaws (1): each time the jaws (1) are closed one after the other, the contents to be packaged will be filled inside each pre-container (6) by means of a dispenser mode, so that the packaging will start from the bottommost jaw (1): towards the next jaws (1) that are higher up.
2.6) Procedure comprising one or more systems for blowing, by means of a mechanical mode such as that of a compressor and one or more nozzles or/and tubes, at least one fluid inside the pre-container (6a), being most optimally air or/and gas, in such a way as to produce,
on the one hand, the widening and inflation of the pre-container (6a), being the most optimal the area or contiguous faces where the flaps (10; 11; 12; 13; 14; 15) are generated, and on the other hand, the widening and inflation of the pre-container (6a),
on the other hand, it will make the pre-container (6a) acquire a more defined three-dimensional geometrical shape of the intended pre-container (6a; 7) to be obtained.
The blowing system will be located inside the pre-container or container and also, if there is a forming tube (5), it will be located or fixed inside or/and outside the forming tube, as well as optionally the pressurized air blowing tube is telescopic or/and articulated in order to be inserted and positioned precisely in the area or at the height where any of the flaps of the pre-container are generated: intended for,
to enable any of the flaps to be generated optimally in dimensions, shape and without over folds or wrinkles due to the fact that the wrapper, film, tube or semi-tube is going to be stretched and widened.
2.7) Procedure comprising one or more of a pre-container wrapper gripping and displacement system (6a; 6b; 7), by means of a mechanical mode such as that of one or more robot grippers, mechanical arms or suction cups with or without air suction, which are actuated by one or more pneumatic or electric cylinders, so that first one or more side faces of the pre-container are to be gripped and subsequently are to be displaced outwardly or in the opposite direction to the pre-container aging, so as to widen the pre-container wrapper or the area where any of the flaps are to be generated.
This gripping and displacement system will be fixed outside the casing to one or more elements or parts of the machine, such as the sealing or/and cutting jaw (1a; 1b) or impact body (18b; 18b) with which the English fold or stable bottom type flaps are generated.
Furthermore, at least two suction cups without air suction will be fixed to the left and right of the pre-container and/or in front of and behind the pre-container, as well as being fixed or positioned when actuated: aligned at the same height but in opposite directions, to the left and right of the pre-container and/or in front of and behind the pre-container, so that when actuated the suction cups will impact each other.
2.8) Procedure comprising one or more of a device or system of rods or frame as a tensor, extensible or non-extensible, which are fixed to the inside face of the forming tube (5), remaining inside the wrapper and the pre-container or pre-container (6a), in such a way that it will widen the pre-container, pre-container (6a) or unitary pre-container (7) to facilitate the generation of the flap without folds and wider: obtaining
a unitary pre-container (7), pre-container or pre-container (6a) with a more three-dimensional shape.
2.9) Procedure comprising a system of upward and downward displacement of the sealing and/or cutting jaw (1a), by means of a mechanical drive mode such as that of a pneumatic or electric cylinder or actuator, such that when actuated the actuator is going to cause the pre-container (6a), which is clamped or/and blocked by the jaw (1a) along the transverse sealing line (17) of the lowermost part of the pre-container (6a):
is displaced upwards by colliding with the underside of this jaw (1b), causing the pre-container (6a) to widen or inflate (preferably by ¾ or from the middle to the top of the upper part) in order to facilitate, a posteriori, The top part of the pre-container (6a), where the flaps are generated, acquires a cubic or parallelepiped shape, as well as the edges are more defined, being more straight and more at right angles.

102. Procedure for transforming a flexible pre-container, according to claim 100 or 101, characterized in that it comprises a fourth stage, wherein one or more of any one or more of the generated flaps of one or more pre-containers (6a; 6b; 7), by means of a mode is to be manipulated or/and transformed, choosing randomly and combined and in an indistinct order from among one or more of any one of the following options:
3.1) a mode comprising sealing, by means of a heat source mode (4) such as that of a heating element (4a) or by ultrasound, one or more times on one or more sides with one or more seals on part or all of one or more of any one or more of the generated flaps, being most optimized when sealing part or all of the intersection zone of any one of the flaps and the body of the pre-container, or/and part or all of the transverse zone parallel to the intersection zone of any one of the flaps and the body of the pre-container; obtaining,
one or more sealing or welding lines or/and points that permanently maintain stable at least part or all of any one of the flaps, and
at least one additional pre-container side and/or at least one additional support side.
3.2) a mode comprising cutting one or more times part or all of one or more of any one or more of the generated flaps, by means of a blade-like mode, obtaining:
part or all of the flap, triangular body or cut strip.
3.3) a mode comprising cutting or severing by cauterizing part or all of the flap, triangular body or strip, by means of an incandescent metal cutting edge or filament; obtaining,
a part of the flap, triangular body or strip cut or severed, and
a sealing line like that of a heat-sealed plastic thread.
3.4) a mode comprising the following two steps:
a first step of: sealing, by means of one or more heat sources such as a resistor or by ultrasound, one or more times on at least one side with one or more sealing lines or/and sealing points the flap or triangular body (14) of the pre-container, such that the flap or triangular body will subsequently be transformed into a strip shape (15).
For this purpose, the area adjacent to or and/or next to the left and right of the sealing line that runs longitudinally through the middle of the flap or triangular body (14) is sealed longitudinally, this longitudinal line being the same transverse sealing line that closes the flexible containers in the uppermost and/or lowermost transverse area.
At the same time, the intersection area of the flap or triangular body and the body of the container is also sealed, as well as it is optional to seal just above the longitudinal seal that is located at the longitudinal half of the flap or triangular body.
a second step of: cutting or severing, by means of one or more blades or by cauterizing with a cutting edge or incandescent metal wire, part or all of the left and/or right segment of the triangular flap or body (15a), wherein these segments are delimited by the following sealing or welding lines: the longitudinal sealing or welding line made to the left and right of the longitudinal sealing or welding line of the middle of the flap or triangular body, and the sealing or welding line made in the area of intersection of the flap (or triangular body) and the body of the container.
Once the two steps have been completed, a triangular strip-shaped flap or body (15b) is obtained.
3.5) a mode comprising folding upon itself the flap, triangular body flap (14) or strip flap (15b), by mechanical means such as directed pressurized air or pneumatic or electric cylinders such as one or more linear or/and swivel cylinders, such that it is to:
folding one or more times towards one or more directions part of the flap, flap triangular body (14) or flap strip (15b) in or on another part of itself; obtaining,
a flap, triangular body flap (14) or strip flap (15b) that protrudes less from the body of the container or has less length in length, and/or
an edge or/and crease that is generated in the intersection area of the folded, folded or joined parts of the flap, triangular body flap (14) or strip flap (15b).
3.6) a mode comprising sealing, by means of one or more heat sources such as a heating element or ultrasound, one or more times on at least one side with one or more transverse seals on part or all of the fold and/or area contiguous or adjacent to the edge or/and fold that is generated by folding the flap, triangular body (14) or strip (15) upon itself; obtaining in a permanent manner:
the folding of the flap, triangular body (14) or strip (15b), and
a support face or additional face generated in the area of the container body adjacent to the flap, triangular body or folded strip, as well as
a flap, triangular body (14) or folded strip (15b) that protrudes less from the body of the container by having a shorter length, and
an edge and/or fold is generated in the intersection area between the folded parts of the flap, triangular body (14) or strip (15b).
3.7) a mode comprising fixing or joining, by means of contact glue or adhesive, the loose but not separated part which is generated by folding over itself the flap, triangular body or strip, which is comprised between the most extreme part or vertex of the flap, triangular body or strip and the fold which is formed by folding over itself the flap, triangular body or strip which is not loose; obtaining,
a loose flap, triangular body or strip that is permanently attached to another part of the rest of the same flap, triangular body or strip that is not loose, which is comprised between the fold of the folding of the flap, triangular body or strip on itself and the area of intersection of the flap, triangular body or strip and the body of the container.
3.8) a mode comprising cutting, by means of a blade or by cauterizing with an incandescent metal edge or filament, the loose but not separated part of the flap, triangular body or strip, which is comprised between the most extreme part or vertex of the flap, triangular body (14) or strip (15) and the fold formed by folding over itself the flap, triangular body or strip; obtaining,
a flap, triangular body or strip of smaller size and smaller volume, in which part or all of the loose flap, triangular body or strip has been sectioned and separated from the rest of the same flap, triangular body or strip.
3.9) a mode comprising sealing, by means of one or more heat sources such as that of a heating element or ultrasound, two or more transverse seals on the flap, triangular body (14) or strip (15), which are made on one or more sides and with one or more sealing or welding lines or/and dots on each transverse seal, wherein the first seal is made in the area of intersection of the flap, triangular body or strip and the body of the container, and the second transverse seal is made following or/and separate from the previous or first seal.
In addition, the most optimized is when there is a separation between transverse seals or welds of between 0.1 and 5 millimeters, although there may also be no separation between the transverse seals or lines, or there may be part of a transverse seal or line superimposed on part of another transverse seal or line; obtaining:
two or more transverse seals in the area of intersection of the flap, triangular body or strip and the body of the container, which will keep the flap, triangular body or strip, as well as the support faces or additional faces generated in the container, permanently arched, and
an arching of the flap, triangular body or strip in the area delimited between two separate or overlapping transverse seals or weld lines, and
a vertical or diagonal elevation of the flap, triangular body (14) or arched strip (15), which contacts or does not contact the side face of the container body profile.
It is also optimized when a plexible plastic wrapper is used to make the pre-container: with a thickness or gauge of between 10 to 80 microns, as well as one of the layers of polypropylene and/or polyethylene.
3.10) a mode comprising rolling, or rolling and flattening, or also but rolling, flattening and sealing the flap, triangular body flap (14) or strip (15b), by means of a mechanical way such as by means of at least one pneumatic or electric rotary actuator or pneumatic or electric turning cylinder, as well as also by means of a way of momentarily holding the end of the flap, triangular body flap (14) or strip (15b) until it is rolled up, the most optimal way being by means of a pneumatic or electric clamp or clamp cylinder, or by means of a non-permanent adhesive or bonding system such as contact glue, viscous substance or a sticker with adhesive, or by sealing a resistor or resistor without the thermal insulation tape covering it, so that when the hot resistor comes into contact with part of the end of one of the faces of the flap, triangular body flap or strip flap: Is to be momentarily adhered or embedded in the heat sealable plastic. The procedure includes the following steps:
a first step, in which at least part of the end or the tip of the flap, triangular body flap (14) or strip (15b) is to be clamped by means of a mechanical means such as by means of at least one cylinder clamp or actuator pneumatic or electric clamp, or also by means of a resistor without being covered by an anti-thermal tape or by employing an adherent or glue fixed to the end of a rod or flat or cylindrical bar, such that on contact with at least part of the end of the flap, triangular body flap or strip flap: both are to be glued, adhered or held momentarily until winding is started.
a second step, wherein being attached to at least part of the end of the flap, triangular body flap (14) or strip flap (15b), at least one cylinder or actuator clamp, or bar or rod, or resistor:
will be attached to the rod of a rotary cylinder or rotary actuator, so that when it is actuated and rotated at least one turn, it will cause the flap, triangular body flap or strip flap to also rotate and roll up.
a third step, in which the winding device is separated from the already wound flap, triangular body or strip flap, by means of a mechanical means such as a linear or rotary cylinder, since on its rod will be fixed the winding device such as the cylinder or gripper actuator and the turning cylinder or rotary actuator (in this case, the gripper will be previously opened so as not to hold the end of the flap, triangular body flap or strip flap), or the rod or bar with glue or adhesive or also the resistor.
In the case of rolling and also crushing or/and sealing, the procedure comprises one or two further steps that can be taken both before and after the third step. This procedure has two options:
A first option, wherein once the flap, triangular body flap (14) or strip flap (15b) has been rolled up (and whether or not the rolling device has been separated from the flap, triangular body flap or strip flap): this is to be crushed from above, by means of a mechanical mode such as that of an impact body (2) or impact and sealing body (2) driven by a cylinder or actuator (linear or/and rotary or turning), so that the winding of the flap, triangular body flap or strip flap is to be folded.
A second option, wherein first the same procedure as described in the first option is to be given and, secondly, is to be sealed, by means of a heat source (heat-sealing) such as that of a resistor or by ultrasound, at least once on at least one side with at least one line or/and at least one sealing or welding point: at least part of the flap, flap triangular body (14) or flap strip (15b) rolled up and which has previously been flattened and folded.
3.11) a mode comprising adhering or gluing, by means of a contact-glue or a strip or sticker with glue on both sides, the triangular flap or body (14) to:
a part of the pre-container body, or
to another part of the triangular flap or body (14) that has been folded back on itself one or more times, or
to another part of the flap or triangular body (14) which has been folded over itself one or more times, as well as to another part of the flap or triangular body (14) which has been folded over itself one or more times, as well as the flap or triangular body (14) folded over itself is to be glued to the body of the pre-container.

103. Procedure for transforming a flexible pre-container, according to claim 100 or 101 or 102, characterized in that it comprises the actuation of a second jaw (1b) or sealing and/or cutting jaw (1b), which can be only a closing and opening jaw, or have the same or similar characteristics and functions as the sealing and/or cutting jaw (1a).
This jaw (1b) is to be arranged next to or above or/and below the other sealing and/or cutting jaw (1a), at a distance at least equal to or greater than the length or height of the intended unit pre-container (7) or pre-container (6a; 6b) to be processed: intended to be closed and opened, as well as once the jaw (1b) is closed in any one of the second, third and fourth stages can be chosen, alternatively and in combination and in an indistinct order, from among one or more of any one of the following options:
1) neither seal nor cut. 2) cut. 3) seal. 4) seal and cut. 5) cut and seal.
On the other hand, when the jaw (1b) is actuated in the closed position, in addition to clamping, holding or blocking the pre-container (6a; 7) or the pre-container located just above this jaw (1), it will cause part of the sheet or film of the tubular wrapper to be folded in two parallel faces, thus obtaining:
at least two sides or sheets of the film, foil or wrapper joined in parallel, as well as the more optimized it is when no folds or creases are formed between them, and
a pre-container (6a) or unitary pre-container (7) closed at the top, and
a pre-container just above this second jaw (1b).
Likewise, if the sealing of the jaw (1b) is activated, by having a heat source such as a heating element or by ultrasound, one or more sealing lines and/or points are to be obtained on part or all of one or both sides of the transverse sealing flap (27) or transverse area of the uppermost part of the pre-container (6a) and/or on the lowermost part of the pre-container located above the jaw (1b).
Optionally or complementarily, the second jaw (1b) as well as the first jaw (1a): one or more of one of the jaw procedures (1a) described in the preceding claims are also to be developed so as to generate, manipulate or/and transform one or more of any one or more of any of the flaps of the pre-container.

104. Procedure for transforming a flexible pre-container, according to claim 103, characterized in that it comprises that the main jaw (1a) or/and the secondary jaw (1b), in any of the second or third stages, is to be chosen, alternatively and in combination and in an indistinct order, from one or more of any one or more of the following options: 5.1) cutting. 5.2) cutting and sealing. 5.3) sealing. 5.4) seal and cut. 5.5) neither cut nor seal.
Also, most optimized is when sealing and cutting is performed as follows:
sealing, by means of a heat source mode such as that of a heating element or by ultrasound, one or more times on at least one side with at least one line or/and spot welding or sealing: in part or the whole of the uppermost or/and lowermost cross-sectional area of the upstream pre-container (6a) and/or of the pre-container above the second jaw (1b), or/and downstream pre-container (6b).
cutting, by means of a cutting mode such as a blade or by cauterizing with an incandescent edge or filament, one or more times the entire lowermost cross-sectional area of the pre-container (6a) and/or of the pre-container above the second jaw (1b), and/or cutting the cross-sectional area of the uppermost part of the rear pre-container (6b),

105. Procedure for transforming a flexible pre-container, according to claim 102 or 103, characterized in that it comprises that the transverse closing flap (27) of the lowermost part of the pre-container (6a) or of the uppermost part of the pre-container (6b) which is located between the jaw (1a; 1b) and which is in a position of verticality: turn towards the body of the container or pre-container, in a position of horizontality with respect to the face above or below the jaw (1a; 1b). The procedure comprises the following steps:
a first step, wherein the sealing and cutting jaw (1a; 1b) is to seal and cut, or cut or seal, the lowermost transverse part of the pre-container (6a) and/or the uppermost transverse part of the pre-container (6b), obtaining: at least one transverse sealing flap (27) on the lowermost or/and uppermost part of the pre-container (6a) or/and pre-container (6b).
a second step, in which the sealing and cutting jaw (1a) or/and the jaw (1b) is to be operated in the open position, with an opening in which the flap (27) can be released and rotated without being clamped or blocked by the sealing and cutting jaw (1a; 1b).
a third step, in which the sealing and cutting jaw (1a) or/and the jaw (1b) is to be actuated in the closed position, so that the flap (27) below or/and above the pre-container (6a) or/and pre-container (6b):
is to be positioned or placed below or/and above the face above or/and below the jaw (1a) or/and jaw (1b).
a fourth step, wherein at least part of left or/and right end of at least one flap (27) which is located just below or above any one of the generated flaps (10a, 10b, 10c, 10d, 11a, 11b, 12a, 12b, 14, 15a, 15b, 15c) is to be sealed, preferably, with at least one impact and sealing body (2), as well as the more optimized is when it is sealed at least once on the underside or/and above the flap (10a, 10b, 10c, 10d, 11a, 11b, 12a, 12b, 14, 15a, 15b, 15c) and on at least the part where the flap (27) is located or situated, so that the flap (27) is to be sealed or welded to the face above or/and below the generated flap (10a, 10b, 10c, 10d, 11a, 11b, 12a, 12b, 14, 15a, 15b, 15c); obtaining:
a flap (27) that is permanently maintained horizontally or parallel with respect to the top and/or bottom face that acts as a base or support of the pre-container, and
a pre-container or container which is to be held vertically without tilting or slanting to one side, because the flap (27) is no longer in an oblique or diagonal position with respect to the flat top or/and bottom face of the pre-container (6a) or/and pre-container (6b) which acts as a base face or support face.

106. Procedure for transforming a flexible pre-container, according to claim 100 or 102, characterized in that it comprises that the third and/or fourth stage is to be given in a unitary pre-container (7) which is independent in that it is not attached to the rest of the wrapper or the pre-container (6a; 6b), which has been made from a pre-container (6a) or/and pre-container (6b), as well as still remains in the flexible container forming, filling and/or sealing machine.
Optionally, the unitary pre-container (7) is either clamped from above or/and below by the main jaw (1a) or/and the secondary jaw (1b), or it is not clamped and is solely supported on the sealing and cutting jaw (1a) but, in this case, the unitary pre-container (7) is to be immobilized and/or clamped, by means of a mechanical means such as one or more clamping jaws, one or more grippers of a robot, or the wedging between the jaw (ha) and the jaw (1b), or between the jaw (ha) and the pressing platform (22a) or pressing drawer (22b), as these will be more optimally fixed close to the pre-container (7).
Next, one or more of any one or more of the flaps (11a; 11b; 12a; 12b, 13a; 13b; 13c; 13d; 13e) or triangular bodies (14) will be generated, manipulated or/and transformed, by means of one or more of any one of the procedures or devices of this invention; so that the pre-container unit (7) will be transformed into another three-dimensional geometrical body shape: depending on the shape, size and number of flaps that are generated, as well as on the shape that the unitary pre-container (7) has before being transformed.

107. Procedure for transforming a flexible pre-container, according to claim 100, characterized in that it comprises that steps 1 and 2 of claim 100 are not to be given, because the procedure is to be given in vertical, horizontal or oblique filling-only, or filling and sealing procedures, wherein the procedure comprises:
at least one means for dosing and/or introducing the product inside the container.
at least one base for supporting the containers, in which they are subsequently to be filled.
at least one means of holding the containers to lock or immobilize them.
optionally or in addition, at least one container accumulator dispenser for automatically or manually feeding the containers into the starting point of the machine.
optionally or additionally, a sealing means, by means of a heat source such as a heating element or by ultrasound, for sealing at least one or more sides of the container with one or more seals or welds, partially or completely closing the container.

108. Procedure for transforming a flexible pre-container, according to claim 100 or 102, characterized in that it comprises in the second, third or fourth stage, by means of a filling mode: dosing or/and introducing inside the pre-container the contents to be packaged, being most optimally packaged above the previous pre-container (6a), which is located above the sealing and cutting jaw (1a) or also the cutting or sealing and cutting jaw (1b).
Likewise, the more the procedure is optimized the better:
in the third stage, once all the flaps or at least any one of the flaps of the pre-container (6a): have been or have been generated or generated and/or manipulated or/and transformed, as well as, if there is a second jaw (1b) above the jaw (1a): this one cannot be closed, or
in the second, third or fourth stage: once the cutting or sealing and cutting jaw (1b) has been closed or/and remains closed and subsequently seals or seals and cuts the cross-sectional area of the bottom of the pre-container located just above the jaw (1b) or, likewise, the cross-sectional area of the top of the pre-container (6b); or
Being the least optimized option:
in the second stage, once the sealing and cutting jaw (1a) [and provided that, if there is a second jaw (1b) above it, the latter has not been previously closed] has been closed or/and remains closed until at least the product or/and substance to be packaged is finished being introduced into the pre-container (6a). This option may cause any one of the flaps of the invention generated in the third stage not to be generated or not to form properly, as well as it may also prevent the sealing of the flap or may prevent the sealing by producing breaks, cracks or micro pores, due to the fact that in the area where the sealing or the cutting or folding of the flap is to be carried out: the product packaged inside will get in the way or the plastic material of the wrapper will overheat or a wrinkle will form on the surface of the flap.

109. Procedure for transforming a flexible pre-container, according to claim 100 or 101 or 102, characterized in that it comprises producing two pre-containers (7) or two unitary containers in each manufacturing cycle of the machine, by means of at least one second sealing and/or cutting jaw (1b), as well as generating or processing any of the pre-container or container types, the most optimized being the mixed container such as the pillow-type half-transverse upward and half-transverse downward English fold type or stable bottom type. The procedure comprises the following stages:
A first Stage, in which the procedure is the same as that described in the first stage of claim 1.
A second Stage, in which the procedure is the same as that given in the second stage of claim 1, as well as in claims 4, 5, 7 and 9, wherein the procedure comprises the following steps:
A step first, wherein the sealing and/or cutting jaw (1a) is closed, defining a pre-container (6a) open at the top and a pre-container (6b) closed at the top and bottom.
Furthermore, depending on the pre-containers (7) or containers to be obtained, one or more of the following options will be chosen:
in the case of an entirely cushion pack, the jaw (1a) will be closed in the manner of the cushion pack where the impact bodies (18a; 18b) are not actuated, thus generating a transverse sealing flap (17a) of cushion, where the two sides of the wrapper which meet when the jaw (1a) is closed: do not form overlapping folds as occurs with the English fold or stable bottom type pack.
in the case of a mixed packaging, entirely or partially of English fold or stable bottom type, simultaneously actuating one or two impact bodies (18a) or/and one or two impact bodies (18b), to the left and/or right and above and/or below the jaw (1a): one or two English fold or/and stable bottom type flaps are generated to the left and/or right of the bottom of the pre-container (6a), or/and to the left and/or right of the top of the pre-container (6b).
A step second, wherein the procedure is the same as that described in claim 2.
A step third, wherein the pre-container (6a) is filled with the product to be packaged.
A third Stage, in which the procedure is the same as that described in the third stage of claim 1.
A fourth Stage, in which the procedure is the same as that described in the fourth stage of claim 3.
A fifth Stage, in which the second jaw (1b) is actuated in the closed position, so as to obtain a pre-container (6a) with a defined geometrical body shape, which is closed at the top as well as at the bottom, as well as to obtain a pre-container located just above the second jaw (1b).
Furthermore, depending on the pre-containers (7) or containers to be obtained, one or more of the following options will be chosen:
in the case of an entirely pad pack, the jaw (1b) will be closed in the manner of the pad type pack where the impact bodies (18a; 18b) are not actuated, thus generating a transverse sealing flap (17a) of pad, where the two sides of the wrapper which meet when the jaw (1b) is closed: do not form overlapping folds such as occurs with the English fold or stable bottom type pack.
in the case of a mixed packaging, entirely or partially of the English fold or stable bottom type, simultaneously one or two impact bodies (18a) or/and one or two impact bodies (18b) are actuated, to the left and/or right and above and/or below the jaw (1b):
one or two English fold type or/and stable bottom flaps are generated to the left and/or right of the top of the pre-container (6a), or/and to the left and/or right of the bottom of the pre-container located just above the second jaw (1b).
A sixth stage, in which the contents to be packaged are to be dosed and/or introduced inside the pre-container located above the second jaw (1b).
A seventh stage, in which the second jaw (1b) and the first jaw (1a), depending on the unitary pre-container (7) or container to be obtained, will choose between one or more of any of the following options: a) cut. b) cut and seal. c) seal and cut.
Also, the most optimized is when it is sealed, by means of a heat source mode such as that of a resistance or ultrasonic, one or more times on at least one side with at least one line or/and sealing point on part or all of the lowermost cross-sectional area of the pre-container (6a) or/and on the uppermost cross-sectional area of the rear pre-container (6b), as well as being cut, by means of a cutting mode such as a knife or by cauterizing with a cutting edge or incandescent filament: one or more times the entire lowermost cross-sectional area of the pre-container (6a) and of the pre-container above the second jaw (1b), as well as the cross-sectional area of the uppermost part of the rear pre-container (6b) is to be cut,
An eighth stage, in which the procedure is the same as that described in the third stage of claim 1.
A ninth Stage, in which the procedure is the same as that described in the fourth stage of claim 3.
A tenth Stage, in which the first jaw (1a) and the second jaw (1b) are actuated in the open position, such that:
in the case that the two jaws (1a; 1b) have cut through the entire cross section of the pre-container (6a; 6b) from above and below, cut the entire cross section of the pre-container (6a; 6b) from above and below, two finished single containers (7) are obtained in each production cycle:
a pre-container (6a) already finished or transformed into a unitary pre-container (7), where the latter will be optimally picked up by means of a mechanical mode such as that of a mechanical arm, robot gripper or falling on a conveyor belt located under the machine, and
a pre-container (6b) already finished to be processed or transformed into a unitary pre-container (7), wherein in a more optimal way it will be picked up by means of a mechanical mode such as a mechanical arm, robot claw or falling on a conveyor belt located underneath the machine.
Likewise, either the pre-container (6a) or/and the pre-container (6b) at the uppermost or/and lowermost transverse part may be either open having been transversely cut but not having been transversely sealed in its entirety; or it may also be or be closed having been cut and sealed in its entirety.
In addition, the cut may be made in between at least one transverse sealing line of closure of the pre-container (6a) or, conversely, above or below the sealing line or lines made; and,
in the case that one of the sealing and/or cutting jaws (1b) does not cut, or does not cut the entire crosswise, only one finished unitary pre-container (7) is obtained:
a pre-container (6b) already finished to be processed or transformed into a unitary pre-container (7), where the latter will be picked up by means of a mechanical mode such as an arm, robot gripper or falling on a conveyor belt located under the machine, as well as.
a pre-container (6a) not yet finished or transformed into a unitary pre-container (7) when still attached at the top to the wrapper, foil, film, tube or half-tube, which in the uppermost cross-sectional area, prior to opening the jaw (1b), can be either open if not completely sealed and not completely cut, or be closed if at least partly sealed and not completely cut, as well as, subsequently, once the two jaws (1a; 1b) are opened, the pre-container (6a) will become the pre-container (6b) when the wrapper, film, foil, sheet, tube or half-tube is put in place, when the wrapper, film, foil, tube or half-tube is moved forward again; and
in the case that at least the two sealing and/or cutting jaws (1a; 1b) do not cut, or do not cut the entire cross section, no finished unitary pre-container (7) will be obtained, which would be the same as described above but with the difference that, in addition, upon advancing the wrapper, film, sheet, tube or half-tube: the pre-container (6b) is going to be hanging so it is now going to be a pre-container (6c), as well as the pre-container that previously was (6a) is now going to be a pre-container (6b).
Then, in successive manufacturing cycles, the steps 1 to 11 described in this claim 10 will be repeated.

110. Procedure for transforming a flexible pre-container, according to claim 100, characterized in that it comprises generating one or more pre-cut lines (24) with lines or/and discontinuous dots on the wrapper, film or foil on one or more sides of the pre-container, by means of a laser welding system mode, being the most optimal when pre-cutting on the outside with a depth of about 7 micron and without going through the wrapper, film or foil.
The pre-cut (24) is to be performed on part of one or more faces of the pre-container (6; 7), the most optimal ones being the pre-container of cube type, rectangular prism, parallelepiped, trapezoidal rectangular prism, cylinder, elliptical cylinder or concave or convex cylinder, as well as the pre-cut (24) once torn: an opening line or lid is obtained through which the contents packaged inside the pre-container or container are to be accessed.
The pre-cut (24) is most optimized when it is made with a broken line that forms two, three or four perpendicular sides, as well as between the perpendicular sides forming a right angle, or also if they form an angle greater or less than 90 degrees.
Likewise, the most optimized is when the pre-cut line (24) is performed on two, three or four of the edges contiguous or sides contiguous to the edge of one of the faces of the pre-container (6; 7) such as the top, front or side face, as well as the most optimal pre-containers are those of the cube, rectangular prism, parallelepiped, trapezoidal rectangular prism, cylinder, elliptical cylinder, or concave or convex cylinder type.

111. Device on vertical, horizontal or diagonal machines: forming, filling and/or sealing, or only filling and/or sealing, which manufactures or/and transforms, from flexible plastic material of film, sheet, tube or half-tube type, flexible containers or three-dimensional flexible containers, as well as manufactures pre-containers (6a; 6b; 7), which are in the process of being processed or already processed but still remain in the machine because they are to be handled or/and transformed by the same or another machine.
Likewise, the container or pre-container may contain nothing inside or, on the contrary, it may contain a fluid, and it may also contain a solid; wherein the machine comprises:
optionally or additionally, a sealing means, by means of a heat source such as that of a resistor or by ultrasound, to realize the longitudinal sealing line of the left and/or right longitudinal end of the pre-containers (6a; 6b) or containers (7) such as those of suchet, pouch, pillow or Pillow type with three or four seals or welds.
optionally or in addition, a sealing means, by means of a heat source such as that of a heating element or by ultrasound, for longitudinal sealing in the middle area or on the sides of the wrapper, these longitudinal seals being those in the middle of the rear face and to the left and right of the pre-containers (6a; 6b) or containers (7) such as those of pad type, English fold or stable bottom of three, four or five seals or welds.
optionally or additionally, a means for generating and sealing at least one continuous or discontinuous vertical edge flap (16): on at least one side or on the left or/and right side of the pre-container or container, as well as the most optimal way to generate the vertical edge flaps (16) is when, by means of the forming neck or/and forming tube, the wrapper acquires or takes the shape of a quadrangular tube when being coupled around the forming tube (5), generating in the wrapper four vertical edges (16) in the area just of the four longitudinal edges that the forming tube (5) has; so that at least part of the wrapper on one of the sides or areas adjacent to an edge (16): is to be folded and sealed on at least part of the other side or zone contiguous to the same edge (16), so that the pre-container or container is to contain at least one vertical edge flap (16), which endows the pre-container or container with greater firmness and consistency.
at least one sealing and/or cutting jaw (1a) with which the top and/or bottom cross-section of the pre-containers (6a, 6b) or containers (7) is sealed and/or cut.
optionally or in addition, at least one way of generating an English fold, Stable bottom fold, Stable bottom fold or Stabilo fold, which are generated when the sealing and/or cutting jaw (1a, 1b) is simultaneously actuated at the same time as the sealing and/or cutting jaw (1a, 1b) is closed, by means of a mechanical means such as pneumatic cylinders or servos, an impact body (18a) such as that of a triangular-shaped plate arranged in a horizontal plane or/and at least one impact body (18b) such as that of a quadrangular-shaped plate arranged in a vertical plane.
a way or means of forming a three-dimensional shape or geometric body, such as:
the upstream pre-container (6a), located just above the sealing and/or cutting jaw (1a), wherein the lower part of the pre-container (6a) is held by the sealing and/or cutting jaw (1a) which is actuated in the closed position, as well as the wrapper forming the pre-container (6a) is open at least at the top in order to thus introduce inside it the contents to be packaged, or it can also be closed since nothing is to be packaged inside it. Likewise, the pre-container (6a) houses at least one fluid inside, as well as optionally it can house solid, and/or
the rear pre-container (6b), located just below the sealing and/or cutting jaw (1a), wherein the top of the pre-container (6b) is held by the sealing and/or cutting jaw (1a) which is actuated in the closed position, as well as the top of the wrapper forming the pre-container (6b) is closed, Likewise, the pre-container (6b) houses at least one fluid inside, as well as optionally it can house solid, and/or
the unitary pre-container (7), is an independent container unit such as English Fold, Stable Bottom, Stabilo, Stable Bottom, Pillow, Pillow, Suchet, Pouch or gusset type packaging, which is to be supported or located just above or below the sealing and/or cutting jaw (1), therefore it is not attached to the wrapper or the pre-container (6a; 6b) and neither is it being held or trapped by the jaw (1a; 1b).
The unitary pre-container (7) is either the pre-container (6a; 6b) which at the top and bottom has been cut, or sealed and cut, or cut and sealed by the jaw (1a), or jaw (1a) and jaw (1b), or is a pre-made container and is subsequently placed, by means of a mechanical mode, above or below the jaw (1a) or jaw (1b).
The containers or unitary pre-containers (7) are closed, or are also open on part or all of one or more of their sides or faces, or may be or be totally closed, as well as may also not house anything inside, or house at least one fluid, or house a fluid and additionally solid.
optionally or in addition, means of introduction and dosing of the product to be packaged inside the pre-container or container, such as a linear or multihead weigher or/and a hopper.
optionally or in addition, means of generating at least any one of the flaps of type such as English fold, stable bottom, flat bottom, Stabilo or gusette;
wherein the device is characterized in that it comprises one or more impact devices, such as one or more directed pressurized air blowing devices or/and one or more impact bodies (2) or/and impact bodies plus (2), driven by means of a mechanical mode such as one or more pneumatic or electric cylinders, the most optimal ones being the linear cylinder (9) or/and turning cylinder (8), on whose piston rod the impact body or impact body plus is fixed: intended to
pressing, part of one or more side faces of the pre-container (6a) or/and pre-container (6b), towards the inner enclosure of the pre-container and/or towards the top or/and bottom surface of the sealing and/or cutting jaw (1a; 1b), being most optimal when pressing the zone or area of the side faces which are close and/or contiguous to the top or/and bottom surface of the sealing and cutting jaw (1a; 1b); and
generate one or more flaps, alternatively and in combination, from among one or more of any one of the flaps, such as those of the type flap plus (11a, 11b, 12a, 12b), flap plus burr (13a, 13b; 13c; 13d; 13e) or triangular body flap (14).
These impact devices are to be arranged close to the faces or lateral sides of the pre-container where any of the flaps, flaps plus or flap triangular body are generated, as well as they are to be fixed to one or more elements or parts of the machine such as a support, robot gripper or mechanical arm, being most optimized when fixed to the sealing and/or cutting jaw (1a; 1b) or/and to the English fold or stable bottom impact device or body (17; 18).

112. Device, according to claim 111, characterized in that it comprises widening or/and is to generate a flattened face which acts as a base at the bottom of the pre-container (6a) or/and pre-container (6b), so as to facilitate subsequently or simultaneously generating one or more of any one or more of the flaps, such as triangular body type (14), strip type (15), plus flap type (11; 12), burr flap type (13), English fold type or stable bottom or base type.
The devices are most optimized when performed prior to the pre-container pressing stage to generate the flaps.
The flaring is performed by means of different devices, which are chosen randomly and in combination and in an indistinct order from one or more of the following options:
13.1) Device comprising one or more of an immobilizing-tightening Pison body (19), fixed or/and located under the forming tube (5) or/and on one or more faces of the inside or outside of the forming tube (5). This device comprises the following elements or parts:
an impact body by means of a tamper mode (19), preferably, flat and of the same or similar shape as that of the support face that acts as a base, preferably, quadrangular or circular, as well as being preferably defined by a perimeter structure (preferably, quadrangular or circular), as a chassis, which in the center area is preferably hollow so as not to obstruct or intercept the contents to be packed, by a perimeter structure (preferably quadrangular or circular), as a chassis, which is preferably hollow in the center so as not to obstruct or intercept the contents to be packaged in the pre-container (6a) as it falls through the forming tube, and
a drive mode by mechanical means, such as a linear actuator (9) or a pneumatic or electric linear cylinder (9), on whose piston rod the clamp (19) is fixed.
This device (19) is intended to widen, tamp, block or immobilize:
the support face or base face of the pre-container former (19), blocking the wrapper between the tamper (19) and the surface (preferably flat) of the upper part of the sealing and/or cutting jaw (1) which is located below the wrapper, as well as widening the side faces adjacent to the base face, for example by making them, in an optimized manner, positioned vertically (90 degrees to the plane or base face) or approximately vertical (90 degrees to the plane or base face).
The tamper (19) may be of a smaller size or narrower on at least one of its sides (or the perimeter contour), so as to free up space in the area between the outer perimeter of the outer perimeter of the support face of the front pre-container (6a) and the lateral sides or the outer perimeter of the tamper (19), in such a way as to allow the impact bodies or impact plus bodies (2, 3), when actuated, to fold at least part of the bottom area of the wrapper of at least one side or lateral side over at least part of at least one side or outermost area of the support face wrapper, thus generating at least one flap plus (11; 12; 16).
Optionally or in addition, this device may also have a sealing system, by means of a heat source such as a heating element, fixed to the lower part of the immobilizer—stretcher rammer to come into contact (when actuated) with the flat face or base of the inside of the pre-container (6a): intended for
choose, alternatively or combinatorially and in an indistinct order, from one or more of any of the following options:
1) seal at least part of the base or support face.
2) sealing at least part of at least one English type flap or stable bottom, in case it has been formed and is located inside the pre-container (6a).
3) sealing at least part of the base face or support face where at least part of the transverse sealing flap (17) of the lowermost part of the pre-container (6a) is located, which has previously been rotated from a vertical position [by being held by the jaw (1a)] to a horizontal position by being placed below the base or support face as well as above the sealing and/or cutting jaw (1a) once the latter has been opened and then reclosed.
13.2) Device comprising one or more of a telescopic forming tube, fixed or/and located under the forming tube (5) or/and on one or more faces of the inside or outside of the forming tube (5). This device comprises the following elements or parts:
at least two sections of forming tube, being most optimally when they are of a quadrangular or cylindrical shape, in which one fits under the other and is movable, actuated by means of a mechanical mode such as that of one or more pneumatic or electric cylinders, which is to be fixed to at least one face of the inside or outside of the forming tube (5a) which is located just above the telescopic forming tube which is movable.
The telescopic forming tube (5b) will extend or move downwardly: a distance or length less than the gap between the lower part of the movable forming tube (5b) itself and the radius of action of the impact bodies (2, 3) of the invention which generate the flaps, flaps plus or triangular flap bodies; in such a way that it will allow these impact bodies (2, 3) to travel all the way to contact or stop with the sealing and/or cutting jaw (1), without the movable forming tube (5b) blocking their passage or intercepting their trajectory: intended for
on the one hand, that the wrapper of the previous pre-container is widened, preferably from the bottom or from the middle to the bottom and, on the other hand, that the pre-container is not widened, preferably from the bottom or from the middle to the bottom,
on the other hand, the wrapper, film, foil, tube or half-tube is kept taut or stretched to prevent creases from forming, facilitating optimal folding of the wrapper at the time the plus flap (11, 12, 13), triangular body flap (14) or manipulated triangular body flap (15a; 15b; 15c) is generated, as well as simultaneously with or before the impact plus body (2, 3) is actuated to generate the flaps: the wrapper, film, foil, sheet, tube or half-tube, optionally, more optimally, can also be moved or advanced (depending on the size of the generated flap or flap plus) downwards so as to facilitate or allow the flaps to be generated as for example flap plus (11; 12; 13), triangular body flap (14) or manipulated triangular body flap (15a; 15b; 15c), whereby the wrapper, film, foil, semi-tube or tube comprised above the sealing and/or cutting jaw (1a; 1b), and which is in the closed position:
is to be displaced a distance at least so that there is a clearance allowing at least part of at least one side face of the side of the pre-container (6a, 6b) or unitary pre-container (7) to be folded towards at least another part of at least another side of the pre-container or unitary pre-container (7), preferably, the lowermost part of the side face contiguous to the base support face of the pre-container (6a; 6b) or unitary pre-container (7) or the uppermost face or faces of the pre-container (6a; 6b) or unitary pre-container (7).
Optionally or in addition, this device may also have a sealing system, by means of a heat source such as a heating element, fixed to the lower part of the extendable and retractable forming tube so as to come into contact (when actuated) with the flat face or base of the inside of the pre-container (6a); intended for
choose, alternatively or combinatorially and in an indistinct order, from one or more of any of the following options:
1) seal at least part of the base or support face.
2) sealing at least part of at least one English type flap or stable bottom, in case it has been formed and is located inside the pre-container (6a).
3) sealing at least part of the base face or support face where at least part of the transverse sealing flap (17) of the lowermost part of the pre-container (6a) is located, which has previously been rotated from a vertical position [by being held by the jaw (1a)] to a horizontal position by being placed below the base or support face as well as above the sealing and/or cutting jaw (1a) once the latter has been opened and then reclosed.
13.3) Device comprising a pressing platform (22a) or/and pressing drawer (22b), which are located below the pre-container (6b; 6a) which are located downstream of the sealing and/or cutting jaw (1a; 1b) of the vertical packaging machine.
This device comprises or consists of a support base (adjustable), preferably with a drawer, where the half-down part (or approximately) of the pre-container (6b; 6a) is to be inserted inside the pressing drawer, or is to be supported on the pressing platform: intended to press upwards the rear pre-container (6b) {or also front pre-container (6a), due to the fact that the jaw (1a), by means of an actuator (8; 9), is also going to be driven upwards so it is going to have the same function as the Drawer (22a) or Platform (22b)} which is located between the pressing platform and the surface below the sealing and/or cutting jaw (1a; 1b): obtaining.
a pre-container (6b; 6a) which has been flattened and widened three-dimensionally in a cubic or rectangular prismatic shape in the area or part from half or three-fifths upwards (or approximately), as well as a flat face has been generated in the uppermost part which is in contact with the underside of the sealing and/or cutting jaw (1), thus facilitating the subsequent generation of any one of the flaps [single plus (11, 12, 13), triangular body flap (14) or manipulated triangular body flaps (15a; 15b; 15c)] of the pre-container (6b; 6a).
The platform or presser drawer will be moved upwards by means of a mechanical means, such as a linear cylinder actuator that will be arranged in a vertical position, so it will be fixed to the rod of this cylinder (9), preferably, from below, as well as this linear cylinder (9), preferably, will be fixed to the piston rod of another linear cylinder (9) but in a horizontal plane (and this, in turn, will be fixed to a support or element or part of the machine): intended for
push the rear pre-container upwards until it is flattened against the bottom surface underneath the sealing and/or cutting jaw (1).
This device will be located just below the pre-container (6b) which is located downstream of the sealing and/or cutting jaw (1) of the packaging machine.
The pressing platform is a support base, preferably, with drawer and is adjustable, as well as the half-down part (or approximately) of the pre-container (6b; 6a): it is to be inserted inside the pressing drawer (22b), where it can also be supported or not.
Likewise, optionally, the pressing platform (22a) or the pressing drawer unit (22b) can also have, or be fixed to it, at least one system or device of at least one jaw (22c), fixed to at least one side or face, preferably, to the front or rear face, as well as if it is a drawer unit (20b) it will be fixed to the lateral faces of it and, if it is a platform, it will be fixed to the top/bottom face and to the outer contour of it.
The clamping jaw (22c) is intended, on the one hand, to clamp the pre-container (6b) [or unitary pre-container (7)], preferably, at a concentric point or place at which the container is to be maintained in a position of verticality without tilting and, on the other hand, optionally, is to exert pressure from at least one side face of the pre-container (6b) or unitary pre-container (7) towards the interior thereof so that the fluid contained therein: exerts pressure, in turn, on the rest of the pre-container (6b) or unitary pre-container (7), preferably, the part (or the fourth part) from the top or from the middle to the top of the pre-container (6b) or unitary pre-container (7).
13.4) Device comprising one or more of a conical flap removal device (21), wherein these are driven by means of a mechanical means, such as for example a rotary actuator (8) or at least one linear cylinder (9), in such a way as to cause the pre-container (6; 6b; 6a) or unitary pre-container (7) is displaced or pushed from the bottom or from the middle to the bottom in order to rotate it to one side or/and to the other, whereby the path can be, for example, horizontal, diagonal or semicircular, whereby the pre-container will be displaced in the same way (or, to the left or/and to the right, or diagonally to the left or to the right, or, by means of a turning cylinder, to turn pendularly to the left or/and right) thus generating at least any one of the conical flaps.
The device comprises at least one thrust body removes conical flap (21), being able to choose, for example, from among the following different options:
1) at least one device in which there is attached to the head of the stem a body in the form of a blade or plate arranged in parallel and in a vertical plane with respect to the underside of at least one side face of the pre-container (6) or unitary pre-container (7), or
2) at least one drawer device (22b), wherein the bottom or half-down part of the pre-container (6) or unitary pre-container (7) is inserted to thereby, by means of at least one rotor or/and linear actuator, displace the pre-container or container by pushing it to one side or/and to the other or,
3) at least one gripper device of a robot or of a mechanical arm, in which it will catch or hold by pinching or folding at least part of the wrapper, foil, film, tube or semi-tube from the bottom or from the middle down of at least one side face of the pre-container (6) or pre-container unit (7), tube or half-tube from the bottom or from the middle to the bottom of at least one of the lateral faces of the pre-container (6) or unitary pre-container (7), so that with only one gripper it will be possible to move the pre-container or container to one side and to the other to generate one or both conical flaps, or
4) at least one sealing and/or cutting jaw device (1; 1a; 1b) and at least one mechanical mode such as that of at least one rotary or linear actuator which is to cause the jaw (1), once the latter has been actuated in closed position and has gripped, clamped or trapped by the lowermost part to the pre-container or container: to move to one side or/and to the other.
These four devices are arranged side of or/and in front of at least one side face to left and/or right, or/and in front of or/and behind of the bottom or middle to bottom of the side face of the pre-container or container or/and, likewise, of the sealing and/or cutting jaw (1).
13.5) Device comprising one or more insufflators of at least one fluid, fixed to the forming tube (5) or/and retractable extendable tube.
The insufflator device is composed of one or more compressors and one or more nozzles and/or dispensing tubes: intended for
Introduce at least one fluid inside the pre-container (6a; 7), as well as
widen or inflate the pre-container, being the most optimized the area where any of the flaps are generated, as well as defining a more three-dimensional geometric shape so that, subsequently, the flaps will be generated optimally without folds or creases.
This device is to be arranged or fixed on the inside or/and outside of the forming tube (5), as well as optionally part of the device is telescopic and extends and is directed inside the pre-container (6a).
13.6) Device comprising one or more suction cup devices, which comprises:
at least one suction cup, at least one mechanical drive means such as a linear cylinder (9) or rotary actuator (8) and, optionally, at least one air suction system or device for holding, directing or exerting pressure on the envelope; intended to
stretch and widen the wrapper, film, sheet, tube or half-tube of the pre-container (6) or unitary pre-container (7) lengthwise (towards the front and towards the back) or/and widthwise (towards the sides) of the area, proximal area or area further upwards from where at least any one of the flaps is generated.
13.7) Device comprising one or more rod or frame devices, which are fixed to the inner or/and outer face of the forming tube (5, 5a), being located inside the wrapper and the pre-container (6a): intended to widen and make the pre-container (6a) or unitary pre-container (7) acquire a three-dimensional shape.
Likewise, the device is immobile or is also mobile, driven by a mechanical mode such as pneumatic or electric cylinders such as one or more linear cylinders or/and swivel cylinders, most optimally when unfolded and retracted or/and moved up and down.

113. Device according to claim 111 or 112, characterized in that it comprises one or more devices for manipulating and/or transforming one or more of any one or more of the generated flaps, such as flap plus (11; 12; 13), flap triangular body (14) or flap strip (15), wherein the one or more devices alternatively and combinatorially and in an indistinct order are chosen from one or more of any one of the following options:
14.1) The device comprises a sealing system, by means of a heat source mode (4) such as that of a resistor (4a) or by ultrasound: intended for. sealing one or more times one or more sides of all or part of any one of the generated flaps, the most optimal ones being the flap plus English fold (11a), flap plus flat English fold (11b), flap plus stable bottom (12a), flap plus flat stable bottom (12b), flap plus English fold burr (13a), flap plus stable bottom burr (13b), flap plus flat stable bottom burr (13c), flap plus flat stable bottom burr (13d) or triangular body flap (14); resulting in,
one or more seals or welds that keep the flap or flap plus permanently stable, as well as keep permanently stable at least one of the support faces or additional face generated.
Likewise, it is most optimized when sealed with one or more sealing lines or/and sealing or welding points.
The device is most optimally attached to the impact plus body (2, 3) or/and to the sealing and/or cutting jaw (1a; 1b), the more optimally when attached to the striking segment of the impact plus body (2, 3) or/and in the zone or area of the sealing and/or cutting jaw (1a; 1b) where any of the flaps are generated, being most optimally when located or attached to the top or bottom face of the jaw (1a; 1b).
Also, optionally, the device is driven by a mechanical means such as one or more pneumatic or/and electric cylinders, such as linear cylinder (9) or/and turning cylinder (8).
14.2) The device comprises a sealing system, by means of a heat source mode (4) such as that of a resistor (4a) or by ultrasound: intended for. sealing one or more times one or more faces of the intersection zone of any one of the generated flaps and the body of the pre-container; obtaining,
one or more seals or welds that keep the flap or flap plus permanently stable, as well as keep permanently stable at least one of the support faces or additional face generated.
Likewise, it is most optimized when sealed with one or more sealing lines or/and sealing or welding points.
The device is most optimally attached to the impact plus body (2, 3) or/and to the sealing and/or cutting jaw (1a; 1b), the more optimally when attached to the striking segment of the impact plus body (2, 3) or/and in the zone or area of the sealing and/or cutting jaw (1a; 1b) where any of the flaps are generated, being most optimally when located or attached to the top or bottom face of the jaw (1a; 1b).
Also, optionally, the device is driven by a mechanical means such as one or more pneumatic or/and electric cylinders, such as linear cylinder (9) or/and turning cylinder (8).
14.3) The device comprises a cutting system, by means of a blade or cauterizing by means of a cutting edge or incandescent metal filament: intended to cut or section one or more times part or all of one or more of any of the generated flaps.
The device is to be fixed, optimally, to the impact plus body (2, 3) or/and on the part or the area of the sealing or/and cutting jaw (1a; 1b) that contacts any of the generated flaps, as well as also the device is driven by a mechanical means such as that of one or more pneumatic or/and electric cylinders such as the linear cylinder (9) or/and turning cylinder (8).
14.4) The device comprises a system for folding the flap, triangular body flap (14) or strip flap (15b) at least once on itself, by mechanical means such as blowing pressurized air or/and by pneumatic or/and electric cylinders such as that of one or more linear cylinders (9) or/and turning: designed for
folding one or more times towards one or more directions at least one part the flap, triangular body flap (14) or strip flap (15b) towards at least another part of itself; obtaining,
a flap, triangular body flap (14) or strip flap (15b) that protrudes less than the body of the container or has less length in length, and/or
an edge or/and crease that is generated in the intersection area of at least two folded, folded or joined parts of the flap, triangular body flap (14) or strip flap (15b).
The device is to be fixed, optimally, to the impact plus body (2, 3) or/and on the part or the area of the sealing or/and cutting jaw (1a; 1b) that contacts any of the generated flaps.
14.5) The device comprises rolling, or rolling and flattening, or also but rolling, flattening and sealing the flap of the type such as plus flap, triangular body flap or strip flap (15b).
The device comprises the following elements, parts and pieces:
at least one gripper device or system, such as a pneumatic or electric gripper jaw cylinder or gripper actuator, attached to the rod end of a rotary cylinder or rotary actuator: designed to momentarily hold at least part of the end of the flap, plus flap, triangular body flap or strip flap: until it is rolled at least once in at least one direction.
at least one system for advancing and retracting the gripper device or system, such as at least one linear cylinder or actuator or/and at least one rotary cylinder or rotary actuator pneumatic or electric, wherein at least one of the piston rods of at least one of the cylinders or actuators is to be attached to at least one gripper device or system: intended to move the clamp device or system forward and backward, with the function of bringing the clamp closer to the end of the flap, triangular body or strip, and then, once the clamp is closed, accompanying the forward movement of the winding action of the clamp, as well as once finished winding and opening the clamp, the forward and backward system will move the clamp device or system making it move back to the starting or initial point.
optionally and complementarily, at least one crushing device or body, driven with at least one linear cylinder or actuator (pneumatic or electric) or/and at least one turning or rotary cylinder or actuator (pneumatic or electric), as well as it can be fixed to the machine frame, to a support or to the clamp device: intended to crush at least part of the flap, triangular body or strip that has been rolled up so as to make it fold consistently into at least two parts.
optionally and complementarily, at least one sealing or heat-sealing system, by means of a heat source such as a heating element or ultrasound, which will be preferably fixed on the face or the underside of the crushing body that comes into contact with the flap, flap plus, triangular body or strip that is rolled up.
14.6) The device comprises a system supplying contact glue or stickers or strips with glue on one or both sides, by means of a mechanical way: intended to—adhere or glue part of any of the flaps such as the triangular body flap (14), strip flap (15) or plus flap (11; 12; 13):
on the pre-container body, or
on another part of the same flap (11; 12; 13; 14; 15), as well as optionally the flap folded and glued on itself, in turn, is to be adhered or glued to the body of the pre-container.
The device is to be fixed or located in the area or close to the area where any pre-container flaps are generated, being most optimally when fixed to the impact plus body (2, 3) or/and the sealing or/and cutting jaw (1a; 1b).
14.7) The device comprises generating and folding upon itself one or more than one of any one of the flaps, such as the plus flap (10; 11; 12; 13), triangular body flap (14) or strip flap (15).
The device may be attached to the impact plus body (2; 3) or, more optimally, be attached to the sealing and/or cutting jaw (1) or additional sealing and/or cutting jaw (15b), as well as comprising the following elements or parts:
at least one device intended to bring together or approximate, by means of a folding mode, at least once upon itself towards at least one direction of at least part of a flap (10; 11; 12; 13; 14; 15b) over at least another part of itself, being most optimized being superimposed in parallel or with some degree of turning to one side or the other, as well as folding upon itself rectilinearly, obliquely or semicircularly, and
at least one system for consolidating or permanently holding stable the generated flap, as described in claim 36 of machine: intended to
seal at least any one of the generated flaps or, alternatively,
optionally seal at least any one of the generated flaps and/or seal any one of the flaps once it has been folded back on itself.
14.8) The device comprises one or more systems for folding any of the flaps, by means of a hook, fork, buckle or hinge, which is optimally to be located just below the area where any of the flaps are generated, as well as to be fixed to a rotary actuator or turning motor, wherein the latter in turn is to be fixed to the sealing or/and cutting jaw (1a; 1b): intended to
rotate and fold, one or more times in one or more directions, any of the flaps in or on the body of the pre-container.

114. Device, according to claim 111 or 112 or 113, characterized in that it comprises a second jaw (1b) or second sealing and/or cutting jaw (1b), which is to be fixed above the sealing and/or cutting jaw (1a).
Also, optionally or complementarily, the second jaw (1b) contains one or more of one or more of any one of the devices, parts, elements or parts of the first jaw (1a), which are chosen alternatively and in combination from among one or more of one or more of any one of the elements, parts or devices described in this invention for the first sealing and/or cutting jaw (1a): intended to
be closed above the pre-container (6a), delimiting a volume or geometrical body shape of pre-container (6a), as well as,
optionally or complementarily, the pre-container (6a) on the top side or the pre-container located above the jaw (1b): is to be handled or/and transformed by means of any one of the devices described in this invention which are applicable and functional on the sealing and/or cutting jaw (1a) or on the bottom side of the pre-container (6a) or/and on the top side of the pre-container (6b).
Likewise, in the case where the second jaw (1b) seals and/or cuts transversely the upper part of the pre-container (6a) and that in turn the contents to be packaged are inserted into the pre-container located above the second jaw (1b): two pre-container or container units are to be produced in each production cycle, or two units in which one or both of them are mixed pre-containers or mixed containers, the most optimal ones being those with a half-upward pillow-type shape and a half-downward English fold or stable bottom.

115. Device, according to claim 111, characterized in that it comprises one or more pre-cutting devices (24), by means of a welding system mode such as laser, for pre-cutting one or more layers of the outside of the wrapper, foil or film of the pre-container, being most optimally a pre-cut of about 7 microns deep on the outside and without going through the flexible plastic wrapper, film or foil, as well as most optimally when the pre-cut is made with one or more lines or/and dots: intended for
pre-cut part of one or more faces of the pre-container (6; 7), being the most optimal when pre-cutting (24) two, three or four perpendicular edges or sides contiguous to the edges of a face of the pre-container, as well as the most optimal when between the edges or between the perpendicular sides: they form a right angle, or greater or less than the angle of 90 degrees; and
to generate an opening or lid in the pre-cut zone or area through which to access the packaged contents inside the pre-container (6; 7) or container.

116. Machines of forming, filling and/or sealing, or only filling and/or sealing, that manufactures or/and transforms, from flexible plastic material of film, sheet, tube or semi-tube type, in flexible containers or three-dimensional flexible containers, as well as manufactures pre pre-containers (6a; 6b; 7), which are in process or already manufactured but still remain in the machine because they are going to be transformed in the same or another machine.
Likewise, the container or pre-container may contain nothing inside or, on the contrary, it may contain a fluid, and it may also contain a solid; wherein the machine comprises:
optionally or additionally, a sealing means, by means of a heat source such as that of a resistor or by ultrasound, to realize the longitudinal sealing line of the left and/or right longitudinal end of the pre-containers (6a; 6b) or container (7) such as those of suchet, pouch, pillow or Pillow type with three or four seals or welds.
optionally or in addition, a sealing means, by means of a heat source such as that of a heating element or by ultrasound, for longitudinal sealing in the middle area or on the sides of the wrapper, these longitudinal seals being those in the middle of the rear face and on the left and right of the pre-containers (6a; 6b) or containers (7) such as those of pad type, English fold or stable bottom of three, four or five seals or welds.
optionally or additionally, a means for generating and sealing at least one continuous or discontinuous vertical edge flap (16): on at least one side or on the left or/and right side of the pre-container or container, as well as the most optimal way to generate the vertical edge flaps (16) is when, by means of the forming neck or/and forming tube, the wrapper acquires or takes the shape of a quadrangular tube when being coupled around the forming tube (5), generating in the wrapper four vertical edges (16) in the area just of the four longitudinal edges that the forming tube (5) has; so that at least part of the wrapper on one of the sides or areas adjacent to an edge (16): is to be folded and sealed on at least part of the other side or zone contiguous to the same edge (16), so that the pre-container or container is to contain at least one vertical edge flap (16), which endows the pre-container or container with greater firmness and consistency.
at least one sealing and/or cutting jaw (1a) with which the top and/or bottom cross-section of the pre-containers (6a, 6b) or containers (7) is sealed and/or cut.
optionally or in addition, at least one way of generating an English fold, Stable bottom fold, Stable bottom fold or Stabilo fold, which are generated when the sealing and/or cutting jaw (1a, 1b) is simultaneously actuated at the same time as the sealing and/or cutting jaw (1a, 1b) is closed, by means of a mechanical means such as pneumatic cylinders or servos, an impact body (18a) such as that of a triangular-shaped plate arranged in a horizontal plane or/and at least one impact body (18b) such as that of a quadrangular-shaped plate arranged in a vertical plane.
a way or means of forming a three-dimensional shape or geometric body, such as:
the upstream pre-container (6a), located just above the sealing and/or cutting jaw (1a), wherein the lower part of the pre-container (6a) is held by the sealing and/or cutting jaw (1a) which is actuated in the closed position, as well as the wrapper forming the pre-container (6a) is open at least at the top in order to thus introduce inside it the contents to be packaged, or it can also be closed since nothing is to be packaged inside it. Likewise, the pre-container (6a) holds at least one fluid inside, as well as optionally it can hold solid, and/or
the rear pre-container (6b), located just below the sealing and/or cutting jaw (1a), wherein the top of the pre-container (6b) is held by the sealing and/or cutting jaw (1a) which is actuated in the closed position, as well as the top of the wrapper forming the pre-container (6b) is closed. Likewise, the pre-container (6b) houses at least one fluid inside, as well as optionally it can house solid, and/or
the unitary pre-container (7), is an independent container unit such as English Fold, Stable Bottom, Stabilo, Stable Bottom, Pillow, Pillow, Suchet, Pouch or gusset type packaging, which is to be supported or located just above or below the sealing and/or cutting jaw (1), therefore it is neither attached to the wrapper nor to the pre-container (6a; 6b) nor is it being held or trapped by the jaw (1a; 1b).
The unitary pre-container (7) is either the pre-container (6a; 6b) which at the top and bottom has been cut, or sealed and cut, or cut and sealed by the clamp (1a), or clamp (1a) and clamp (1b), or is a pre-made container and is subsequently placed, by means of a mechanical mode, above or below the clamp (1a) or clamp (1b).
The containers or unitary pre-containers (7) are closed, or are also open on part or all of one or more of their sides or areas, or may be or be totally closed, as well as may also not house anything inside, or house at least one fluid, or house a fluid and additionally solid.
optionally or in addition, means of introduction and dosing of the product to be packaged inside the pre-container or container, such as a linear or multi-head weighed or/and a hopper.
optionally or in addition, means of generating at least any one of the flaps of type such as English fold, stable bottom, flat bottom, Stabilo or gusette;
Wherein the machine is characterized in that it comprises the same as described in claim 12 of device.

117. Machine, according to claim 116, characterized in that it comprises the same as described in device claim 112.

118. Machine, according to claim 116 or 117, characterized in that it comprises the same as described in device claim 113.

119. Machine, according to claim 116 or 117 or 118, characterized in that it comprises the same as described in device claim 114.

120. Machine, according to claim 116, characterized in that it comprises the same as described in device claim 115.

121. Container flexible, characterized in that it is obtainable by means of the procedure described in claims 100 to 110, or the device described in claims 111 to 115, or using the machine described in claims 116 to 120.

122. Container, according to claim 121, having the shape of a geometrical body similar or equal to a triangular-concave, regular, irregular, straight or oblique prism, which has five faces, wherein the lowermost face acting as a base is quadrangular and flat, and the front and rear faces are trapezoid-shaped, and the left and right side faces are isosceles or equilateral triangles in opposite directions and in diagonal convex position, as well as the bottom side of both side faces is horizontal and is also a side of the base face, so that the container is gradually narrowing from the flat quadrangular face that makes support base: To the horizontal side or the sealing line of the topmost part of the container which ends flat without any width.
The container has a shape similar to that of a bag but without the handles, as well as containing two flaps extending and protruding from the body of the container, wherein the two flaps are parallel and are located one on the left side and the other on the right side of the flat base face; wherein the container is characterized in that it comprises a closed or partially open container, wherein the half transverse half downwardly is of pad type and the other half transverse half upwardly is of English fold or stable bottom type, as well as any one or both of the flaps, alternatively or in combination and in an indistinct order, are as one of the following flap options: English fold flap; stable bottom flap; English fold plus flap (11a; 11b); stable bottom plus flap (12a; 12b). Also, optionally, the container contains one or two burr flaps (13), on the lower side of the front or/and back side of the container.

123. Container, according to claim 121, having the shape of a geometrical body similar or equal to a cube, rectangular prism or regular, irregular, straight or oblique parallelepiped, wherein the rectangular prism and the parallelepiped are arranged in a vertical format or in a horizontal format such as that of a shoe box, as well as having 6 sides and containing 4 flaps; wherein the container is characterized in that it comprises a closed or partially open container, wherein the half transverse half from middle to bottom is of the English fold or stable bottom type and has two flaps, one on the left side and the other on the right side of the bottom flat face that makes a base to the left side, as well as any one or both of the two flaps, alternatively or in combination and in an indistinct order, are as one of the following flap options: English fold flap; stable bottom flap; English fold plus flap (11a; 11b); stable bottom plus flap (12a; 12b). And the transverse half of the top side contains two flaps, one on the left side and the other on the right side of the flat top face of the container, as well as any one or both of the two flaps, alternately or in combination and in an indistinct order, are as one of the following flap options: English fold flap; stable bottom flap; English fold plus flap (11a; 11b); stable bottom plus flap (12a; 12b); triangular body flap (14); strip flap (15); triangular body flap folded on itself (15a); flap strip folded on itself (15b); arched flap; flap fully cut; flap partially cut; flap fully cut in welding wire; flap partially seared in welding wire; rolled flap; rolled and flattened flap.
Also, optionally, the container contains one, two, three or four burr flaps (13), on the top and/or bottom side of the front or/and back side of the container.

124. Container, according to claim 121 or 123, having the shape of a geometrical body similar or equal to a cylinder or elliptical cylinder, which has 6 faces, as well as containing 4 flaps; wherein the container is characterized in that it comprises as described in claim 123.

125. Container, according to claim 121 or 123, having the geometrical body shape similar or equal to a concave-convex cylinder or elliptical concave-convex cylinder, which has 6 faces, wherein the left and/or right parallel side faces of the container are bent convexly with respect to the container body, and the other two parallel front and rear faces of the container are bent concave with respect to the container body, as well as the parallel top and bottom faces, the two parallel left and/or right sides are concave semicircles and the other two parallel front and rear sides are concave.
Also, on the left and right side of the top and bottom face of the container there is in extension and protruding from the body of the container: a flap; wherein the container is characterized in that it comprises as described in claim 123.

126. Container, according to claim 121, having the shape of a geometrical body similar or equal to a regular, irregular, straight or oblique trapezoidal rectangular prism, which has seven faces, wherein the front and rear faces are rectangular trapezoidal in shape and transversely convex at the top, and the upper face are two parallel convex triangular faces, as well as to the left or right there is a dosing neck that protrudes upwards obliquely, which has a conical shape and its vertex is pointed; on the other hand, the base or bottom face and the right or left lateral face are flat and quadrangular, the lateral face being arranged perpendicular to the base face, and the right or left lateral face where the dosing neck is located is triangular and at the same time is convexly flexed.
The container has a shape similar to that of a jar with a dispensing neck, as well as containing three flaps extending and protruding from the body of the container, wherein two flaps are parallel and are located one on the left side and the other on the right side of the flat face that acts as a base, and the third flap is on the top horizontal side of the side face where the dispensing neck is not located; wherein the container is characterized in that it comprises a closed or partially open container, wherein the transverse half from middle to bottom is of the English fold or stable bottom type and has two flaps, one on the left side and the other on the right side of the bottom flat face that makes the left side base, as well as any one or both of the two flaps, alternatively or in combination and in an indistinct order, are as one of the following flap options: English fold flap; stable bottom flap; English fold plus flap (11a; 11b); stable bottom plus flap (12a; 12b).
And the transverse half of the top side contains a flap on the top side of the left or right side of the container, as well as this flap, alternatively or in combination and in an indistinct order, is as one of the following flap options: English fold flap; stable bottom flap; English fold plus flap (11a; 11b); stable bottom plus flap (12a; 12b); triangular body flap (14); strip flap (15); triangular body flap folded on itself (15a); flap strip folded on itself (15b); arched flap; flap fully cut; flap partially cut; flap fully cut in welding wire; flap partially seared in welding wire; rolled flap; rolled and flattened flap.
Also, optionally, the container contains one, two, three or four burr flaps (13), on the top and/or bottom side of the front and/or rear quadrangular face of the container.

127. Container, according to claim 121 or 122 or 123 or 124 or 125, characterized in that it additionally comprises in any of the containers: at least one laser pre-cutting line (24):
on at least part of at least one face of the pre-container (6a; 6b; 7) or container, wherein the pre-cut line or lines (24) when torn are openings through which to access the packaged contents inside the container, being most optimally when two, three or four perpendicular edges or sides adjoining the edges of a face of the container are pre-cut (24), as well as most optimally when between the edges or between the perpendicular sides: form a right angle, or greater or less than a 90-degree angle, and an opening or lid is generated which is separated from or remains attached to the container on at least one side.
